(19) United States
(12) Patent Application Publication
(10) Pub. No.: US 2024/0368357 A1
(43) Pub. Date: Nov. 7, 2024

(54) SILANE CROSSLINKABLE SILICONE RUBBER COMPOSITION, SILANE CROSSLINKED SILICONE RUBBER FORMED BODY, METHOD OF PRODUCING SAME, AND SILANE CROSSLINKED SILICONE RUBBER FORMED ARTICLE

(71) Applicant: FURUKAWA ELECTRIC CO., LTD., Tokyo (JP)

(72) Inventors: Hiroki CHIBA, Tokyo (JP); Yusuke KAMADA, Tokyo (JP); Takahiro SAKURAI, Tokyo (JP)

(73) Assignee: FURUKAWA ELECTRIC CO., LTD., Tokyo (JP)

(21) Appl. No.: 18/777,073

(22) Filed: Jul. 18, 2024

Related U.S. Application Data
(63) Continuation of application No. PCT/JP2023/012615, filed on Mar. 28, 2023.

(30) Foreign Application Priority Data
Mar. 30, 2022 (JP) 2022-055557
Mar. 30, 2022 (JP) 2022-055560
Mar. 30, 2022 (JP) 2022-055561

(51) Int. Cl. C08J 3/24; C08G 77/20; C08J 3/22; C08K 3/26; C08K 3/36; C08K 5/13; C08K 5/14; C08K 5/5425; C08L 23/08; C08L 23/14; C08L 27/18

(52) U.S. Cl. CPC C08J 3/242; C08G 77/20; C08J 3/226; C08K 3/26; C08K 3/36; C08K 5/13; C08K 5/14; C08K 5/5425; C08L 23/0869; C08L 23/147; C08L 27/18; C08J 2383/07; C08K 2003/265; C08L 2203/202; C08L 2312/08

(57) ABSTRACT

A silane crosslinkable silicone rubber composition including: with respect to 100 parts by mass of a base rubber containing a millable silicone rubber, 1 to 15 parts by mass of a silane coupling agent graft-bonded to the base rubber; 0.5 to 300 parts by mass of an inorganic filler; and 0.01 to 0.5 parts by mass of a silanol condensation catalyst,
a method of producing the same,
a silane crosslinked silicone rubber formed body obtained by using the silane crosslinkable silicone rubber composition, and a method of producing the same, and
a silane crosslinked silicone rubber formed article including the silane crosslinked silicone rubber formed body.

### CROSS-REFERENCE TO RELATED APPLICATIONS

This application is a Continuation of PCT International Application No. PCT/JP2023/012615 filed on Mar. 28, 2023, which claims priority under 35 U.S.C. § 119 (a) to Japanese Patent Application No. 2022-055557 filed in Japan on Mar. 30, 2022, Japanese Patent Application No. 2022-055560 filed in Japan on Mar. 30, 2022, and Japanese Patent Application No. 2022-055561 filed in Japan on Mar. 30, 2022. Each of the above applications is hereby expressly incorporated by reference, in its entirety, into the present application.

### TECHNICAL FIELD

The present invention relates to a silane crosslinkable silicone rubber composition, a silane crosslinked silicone rubber formed body, a method of producing the same, and a silane crosslinked silicone rubber formed article obtained by using the silane crosslinked silicone rubber formed body.

### BACKGROUND ART

Various resin formed bodies or rubber formed bodies are used as coating layers (insulators, sheaths, etc.) provided on wiring materials, such as insulated wires, cables, cords, optical fiber core wires, or optical fiber cords (optical fiber cables), each of which is used in an electrical- or electronic-equipment field and an industrial field, or as various formed bodies such as packing and sheets. Depending on the intended use, these formed bodies are required to have characteristics such as outer appearance characteristics and strength (e.g. tensile strength), and further required to have heat resistance or the like from the viewpoint of safety and reliability.

Examples of the material for forming the formed bodies include silicone rubbers capable of exhibiting excellent weather resistance, heat resistance, and the like by chemical crosslinking. As a formed body using a silicone rubber, for example, Patent Literature 1 describes “an insulated wire in which a periphery of a conductor is covered with an insulation layer containing a crosslinked silicone rubber, wherein the insulation layer contains an acid acceptor”. Further, Patent Literature 2 describes “an insulated wire in which a periphery of a conductor is covered with an insulation layer containing a crosslinked silicone rubber, wherein the insulation layer has a Shore A hardness of 50 or more as measured in accordance with JIS K 6253 and contains an oxide of a transition metal”.

Furthermore, Patent Literature 3 describes an insulating part for an electric cable, obtained by forming a resin composition containing methyl(benzimidazole-2-yl)carbamate, diiodomethyl-p-tolyl sulfone, and 2-thiazolyl-1H-benzimidazole in a specific amount and a specific total amount, as three kinds of antifungal agents, on a thermoplastic resin containing an ethylene copolymer and/or a silicone rubber.

### CITATION LIST

### Patent Literature

Patent Literature 1: JP-A-2016-091911 (“JP-A” means unexamined published Japanese patent application)
Patent Literature 2: JP-A-2015-090753
Patent Literature 3: JP-A-2007-287683

### SUMMARY OF INVENTION

### Technical Problem

Each of the insulated wires described in Patent Literatures 1 and 2 has an insulation layer containing a crosslinked silicone rubber. Further, in the insulating part for an electric cable described in Patent Literature 3, it is described that the radically reactive silicone rubber may be crosslinked using a crosslinking agent (organic peroxide).

Conventionally, as a method of crosslinking a silicone rubber (final crosslinking method after forming), a self-crosslinking method by heating or a chemical crosslinking method using a crosslinking agent is employed. Therefore, in order to crosslink the silicone rubber, it is essential to perform a crosslinking reaction at a high temperature using, for example, crosslinking equipment such as a chemical crosslinking tube. For example, in Patent Literatures 1 and 2, the crosslinking reaction is performed at 200° C. for 4 hours. In Patent Literature 3, the crosslinking reaction is performed at 160° C. As described above, the conventional method of crosslinking a silicone rubber has a problem of manufacturability (in terms of production) in terms of preparation, maintenance, and the like of the crosslinking equipment, and further crosslinking conditions and the like. Particularly, in recent years, from the viewpoint of protecting and sustaining the global environment, there has been an increasing demand for improvement in productivity, reduction in production cost, and the like, and a technique capable of producing a crosslinked silicone rubber formed body showing desired characteristics with excellent manufacturability is desired.

The present invention solves the above-described problems and provides a silane crosslinkable silicone rubber composition capable of producing a silane crosslinked silicone rubber formed body excellent in outer appearance, heat resistance and strength with excellent manufacturability, and a method of producing the same. Further, the present invention provides a silane crosslinked silicone rubber formed body excellent in outer appearance, heat resistance, and strength, and a method of producing the same. Furthermore, the present invention provides a silane crosslinked silicone rubber formed article obtained by using the silane crosslinked silicone rubber formed body showing the above excellent characteristics.

Incidentally, in recent years, the use of various formed bodies has been diversified, and an improvement in the quality of formed bodies has been progressed. Along with this progress, formed bodies have been required to have higher levels of heat resistance and strength than conventional ones.

Therefore, a preferred embodiment (a preferred aspect) of the present invention solves this problem, and provides a silane crosslinkable silicone rubber composition capable of producing a silane crosslinked silicone rubber formed body excellent in outer appearance and showing high heat resistance and strength with excellent manufacturability, and a method of producing the same. Further, a preferred embodiment of the present invention provides a silane crosslinked silicone rubber formed body excellent in outer appearance and showing high heat resistance and strength, and a method of producing the same. Furthermore, a preferred embodiment of the present invention provides a silane crosslinked silicone rubber formed article obtained by using the silane crosslinked silicone rubber formed body showing the above excellent characteristics.

Here, silicone rubber is generally difficult to form (extrude) with a general-purpose plastic forming machine (hereinafter, may be also referred to as a general-purpose extruder) due to its bulk state, physical properties, and the like. In Examples of Patent Literature 3 as well, a test sheet is produced by press-forming after mixing with a stirrer. Among silicone rubbers, a millable silicone rubber in a bulk state is in the form of pale crepe (the form of a clay), and the mixing and forming of the millable silicone rubber requires production equipment (mixers, extruders, etc.) dedicated to silicone rubbers. Particularly, extrusion forming is an important forming method from the viewpoint of industrial production of various formed bodies, for example, a formed body that can be extrusion-formed with other parts and cannot be easily formed by other forming methods can be formed. Accordingly, in a case where such a problem of formability of the silicone rubber is solved in addition to the above-described problem of manufacturability, and the forming can be performed using general-purpose production equipment, particularly an extruder, it is possible to overcome limitations on handleability and production devices in producing the silicone rubber formed body, and the merit thereof is great.

Further, in recent years, diversification of applications of various formed bodies and improvement of the quality of formed bodies have progressed, and formed bodies exhibiting higher heat resistance and strength than conventional ones have been required, as described above.

Therefore, another preferred embodiment (another preferred aspect) of the present invention solves these problems, and provides a silane crosslinkable silicone rubber composition capable of producing a silane crosslinked silicone rubber formed body excellent in outer appearance and showing high heat resistance and strength with excellent manufacturability, even with a general-purpose extruder, and a method of producing the same. Further, another preferred embodiment of the present invention provides a silane crosslinked silicone rubber formed body excellent in outer appearance and showing high heat resistance and strength, and a method of producing the same. Furthermore, another preferred embodiment of the present invention provides a silane crosslinked silicone rubber formed article obtained by using the silane crosslinked silicone rubber formed body showing the above excellent characteristics.

### Solution to Problem

The present inventors have found that, regarding the crosslinkable silicone rubber composition, when a specific amount of a silane coupling agent is graft-bonded to a millable silicone rubber (organopolysiloxane) in the coexistence of a specific amount of an inorganic filler, the silane coupling agent bonded to the inorganic filler and the silane coupling agent not bonded to the inorganic filler can preferentially and selectively form a silane crosslinkable silicone rubber graft-bonded to the millable silicone rubber. In addition, the present inventors have found that when this silane crosslinkable silicone rubber is used in combination with a specific amount of a silanol condensation catalyst, a silane crosslinking reaction proceeds under relatively mild conditions without using special crosslinking equipment. Then, the present inventors have found that, by such a silane crosslinking method, even in a millable silicone rubber in which a sufficient crosslinked structure cannot be constructed by an ordinary silane crosslinking method, a highly developed crosslinked structure including a crosslinked structure in which an inorganic filler is spirally wound can be constructed, and a silane crosslinked body of a silicone rubber can be allowed to exhibit excellent outer appearance, heat resistance, and tensile strength. The present inventors repeated more studies based on these findings and finally completed the present invention.

That is, the above-described problems of the present invention are solved by the following means.

<A1> A silane crosslinkable silicone rubber composition, including:
a base rubber containing a millable silicone rubber; and
with respect to 100 parts by mass of the base rubber containing a millable silicone rubber, 1 to 15 parts by mass of a silane coupling agent graft-bonded to the base rubber; 0.5 to 300 parts by mass of an inorganic filler; and 0.01 to 0.5 parts by mass of a silanol condensation catalyst.

<A2> The silane crosslinkable silicone rubber composition described in <A1>, wherein the inorganic filler is at least one kind selected from the group consisting of metal hydrate, talc, clay, silica, calcium carbonate, and carbon black.

<A3> The silane crosslinkable silicone rubber composition described in <A1> or

<A2>, wherein a content of the silane coupling agent is 3 to 15 parts by mass with respect to 100 parts by mass of the base rubber.

<A4> A silane crosslinked silicone rubber formed body obtained by, after forming the silane crosslinkable silicone rubber composition described in any one of <A1> to <A3>, bringing the silane crosslinkable silicone rubber composition into contact with water.

<A5> A silane crosslinked silicone rubber formed article including the silane crosslinked silicone rubber formed body described in <A4>.

<A6> A method of producing a silane crosslinkable silicone rubber composition, including a step (1A) of obtaining a silane crosslinkable silicone rubber composition by mixing a base rubber containing a millable silicone rubber, and with respect to 100 parts by mass of the base rubber containing a millable silicone rubber, 1 to 15 parts by mass of a silane coupling agent having a grafting reaction site capable of being graft-reacted with the base rubber, 0.5 to 300 parts by mass of an inorganic filler, 0.01 to 0.6 parts by mass of an organic peroxide, and 0.01 to 0.5 parts by mass of a silanol condensation catalyst,
wherein, when the step (1A) is performed, in a case of melt-mixing all of the base rubber in the following step (a), the step (1A) includes the following step (a) and step (c), or in a case of melt-mixing a part of the base rubber in the following step (a), the step (1A) includes the following step (a), step (b) and step (c):
   Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
   Step (b): a step of preparing a catalyst masterbatch, by melt-mixing a remainder of the base rubber, and the silanol condensation catalyst, and
   Step (c): a step of mixing the silane masterbatch with the silanol condensation catalyst or the catalyst masterbatch.

<A7> A method of producing a silane crosslinked silicone rubber formed body including the following step (1A), step (2) and step (3):
Step (1A): a step of obtaining a silane crosslinkable silicone rubber composition by mixing a base rubber containing a millable silicone rubber, and with respect to 100 parts by mass of the base rubber containing a millable silicone rubber, 1 to 15 parts by mass of a silane coupling agent having a grafting reaction site capable of being graft-reacted with the base rubber, 0.5 to 300 parts by mass of an inorganic filler, 0.01 to 0.6 parts by mass of an organic peroxide, and 0.01 to 0.5 parts by mass of a silanol condensation catalyst,
Step (2): a step of obtaining a formed body by forming the silane crosslinkable silicone rubber composition, and
Step (3): a step of obtaining a silane crosslinked silicone rubber formed body by bringing the formed body into contact with water,
wherein when the step (1A) is performed, in a case of melt-mixing all of the base rubber in the following step (a), the step (1A) includes the following step (a) and step (c), or in a case of melt-mixing a part of the base rubber in the following step (a), the step (1A) includes the following step (a), step (b) and step (c):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of mixing the silane masterbatch with the silanol condensation catalyst or the catalyst masterbatch.

As described above, the present inventors have found that the present invention, i.e. a silane crosslinkable silicone rubber composition including: with respect to 100 parts by mass of a base rubber containing a millable silicone rubber (organopolysiloxane); 1 to 15 parts by mass of a silane coupling agent being graft-bonded to the base rubber; 0.5 to 300 parts by mass of an inorganic filler; and 0.01 to 0.5 parts by mass of a silanol condensation catalyst causes a silane crosslinking reaction under relatively mild conditions without using special crosslinking equipment, and as a result, the problem of manufacturability is solved, and it is possible to produce a silane crosslinked body excellent in outer appearance, heat resistance, and strength. Based on this finding, various studies have been conducted on the physical properties and behavior of this silane crosslinkable silicone rubber composition, and as a result, it has been found that there is room for further improvement to meet the recent demand for increasing the heat resistance and strength of the formed body to a high level. Thus, as a result of further studies on the silane crosslinkable silicone rubber composition, it has been found that a fluororubber is used in combination with a millable silicone rubber as a base rubber while using the silane crosslinkable silicone rubber composition having the above composition as a base, and the content of the inorganic filler is reduced to 100 parts by mass or less, and thus it is possible to allow a silane crosslinked silicone rubber formed body to exhibit high heat resistance and strength while maintaining excellent outer appearance without impairing excellent manufacturability. The present inventors repeated more studies based on these findings and finally completed the preferred embodiment of the present invention.

That is, the above-described problems of the preferred embodiment of the present invention are solved by the following means.

<B1> The silane crosslinkable silicone rubber composition described in <A1>, wherein the base rubber includes a fluororubber and contains 0.5 to 100 parts by mass of the inorganic filler.

That is, a silane crosslinkable silicone rubber composition including: a base rubber containing a millable silicone rubber and a fluororubber, and with respect to 100 parts by mass of the base rubber containing a millable silicone rubber and a fluororubber; 1 to 15 parts by mass of a silane coupling agent graft-bonded to the base rubber, 0.5 to 100 parts by mass of an inorganic filler; and 0.01 to 0.5 parts by mass of a silanol condensation catalyst.

<B2> The silane crosslinkable silicone rubber composition described in <B1>, wherein the fluororubber includes a tetrafluoroethylene-propylene rubber.

<B3> The silane crosslinkable silicone rubber composition described in <B1> or

<B2>, wherein the base rubber includes an ethylene copolymer resin.

<B4> The silane crosslinkable silicone rubber composition described in any one of <B1>1 to <B3>, wherein the inorganic filler is at least one kind selected from the group consisting of metal hydrate, talc, clay, silica, calcium carbonate, and carbon black.

<B5> The silane crosslinkable silicone rubber composition described in any one of <B1>1 to <B4>, wherein a content of the silane coupling agent is 3 to 15 parts by mass with respect to 100 parts by mass of the base rubber.

<B6> A silane crosslinked silicone rubber formed body obtained by, after forming the silane crosslinkable silicone rubber composition described in any one of <B1> to <B5>, bringing the silane crosslinkable silicone rubber composition into contact with water.

<B7> A silane crosslinked silicone rubber formed article including the silane crosslinked silicone rubber formed body described in <B6>.

<B8> The silane crosslinkable silicone rubber composition described in <A6>, wherein in the step (1A), the base rubber includes a fluororubber, and 0.5 to 100 parts by mass of the inorganic filler is mixed.

That is, a method of producing a silane crosslinkable silicone rubber composition, including a step (1B) of obtaining a silane crosslinkable silicone rubber composition by mixing a base rubber containing a millable silicone rubber and a fluororubber, and with respect to 100 parts by mass of the base rubber containing a millable silicone rubber and a fluororubber, 1 to 15 parts by mass of a silane coupling agent having a grafting reaction site capable of being graft-reacted with the base rubber, 0.5 to 100 parts by mass of an inorganic filler, 0.01 to 0.6 parts by mass of an organic peroxide, and 0.01 to 0.5 parts by mass of a silanol condensation catalyst,
wherein, when the step (1B) is performed, in a case of melt-mixing all of the base rubber in the following step (a), the step (1B) includes the following step (a) and step (c), or in a case of melt-mixing a part of the base rubber in the following step (a), the step (1B) includes the following step (a), step (b) and step (c):
   Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
   Step (b): a step of preparing a catalyst masterbatch, by melt-mixing a remainder of the base rubber, and the silanol condensation catalyst, and
   Step (c): a step of mixing the silane masterbatch with the silanol condensation catalyst or the catalyst masterbatch.

<B9> The silane crosslinkable silicone rubber composition described in <A7>, wherein in the step (1A), the base rubber includes a fluororubber, and 0.5 to 100 parts by mass of the inorganic filler is mixed.

That is, a method of producing a silane crosslinked silicone rubber formed body including the following step (1B), step (2) and step (3):
Step (11B): a step of obtaining a silane crosslinkable silicone rubber composition by mixing a base rubber containing a millable silicone rubber and a fluororubber, and with respect to 100 parts by mass of the base rubber containing a millable silicone rubber and a fluororubber, 1 to 15 parts by mass of a silane coupling agent having a grafting reaction site capable of being graft-reacted with the base rubber, 0.5 to 100 parts by mass of an inorganic filler, 0.01 to 0.6 parts by mass of an organic peroxide, and 0.01 to 0.5 parts by mass of a silanol condensation catalyst,
Step (2): a step of obtaining a formed body by forming the silane crosslinkable silicone rubber composition, and
Step (3): a step of obtaining a silane crosslinked silicone rubber formed body by bringing the formed body into contact with water,
wherein when performing the step (1B), in a case of melt-mixing all of the base rubber in the following step (a), the step (1B) includes the following step (a) and step (c), or in a case of melt-mixing a part of the base rubber in the following step (a), the step (1B) includes the following step (a), step (b), and step (c):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of mixing the silane masterbatch with the silanol condensation catalyst or the catalyst masterbatch.

Furthermore, the present inventors have found that the present invention, i.e. a silane crosslinkable silicone rubber composition including: with respect to 100 parts by mass of a base rubber containing a millable silicone rubber (organopolysiloxane); 1 to 15 parts by mass of a silane coupling agent being graft-bonded to the base rubber; 0.5 to 300 parts by mass of an inorganic filler; and 0.01 to 0.5 parts by mass of a silanol condensation catalyst causes a silane crosslinking reaction under relatively mild conditions without using special crosslinking equipment, and as a result, the problem of manufacturability is solved, and it is possible to produce a silane crosslinked body excellent in outer appearance, heat resistance, and strength.

Based on this finding, various studies have been conducted on the physical properties and behavior of this silane crosslinkable silicone rubber composition, and as a result, it has been found that even a silane crosslinkable silicone rubber composition excellent in outer appearance, heat resistance and strength is difficult to extrude and form by a general-purpose extruder, which is a problem of formability, and further, when the problem of formability is improved, heat resistance is deteriorated, whereby the above-mentioned high heat resistance and strength cannot be realized. Therefore, as a result of continuing further studies on the silane crosslinkable silicone rubber composition, it has been found that it is possible to realize a silane crosslinked silicone rubber formed body which can be formed with a general-purpose extruder without impairing excellent manufacturability and which exhibits high heat resistance and strength while maintaining excellent outer appearance by using an ethylene copolymer resin from various polymers in combination with a millable silicone rubber while using the silane crosslinkable silicone rubber composition having the above composition as a base, reducing the content of an inorganic filler to 100 parts by mass or less, and then combining and blending a hindered phenol-based antioxidant, a hydrazine-based metal inactivator, and a benzimidazole-based antioxidant (hereinafter, may be referred to as “three kinds of antioxidants”) in a specific ratio. The present inventors repeated more studies based on these findings and finally completed another preferred embodiment of the present invention.

That is, the above-described problems of another preferred embodiment of the present invention are solved by the following means.

<C1> The silane crosslinkable silicone rubber composition described in <A1>, wherein the base rubber includes an ethylene copolymer resin, and contains 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant.

That is, a silane crosslinkable silicone rubber composition containing: a base rubber containing a millable silicone rubber and an ethylene copolymer resin, and with respect to 100 parts by mass of the base rubber containing a millable silicone rubber and an ethylene copolymer resin, 1 to 15 parts by mass of a silane coupling agent graft-bonded to the base rubber, 0.2 to 8 parts by mass of a hindered phenol-based antioxidant, 0.2 to 5 parts by mass of a hydrazine-based metal inactivator, 1.5 to 15 parts by mass of a benzimidazole-based antioxidant, 0.5 to 100 parts by mass of an inorganic filler, and 0.01 to 0.5 parts by mass of a silanol condensation catalyst.

<C2> The silane crosslinkable silicone rubber composition described in <C1>, wherein the ethylene copolymer resin includes an ethylene-(meth)acrylic acid ester copolymer resin.

<C3> The silane crosslinkable silicone rubber composition described in <C1> or

<C2>, wherein the base rubber includes a fluororubber.

<C4> The silane crosslinkable silicone rubber composition described in <C3>, wherein the fluororubber includes a tetrafluoroethylene-propylene rubber.

<C5> The silane crosslinkable silicone rubber composition described in any one of <C1> to <C4>, wherein a content of the hindered phenol-based antioxidant is 0.5 to 5 parts by mass, wherein a content of the hydrazine-based metal inactivator is 0.5 to 4 parts by mass, and wherein a content of the benzimidazole-based antioxidant is 3 to 12 parts by mass.

<C6> The silane crosslinkable silicone rubber composition described in any one of <C1> to <C5>, wherein the inorganic filler is at least one kind selected from the group consisting of metal hydrate, talc, clay, silica, calcium carbonate, and carbon black.

<C7> The silane crosslinkable silicone rubber composition described in any one of <C1> to <C6>, wherein a content of the silane coupling agent is 3 to 15 parts by mass with respect to 100 parts by mass of the base rubber.

<C8> A silane crosslinked silicone rubber formed body obtained by, after forming the silane crosslinkable silicone rubber composition described in any one of <C1> to <C7>, bringing the silane crosslinkable silicone rubber composition into contact with water.

<C9> A silane crosslinked silicone rubber formed article including the silane crosslinked silicone rubber formed body described in <C8>.

<C10> The silane crosslinkable silicone rubber composition described in <A6>, wherein in the step (1A), the base rubber includes an ethylene copolymer resin, and 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant are mixed, and
wherein each of the hindered phenol-based antioxidant, the hydrazine-based metal inactivator, and the benzimidazole-based antioxidant is mixed in at least one of the step (a) and the following step (b).

That is, a method of producing a silane crosslinkable silicone rubber composition including a step (1C) of obtaining a silane crosslinkable silicone rubber composition by melt-mixing a base rubber containing a millable silicone rubber and an ethylene copolymer resin, and with respect to 100 parts by mass of the base rubber containing a millable silicone rubber and an ethylene copolymer resin, 1 to 15 parts by mass of a silane coupling agent having a grafting reaction site capable of being graft-reacted with the base rubber, 0.2 to 8 parts by mass of a hindered phenol-based antioxidant, 0.2 to 5 parts by mass of a hydrazine-based metal inactivator, 1.5 to 15 parts by mass of a benzimidazole-based antioxidant, 0.5 to 100 parts by mass of an inorganic filler, 0.01 to 0.6 parts by mass of an organic peroxide, and 0.01 to 0.5 parts by mass of a silanol condensation catalyst, wherein, when the step (1C) is performed, in a case of melt-mixing all of the base rubber in the following step (a), the step (1C) includes the following step (a) and step (c), or in a case of melt-mixing a part of the base rubber in the following step (a), the step (1C) includes the following step (a), step (b), and step (c), and wherein each of the hindered phenol-based antioxidant, the hydrazine-based metal inactivator, and the benzimidazole-based antioxidant is mixed in at least one of the following steps (a) and (b):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of melt-mixing the silane masterbatch with the silanol condensation catalyst or the catalyst masterbatch.

<C11> The silane crosslinkable silicone rubber composition described in <A7>, wherein in the step (1A), the base rubber includes an ethylene copolymer resin, and 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant are mixed, and
wherein each of the hindered phenol-based antioxidant, the hydrazine-based metal inactivator, and the benzimidazole-based antioxidant is mixed in at least one of the step (a) and the following step (b).

That is, a method of producing a silane crosslinked silicone rubber formed
body including the following step (1C), step (2) and step (3): Step (1C): a step of obtaining a silane crosslinkable silicone rubber composition by melt-mixing a base rubber containing a millable silicone rubber and an ethylene copolymer resin, and with respect to 100 parts by mass of the base rubber containing a millable silicone rubber and an ethylene copolymer resin, 1 to 15 parts by mass of a silane coupling agent having a grafting reaction site capable of being graft-reacted with the base rubber, 0.2 to 8 parts by mass of a hindered phenol-based antioxidant, 0.2 to 5 parts by mass of a hydrazine-based metal inactivator, 1.5 to 15 parts by mass of a benzimidazole-based antioxidant, 0.5 to 100 parts by mass of an inorganic filler, 0.01 to 0.6 parts by mass of an organic peroxide, and 0.01 to 0.5 parts by mass of a silanol condensation catalyst,
Step (2): a step of obtaining a formed body by forming the silane crosslinkable
silicone rubber composition, and Step (3): a step of obtaining a silane crosslinked silicone rubber formed body by bringing the formed body into contact with water,
wherein, when the step (1C) is performed, in a case of melt-mixing all of the base rubber in the following step (a), the step (1C) includes the following step (a) and step (c), or in a case of melt-mixing a part of the base rubber in the following step (a), the step (1C) includes the following step (a), step (b), and step (c), and wherein each of the hindered phenol-based antioxidant, the hydrazine-based metal inactivator, and the benzimidazole-based antioxidant is melt-mixed in at least one of the following steps (a) and (b):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of melt-mixing the silane masterbatch with the silanol condensation catalyst or the catalyst masterbatch.

### Effects of the Invention

The present invention can provide a silane crosslinkable silicone rubber composition capable of producing a silane crosslinked silicone rubber formed body excellent in outer appearance, heat resistance and strength with excellent manufacturability, and a method of producing the same. Further, the present invention can provide a silane crosslinked silicone rubber formed body excellent in outer appearance, heat resistance, and strength, and a method of producing the silane crosslinked silicone rubber formed body. Furthermore, the present invention can provide a silane crosslinked silicone rubber formed article obtained by using the silane crosslinked silicone rubber formed body showing the above excellent characteristics.

A preferred embodiment of the present invention can provide a silane crosslinkable silicone rubber composition capable of producing a silane crosslinked silicone rubber formed body excellent in outer appearance and showing high heat resistance and strength with excellent manufacturability, and a method of producing the same. Further, a preferred embodiment of the present invention can provide a silane crosslinked silicone rubber formed body excellent in outer appearance and showing high heat resistance and high strength, and a method of producing the silane crosslinked silicone rubber formed body. Furthermore, a preferred embodiment of the present invention can provide a silane crosslinked silicone rubber formed article obtained by using the silane crosslinked silicone rubber formed body showing the above excellent characteristics.

Another preferred embodiment of the present invention can provide a silane crosslinkable silicone rubber composition capable of producing a silane crosslinked silicone rubber formed body excellent in outer appearance and showing high heat resistance and strength with excellent manufacturability, even with a general-purpose extruder, and a method of producing the same. Further, another preferred embodiment of the present invention can provide a silane crosslinked silicone rubber formed body excellent in outer appearance and showing high heat resistance and high strength, and a method of producing the silane crosslinked silicone rubber formed body. Furthermore, another preferred embodiment of the present invention can provide a silane crosslinked silicone rubber formed article obtained by using the silane crosslinked silicone rubber formed body showing the above excellent characteristics.

The above and other features and advantages of the present invention will become more apparent from the following description appropriately with reference to the attached drawings.

### MODE FOR CARRYING OUT THE INVENTION

In the present invention, in a case where the content, physical properties, and the like of components are described by referring to numerical ranges, when the upper limit and the lower limit of a numerical range is separately described, the upper limit and the lower limit of any of the components can be appropriately combined to set a specific numerical range. On the other hand, when a plurality of numerical ranges expressed with the term “to” is set and described, the upper limit and the lower limit forming a numerical range are not limited to a specific combination described before and after the term “to” as a specific numerical range, and may be a numerical range in which the upper limit and the lower limit of each of the numerical ranges are appropriately combined. Note that, in the present invention, the numerical ranges expressed with the term “to” refer to ranges including, as the lower limit and the upper limit, the numerical values before and after the term “to”.

Further, in the present invention, “(meth)acrylic acid” refers to either one or both of acrylic acid and methacrylic acid, and “(meth)acrylic acid ester” refers to either one or both of an acrylic acid ester and a methacrylic acid ester.

In the present invention, the “antioxidant” is also referred to as an anti-aging agent, and a hydrazine-based metal inactivator is also included in one kind of antioxidant.

### [Silane Crosslinkable Silicone Rubber Composition]

The silane crosslinkable silicone rubber composition of the present invention (hereinafter, may be simply referred to as “silane crosslinkable silicone rubber composition [A]”) includes, with respect to 100 parts by mass of a base rubber containing a millable silicone rubber, 1 to 15 parts by mass of a silane coupling agent graft-bonded to the base rubber, 0.5 to 300 parts by mass of an inorganic filler, and 0.01 to 0.5 parts by mass of a silanol condensation catalyst. This silane crosslinkable silicone rubber composition [A] can be prepared by appropriately mixing the above components, and is preferably prepared by the method of producing a silane crosslinkable silicone rubber composition of the present invention (hereinafter, may be simply referred to as “method [A] of producing a silane crosslinkable silicone rubber composition”) as described later.

As will be described in detail later, the silane crosslinkable silicone rubber composition [A] of the present invention includes a silane crosslinkable silicone rubber in which a silane coupling agent bonded or dissociated with an inorganic filler is graft-bonded to a base rubber, ordinarily a millable silicone rubber (organopolysiloxane). Further, the silane crosslinkable silicone rubber composition [A] may appropriately include a crosslinked silicone rubber in which the millable silicone rubber is crosslinked (the organopolysiloxane is crosslinked intramolecularly or intermolecularly). The content thereof is the same as that in the silane crosslinked silicone rubber formed body of the present invention (hereinafter, may be simply referred to as “silane crosslinked silicone rubber formed body [A]”) as described later.

The silane crosslinkable silicone rubber composition [A] causes a silanol condensation reaction under mild conditions without requiring special crosslinking equipment, such as a chemical crosslinking tube and an electron beam crosslinking machine, to produce the silane crosslinked silicone rubber formed body [A] having excellent outer appearance, heat resistance and tensile strength, with excellent manufacturability. Accordingly, the silane crosslinkable silicone rubber composition [A] of the present invention is preferably used in the method of producing a silane crosslinked silicone rubber formed body of the present invention (hereinafter, may be simply referred to as “method [A] of producing a silane crosslinked silicone rubber formed body”), or used for the silane crosslinked silicone rubber formed article of the present invention (hereinafter, may be simply referred to as “silane crosslinked silicone rubber formed article [A]”).

The silane crosslinkable silicone rubber composition in a preferred embodiment of the present invention (hereinafter, may be simply referred to as “silane crosslinkable silicone rubber composition [B]”) includes, with respect to 100 parts by mass of a base rubber containing a millable silicone rubber and a fluororubber, 1 to 15 parts by mass of a silane coupling agent graft-bonded to the base rubber; 0.5 to 100 parts by mass of an inorganic filler; and 0.01 to 0.5 parts by mass of a silanol condensation catalyst. This silane crosslinkable silicone rubber composition [B] can be prepared by appropriately mixing the above components, and is preferably prepared by the method of producing a silane crosslinkable silicone rubber composition of a preferred embodiment of the present invention (hereinafter, may be simply referred to as “method [B] of producing a silane crosslinkable silicone rubber composition”) as described later. The silane crosslinkable silicone rubber composition [B] can also be referred to as a melt-mixture of a silane masterbatch with a silanol condensation catalyst or a catalyst masterbatch, as described later.

As will be described in detail later, the silane crosslinkable silicone rubber composition [B] of a preferred embodiment of the present invention includes a silane crosslinkable silicone rubber in which a silane coupling agent bonded or dissociated with an inorganic filler is graft-bonded to a millable silicone rubber (organopolysiloxane).

The silane crosslinkable silicone rubber composition [B] according to a preferred embodiment of the present invention causes a silanol condensation reaction under mild conditions without requiring special crosslinking equipment, such as a chemical crosslinking tube or an electron beam crosslinking machine, to produce the silane crosslinked silicone rubber formed body having excellent outer appearance, and high heat resistance and strength (hereinafter, may be simply referred to as “silane crosslinked silicone rubber formed body [B]”), with excellent manufacturability. Accordingly, the silane crosslinkable silicone rubber composition [B] of the present invention is preferably used in the method of producing a silane crosslinked silicone rubber formed body of a preferred embodiment of the present invention (hereinafter, may be simply referred to as “method [B] of producing a silane crosslinked silicone rubber formed body”), or used for the silane crosslinked silicone rubber formed article of a preferred embodiment of the present invention (hereinafter, may be simply referred to as “silane crosslinked silicone rubber formed article [B]”).

In general, silicone rubber has a problem of formability that, particularly a millable silicone rubber in a bulk state is in the form of pale crepe (in the form of a clay), the mixing and forming of the millable silicone rubber are difficult and require production equipment (mixers, extruders, etc.) dedicated to silicone rubbers. However, as described later, when an ethylene copolymer resin is used in combination with the millable silicone rubber and a fluororubber as the base rubber, extrusion forming can be performed even with a general-purpose plastic forming machine (hereinafter, also referred to as a general-purpose extruder) without impairing excellent manufacturability and excellent characteristics of the formed body, and the problem of formability can be solved. The silane crosslinkable silicone rubber composition [B] according to a preferred embodiment of the present invention can overcome the limitations on handleability and production devices in the production of the silicone rubber formed body [B], and the merit thereof is great. Further, when this silane crosslinkable silicone rubber composition [B] is applied to both the production methods [B] of the present invention (an aspect of producing a catalyst masterbatch), both the silane masterbatch and the catalyst masterbatch: intermediate products of the silane crosslinkable silicone rubber composition [B] can be prepared as pellets that are difficult to fuse.

The silane crosslinkable silicone rubber composition according to another preferred embodiment of the present invention (hereinafter, may be simply referred to as “silane crosslinkable silicone rubber composition [C]”) includes, with respect to 100 parts by mass of a base rubber containing a millable silicone rubber and an ethylene copolymer resin, 1 to 15 parts by mass of a silane coupling agent graft-bonded to the base rubber, 0.2 to 8 parts by mass of a hindered phenol-based antioxidant, 0.2 to 5 parts by mass of a hydrazine-based metal inactivator, 1.5 to 15 parts by mass of a benzimidazole-based antioxidant, 0.5 to 100 parts by mass of an inorganic filler, and 0.01 to 0.5 parts by mass of a silanol condensation catalyst. This silane crosslinkable silicone rubber composition [C] can be prepared by appropriately mixing the above components, and is preferably prepared by the method of producing a silane crosslinkable silicone rubber composition of another preferred embodiment of the present invention (hereinafter, may be simply referred to as “method [C] of producing a silane crosslinkable silicone rubber composition”) as described later. The silane crosslinkable silicone rubber composition [C] can also be referred to as a melt-mixture of a silane masterbatch with a silanol condensation catalyst or a catalyst masterbatch, as described later.

As will be described in detail later, the silane crosslinkable silicone rubber composition [C] of another preferred embodiment of the present invention includes a silane crosslinkable silicone rubber in which a silane coupling agent bonded or dissociated with an inorganic filler is grafted (grafting reaction) to a millable silicone rubber (organopolysiloxane), together with three kinds of antioxidants and an inorganic filler.

The silane crosslinkable silicone rubber composition [C] according to another preferred embodiment of the present invention causes a silanol condensation reaction under mild conditions without requiring special crosslinking equipment, such as a chemical crosslinking tube or an electron beam crosslinking machine, to produce the silane crosslinked silicone rubber formed body having excellent outer appearance, and high heat resistance and strength (hereinafter, may be simply referred to as “silane crosslinked silicone rubber formed body [C]”), with excellent manufacturability, even with a general-purpose extruder. Accordingly, the silane crosslinkable silicone rubber composition [C] of the present invention is preferably used in the method of producing a silane crosslinked silicone rubber formed body of another preferred embodiment of the present invention (hereinafter, may be simply referred to as “method [C] of producing a silane crosslinked silicone rubber formed body”), or used for the silane crosslinked silicone rubber formed article of another preferred embodiment of the present invention (hereinafter, may be simply referred to as “silane crosslinked silicone rubber formed article [C]”). When this silane crosslinkable silicone rubber composition [C] of another preferred embodiment of the present invention is applied to both the production methods [C] of another preferred embodiment of the present invention (an aspect of producing a catalyst masterbatch), both the silane masterbatch and the catalyst masterbatch: intermediate products of the silane crosslinkable silicone rubber composition [C] can be prepared as pellets that are difficult to fuse.

### [Silane Crosslinked Silicone Rubber Formed Body]

The silane crosslinked silicone rubber formed bodies [A] to [C] in the present invention and each preferred aspect are the crosslinked silicone rubber formed bodies (formed bodies composed of silanol condensates of the silane crosslinkable silicone rubber composition) obtained by forming the silane crosslinkable silicone rubber compositions [A] to [C] in the present invention and each preferred aspect and then subjecting the silane crosslinkable silicone rubber compositions [A] to [C] to silane crosslinking (silanol condensation reaction).

The silane crosslinked silicone rubber formed body [A] of the present invention exhibits excellent outer appearance, and shows sufficient heat resistance and high strength since a crosslinked structure in which an inorganic filler is spirally wound is constructed, in addition to the crosslinked structure at the crosslinking point (vinyl group) of the millable silicone rubber (organopolysiloxane).

As will be described in detail later, the silane crosslinked silicone rubber formed body [A] of the present invention has a crosslinked structure in which a base rubber, ordinarily a millable silicone rubber, is silane-crosslinked (crosslinked structure via a silane coupling agent or a silanol condensate thereof). It is considered that the inorganic filler is incorporated in a part of the crosslinked structure as described later. Note that, the silane crosslinked silicone rubber formed body [A] of the present invention may appropriately contain a crosslinked silicone rubber in which millable silicone rubbers are crosslinked with each other. The content of the crosslinked silicone rubber is not unambiguously determined depending on the selectivity of the grafting reaction of the silane coupling agent to the millable silicone rubber, the content of the crosslinking point in the millable silicone rubber, and the like, but is at least within a range that does not impair the action and effect of the present invention.

The silane crosslinked silicone rubber formed body [A] of the present invention is formed into an appropriate shape and size depending on the intended use, for example, the use of the silane crosslinked silicone rubber formed article [A] of the present invention as described later.

The silane crosslinked silicone rubber formed body [B] according to a preferred embodiment of the present invention is well compatible with fluororubber while constructing a crosslinked structure in which an inorganic filler is spirally wound, in addition to the crosslinked structure at the crosslinking point (vinyl group) of the millable silicone rubber (organopolysiloxane), and exhibits a high level of heat resistance and strength without impairing the excellent outer appearance.

As will be described in detail later, the silane crosslinked silicone rubber formed body [B] of the present invention has a crosslinked structure in which a millable silicone rubber is silane-crosslinked (crosslinked structure via a silane coupling agent or a silanol condensate thereof). It is considered that the inorganic filler is incorporated in a part of the crosslinked structure as described later.

The silane crosslinked silicone rubber formed body [B] of a preferred embodiment of the present invention is formed into an appropriate shape and size depending on the intended use, for example, the use of the silane crosslinked silicone rubber formed article [B] of the present invention as described later.

The silane crosslinked silicone rubber formed body [C] according to another preferred embodiment of the present invention is highly compatible with an ethylene copolymer resin in the coexistence of three kinds of antioxidants while constructing a crosslinked structure in which an inorganic filler is spirally wound, in addition to the crosslinked structure at the crosslinking point (vinyl group) of the millable silicone rubber (organopolysiloxane). Accordingly, excellent outer appearance is shown and a high level of heat resistance and strength are shown.

As will be described in detail later, the silane crosslinked silicone rubber formed body [C] of the present invention has a crosslinked structure in which a millable silicone rubber is silane-crosslinked (crosslinked structure via a silane coupling agent or a silanol condensate thereof). It is considered that the inorganic filler is incorporated in a part of the crosslinked structure as described later.

The silane crosslinked silicone rubber formed body [C] of a preferred embodiment of the present invention is formed into an appropriate shape and size depending on the intended use, for example, the use of the silane crosslinked silicone rubber formed article [C] of the present invention as described later.

Hereinafter, each component to be used in the present invention will be explained.

One kind or two or more kinds of each component can be used.

In the present invention, the term “rubber” is used in the sense of including an elastomer unless otherwise specified.

### <Base Rubber [A]>

A base rubber [A] used in the present invention contains a millable silicone rubber as an essential component, and may appropriately contain other rubbers or various resins as optional components.

### (Millable Silicone Rubber)

The millable silicone rubber is used as a compound obtained by blending a linear organopolysiloxane (uncrosslinked body) as a main raw material (silicone raw rubber) with a reinforcing agent, ordinarily silica.

The millable silicone rubber shows high thermal stability even at a temperature equal to or higher than a decomposition temperature (180° C.) of the organic peroxide, and can cause a grafting reaction with a silane coupling agent with good workability. According to the studies by the present inventors, it has been revealed that even in the presence of a specific amount of an inorganic filler, an organopolysiloxane in which a reinforcing agent is not blended in advance is a clay-like solid, a gum, or a liquid and has a crosslinking point (vinyl group), the organopolysiloxane hardly undergoes a grafting reaction with a silane coupling agent, and a silane crosslinking method cannot be applied. In the present invention, it is further found that an organopolysiloxane (millable silicone rubber) in which a reinforcing agent is blended in advance can preferentially cause a grafting reaction with a silane coupling agent, rather than a crosslinking reaction between organopolysiloxanes, in the presence of a specific amount of an inorganic filler to generate an organopolysiloxane to which the silane coupling agent is graft-bonded. In the present invention, based on this finding, the silane crosslinking method can be applied for the first time only after a silane coupling agent is graft-bonded to a millable silicone rubber as a compound in a state in which a specific amount of an inorganic filler separately coexists.

That is, in the present invention, the millable silicone rubber as a compound obtained by blending an organopolysiloxane and a reinforcing agent is used as a rubber component constituting a base rubber.

The organopolysiloxane may be any organopolysiloxane as long as the silane coupling agent is capable of grafting reaction, and examples of the site (crosslinking point) capable of grafting reaction include an organopolysiloxane containing a vinyl group, and specific examples thereof include methylvinylpolysiloxane, methylphenylvinylpolysiloxane, and methylfluoroalkylpolysiloxane. The fluoroalkyl is not particularly limited, and examples thereof include a 3,3,3-trifluoropropyl group. Note that an end group of the organopolysiloxane is not particularly limited, and examples thereof include an alkyl group (methyl group), a vinyl group, and a hydroxyl group.

A content of the vinyl group in the organopolysiloxane is not particularly limited, and can be appropriately determined depending on the degree of crosslinking, and can be, for example, 0.025 to 1.0 (mol %). The content of the vinyl group can be measured by, for example, infrared absorption spectroscopy (FT-IR) or proton NMR (¹H-NMR). A content of each of the phenyl group and the fluoroalkyl group in the organopolysiloxane is not particularly limited, and is appropriately determined according to the use, required characteristics, and the like. Further, a degree of polymerization of the organopolysiloxane is not particularly limited, and can be, for example, 3,000 to 10,000.

The millable silicone rubber contains a reinforcing agent (a filler). The reinforcing agent is not particularly limited, and examples thereof include various silicas such as fumed silica (also referred to as fumed silica or dry silica), precipitated silica, diatomaceous earth, and quartz powder, and surface-treated silicas thereof. As the reinforcing agent, fumed silica is preferable from the viewpoint of formability, outer appearance of the formed body, insulation resistance, and the like. A BET specific surface area of the reinforcing agent is not particularly limited, and is preferably, for example, about 50 to 300 m²/g. As a method of measuring the BET specific surface area, for example, in accordance with the method specified in Japanese Industrial Standard (JIS) Z 8830 (2013), gas molecules having a known adsorption occupancy area, such as nitrogen gas, are adsorbed onto the surface of powder particles, and the specific surface area of the sample can be determined from the amount of the gas molecules (BET method).

A specific gravity of the millable silicone rubber (before the silane coupling agent is graft-bonded) is not particularly limited, and can be appropriately set according to the use, required characteristics, and the like. When the millable silicone rubber has a small specific gravity, the content of the reinforcing agent in the millable silicone rubber decreases, and thus the compatibility (fluidity) of the base rubber during forming of the silane-crosslinked silicone rubber composition is improved. As a result, when the millable silicone rubber having a small specific gravity is used, the forming can be performed with a general-purpose extruder without impairing excellent manufacturability, and high heat resistance and strength can be realized while maintaining excellent outer appearance. The specific gravity of the millable silicone rubber may be set to 1.05 to 1.50 g/cm³, but is preferably 1.05 to 1.25 g/cm³, more preferably 1.10 to 1.20 g/cm³, still more preferably 1.10 to 1.15 g/cm³, and particularly preferably 1.11 to 1.14 g/cm³ from the viewpoint of being able to achieve a good balance between heat resistance and strength at a high level while solving the problem of formability. The specific gravity of the millable silicone rubber is a value measured by a method described in Examples as described later.

A content of the reinforcing agent in the millable silicone rubber is not particularly limited as long as the specific gravity of the millable silicone rubber is within the above range, and can be appropriately set according to the use, required characteristics, and the like, in addition to the specific gravity. For example, the content of the reinforcing agent in the millable silicone rubber may be, for example, 10 to 40 mass %, preferably 12 to 38 mass %, and more preferably 14 to 35 mass % in 100 mass % of the millable silicone rubber, although it depends on the specific gravity of the reinforcing agent and the like.

The millable silicone rubber may contain a filler other than the reinforcing agent, a dispersion accelerator, and other additives, for example, within a range of satisfying the above-described specific gravity.

The millable silicone rubber may be prepared by mixing an organopolysiloxane, a reinforcing agent, and the above-described additives as appropriate, or a commercially available product (a compound not containing a crosslinking agent (curing agent)) may be used. Examples of the commercially available product include ELASTSIL R 401 series (manufactured by Wacker Asahikasei Silicone Co., Ltd.), XIAMETER RBB6660 series (manufactured by Dow Corning Corp.), Rubber Compound KE series (manufactured by Shin-Etsu Silicone Co., Ltd.), Millable Silicone Rubber TSE series (manufactured by Momentive Performance Materials Inc.), and the like.

The base rubber [A] may contain any rubber or resin other than the millable silicone rubber. Examples of the resin include polyolefin resin, and examples of the rubber include rubbers or elastomers, such as polymers that form polyolefin resins.

The present invention encompasses both an aspect in which the base rubber [A] contains at least one of an ethylene copolymer resin and a fluororubber and an aspect in which the base rubber [A] does not contain at least one of an ethylene copolymer resin and a fluororubber. Note that the phrase “the base rubber [A] does not contain at least one of an ethylene copolymer resin and a fluororubber” is not limited to an aspect in which the content of each of the ethylene copolymer resin and the fluororubber in the base rubber (rubber composition) [A] is 0 mass %, and includes a range in which the effect of the present invention is not impaired, for example, an aspect in which the content of each of the ethylene copolymer resin and the fluororubber in the silane crosslinkable silicone rubber composition [A] or the like is less than 5 mass %.

### (Polyolefin Resin)

The polyolefin resin that can be contained in the base rubber [A] is not particularly limited, and examples thereof include a resin formed of a polymer obtained by homopolymerizing or copolymerizing an olefin compound. For example, known resins used for various resin compositions can be mentioned. The polyolefin resin ordinarily has a site capable of grafting reaction with a grafting reaction site of a silane coupling agent as described later in the presence of an organic peroxide (examples of said site capable of grafting reaction include an unsaturated bond site of the carbon chain, and a carbon atom having a hydrogen atom) in a main chain or at the end thereof. Specific examples of the polyolefin resin include resins such as polyethylene (PE), polypropylene (PP), and polyolefin copolymer including an acid copolymerized component or an acid ester copolymerized component. As the polyolefin resin, a polyethylene resin, a polypropylene resin, or a resin of a polyolefin copolymer including an acid copolymerized component or an acid ester copolymerized component is preferable. Note that the polyolefin resin may be acid-modified with a commonly used unsaturated carboxylic acid, a derivative thereof, or the like.

When the polyethylene resin, the polypropylene resin, or the like is used in combination with the millable silicone rubber in the base rubber [A], extrusion forming with a general-purpose extruder may be possible.

### —Polyethylene Resin—

The polyethylene resin (PE) is not particularly limited as long as it is a resin of a polymer including an ethylene component as a main component. Examples thereof include various resins such as high-density polyethylene (HDPE), low-density polyethylene (LDPE), ultrahigh molecular weight polyethylene (UHMW-PE), linear low-density polyethylene (LLDPE), and very low density polyethylene (VLDPE).

### —Polypropylene Resin—

The polypropylene resin (PP) is not particularly limited as long as it is a resin of a polymer including a propylene component as a main component. Examples thereof include various resins such as random polypropylene and block polypropylene, in addition to a homopolymer of propylene.

### —Polyolefin Copolymer Resin Including Acid Copolymerized Component or Acid Ester Copolymerized Component—

When a polyolefin copolymer resin including an acid copolymerized component or an acid ester copolymerized component is used in combination with a millable silicone rubber, extrusion forming with a general-purpose extruder becomes possible, and the strength of the silane crosslinked silicone rubber formed body [A] can be further increased. Further, in the method of producing a silane crosslinkable silicone rubber composition of the present invention (an aspect of producing a catalyst masterbatch) [A] as described later, the silane masterbatch and the catalyst masterbatch: intermediate products of the silane crosslinkable silicone rubber composition [A] can be pelletized, and blocking (fusion) of pellets can also be suppressed.

The compound that leads an acid copolymerized component or an acid ester copolymerized component in the resin of the polyolefin copolymer including the acid copolymerized component or the acid ester copolymerized component is not particularly limited, and examples thereof include carboxylic acid compounds such as (meth)acrylic acid, and acid ester compounds such as vinyl acetate and alkyl (meth)acrylate. The alkyl group of the alkyl (meth)acrylate is preferably one with carbon numbers 1 to 12.

Examples of the polyolefin copolymer including an acid copolymerized component or an acid ester copolymerized component include those exemplified in the base rubber [B] as described later, and examples thereof include an ethylene-vinyl acetate copolymer (EVA), an ethylene-methyl acrylate copolymer (EMA), an ethylene-ethyl acrylate copolymer (EEA), and an ethylene-butyl acrylate copolymer (EBA).

(Rubber Other than Millable Silicone Rubber)

The rubber other than the millable silicone rubber is not particularly limited, and examples thereof include known rubbers used for various rubber compositions. The rubber other than the millable silicone rubber may have or need not have a site capable of grafting reaction with the grafting reaction site of the silane coupling agent. Specific examples of the rubber other than the millable silicone rubber include an ethylene-α-olefin copolymer rubber, a styrene-based elastomer, a fluororubber, an acrylic rubber, and the like.

### —Ethylene-α-Olefin Copolymer Rubber—

The ethylene-α-olefin copolymer rubber (in the present invention, it is also referred to as ethylene rubber) is not particularly limited as long as it is rubber of a copolymer obtained by copolymerizing ethylene and an α-olefin. Known rubbers can be used. Preferably, the ethylene-α-olefin copolymer rubber includes a binary copolymer rubber of ethylene and α-olefin, a ternary copolymer rubber of ethylene, α-olefin, and a diene compound, and the like. The α-olefin is not particularly limited, and α-olefins with carbon numbers 3 to 12 are preferable. Further, the diene compound constituting the ternary copolymer is not particularly limited, and examples thereof include conjugated diene compounds such as butadiene, isoprene, 1,3-pentadiene and 2,3-dimethyl-1,3-butadiene, and non-conjugated diene compounds such as dicyclopentadiene (DCPD), ethylidene norbornene (ENB) and 1,4-hexadiene. Non-conjugated diene compounds are preferable. As the binary copolymer rubber, an ethylene-propylene rubber (EPM) is preferable. As the ternary copolymer, an ethylene-propylene-diene rubber (EPDM) is preferable.

### —Styrene-Based Elastomer—

The styrene-based elastomer refers to an elastomer including a polymer including a constituent derived from an aromatic vinyl compound in a molecule. Examples of the styrene-based elastomer include block and random copolymers of a conjugated diene compound and an aromatic vinyl compound, or hydrogenated products thereof, and the like. Specific examples thereof include styrene-ethylene-butylene-styrene block copolymer (SEBS), styrene-isoprene-styrene block copolymer (SIS), hydrogenated SIS, styrene-butadiene-styrene block copolymer (SBS), hydrogenated SBS, styrene-ethylene-ethylene-propylene-styrene block copolymer (SEEPS), styrene-ethylene-propylene-styrene block copolymer (SEPS), styrene-butadiene rubber (SBR), hydrogenated styrene-butadiene rubber (HSBR), and the like.

### —Fluororubber—

The fluororubber is not particularly limited, and use can be made of ordinary fluororubber that has been used so far in a heat-resistant rubber formed body.

Such a fluororubber is not particularly limited, and examples thereof include copolymer rubber between fluorine-containing monomers, such as perfluorohydrocarbon including tetrafluoroethylene and hexafluoropropylene, and partially fluorinated hydrocarbon such as vinylidene fluoride, and further copolymer rubber of these fluorine-containing monomers and a hydrocarbon, such as ethylene and/or propylene. Specific examples include tetrafluoroethylene-propylene copolymer rubber (FEPM), tetrafluoroethylene-fluoropropylene (for example, hexafluoropropylene) copolymer rubber, tetrafluoroethylene-perfluorovinyl ether copolymer rubber (FFKM), vinylidene fluoride rubber (FKM, for example, vinylidene fluoride-hexafluoropropylene copolymer rubber). Further, examples thereof also include the above-described copolymer rubber of fluorine-containing monomers and chloroprene and/or chlorosulfonated polyethylene.

### —Acrylic Rubber—

Examples of the acrylic rubber (also referred to as ethylene-acrylic rubber) include a rubber obtained by copolymerizing at least ethylene and acrylic acid alkyl ester as components. The acrylic acid alkyl ester is not particularly limited, and examples thereof include methyl acrylate and ethyl acrylate.

As the acrylic rubber, copolymer rubbers, such as a binary copolymer of ethylene and acrylic acid alkyl ester, and a ternary copolymer obtained by copolymerizing a copolymerization component further containing a carboxy group with the binary copolymer can be preferably used. The copolymerization component containing a carboxy group is not particularly limited, and examples thereof include (meth)acrylic acid and maleic acid.

### (Mineral Oil)

The base rubber [A] can also contain a mineral oil. Examples of the mineral oil include paraffin oil, naphthene oil, aromatic oil, and the like, and paraffin oil is preferable. Preferably, the mineral oil is contained, particularly together with an elastomer.

### (Composition of Base Rubber [A])

The base rubber [A] contains each component at the following content rate so as to be 100 mass % in total. When the base rubber contains a plurality of components, the content rate of the components is the total content rate of the plurality of components.

The content rate of the millable silicone rubber in 100 mass % of the base rubber [A] is not particularly limited, and is preferably 70 mass % or more from the viewpoint of being able to construct a sufficient crosslinked structure, and is more preferably 75 to 100 mass %, still more preferably 78 to 95 mass %, and particularly preferably 80 to 90 mass % from the viewpoint of being able to achieve both heat resistance and tensile strength at a higher level.

The total content rate of the polyolefin resin in 100 mass % of the base rubber [A] is not particularly limited, and is appropriately determined. For example, the total content rate is preferably 0 to 70 mass %, more preferably 5 to 50 mass %, and still more preferably 10 to 40 mass %.

The content rate of the polyethylene resin in 100 mass % of the base rubber [A] is not particularly limited, and is appropriately set in consideration of the total content of the polyolefin resin. For example, the content rate is preferably 0 to 25 mass %, and more preferably 5 to 20 mass %. Similarly, the content rate of the polypropylene resin in 100 mass % of the base rubber [A] is not particularly limited, and is appropriately set in consideration of the total content of the polyolefin resin. For example, the content rate is preferably 0 to 25 mass %, and more preferably 2 to 20 mass %. The content rate of the resin of the polyolefin copolymer including an acid copolymerized component or an acid ester copolymerized component in 100 mass % of the base rubber [A] is not particularly limited, and is appropriately set in consideration of the total content of the polyolefin resin. For example, the content rate is preferably 0 to 25 mass %, more preferably 5 to 20 mass %, and more preferably 2 to 15 mass %.

The total content rate of the rubber other than the millable silicone rubber in 100 mass % of the base rubber [A] is not particularly limited, and is appropriately determined. For example, the total content rate is preferably 0 to 50 mass %, more preferably 5 to 45 mass %, and still more preferably 8 to 40 mass %.

The content rate of the ethylene-α-olefin copolymer rubber in 100 mass % of the base rubber [A] is not particularly limited, and is appropriately set in consideration of the total content of the rubber. For example, the content rate is preferably 0 to 25 mass %, more preferably 0 to 20 mass %, and still more preferably 0 to 15 mass %. The content rate of the styrene-based elastomer in 100 mass % of the base rubber [A] is not particularly limited, and is appropriately set in consideration of the total content of the rubber. For example, the content rate is preferably 0 to 25 mass %, and more preferably 0 to 15 mass %. The content rate of each of the fluororubber and the acrylic rubber in 100 mass % of the base rubber [A] is not particularly limited, and is appropriately set in consideration of the total content of the rubber. For example, the content rate may be set to 8 to 40 mass %.

The content rate of the mineral oil in 100 mass % of the base rubber [A] is not particularly limited, and is appropriately determined. For example, the content rate is preferably 0 to 25 mass %, and more preferably 0 to 20 mass %.

### <Base Rubber [B]>

The base rubber [B] used in a preferred embodiment of the present invention contains a millable silicone rubber and a fluororubber as essential components, and may appropriately contain other rubbers or various resins as optional components.

### (Millable Silicone Rubber)

The millable silicone rubber is used as a compound obtained by blending a linear organopolysiloxane (uncrosslinked body) as a main raw material (silicone raw rubber) with a reinforcing agent, ordinarily silica.

The millable silicone rubber shows high thermal stability even at a temperature equal to or higher than a decomposition temperature (180° C.) of the organic peroxide, and can cause a grafting reaction with a silane coupling agent with good workability. According to the studies by the present inventors, it has been revealed that even in the presence of a specific amount of an inorganic filler, an organopolysiloxane in which a reinforcing agent is not blended in advance is a clay-like solid, a gum, or a liquid and has a crosslinking point (vinyl group), the organopolysiloxane hardly undergoes a grafting reaction with a silane coupling agent, and a silane crosslinking method cannot be applied. In a preferred embodiment of the present invention, it is further found that an organopolysiloxane (millable silicone rubber) in which a reinforcing agent is blended in advance can preferentially cause a grafting reaction with a silane coupling agent, rather than a crosslinking reaction between organopolysiloxanes, in the presence of a specific amount of an inorganic filler to generate an organopolysiloxane to which the silane coupling agent is graft-bonded. In the present invention, based on this finding, the silane crosslinking method can be applied for the first time only after a silane coupling agent is graft-bonded to a millable silicone rubber as a compound in a state in which a fluororubber and a specific amount of an inorganic filler separately coexist.

The millable silicone rubber is the same as the millable silicone rubber in the base rubber [A].

### (Fluororubber)

In a preferred embodiment of the present invention, the fluororubber as described later is used as an essential component of the base rubber.

When the silane crosslinked silicone rubber formed body [B] contains the fluororubber, the silane crosslinked silicone rubber formed body [B] can be made to exhibit a high level of heat resistance and strength, and can be a formed body that does not melt even at a high temperature. Here, the heat resistance that does not melt even at a high temperature refers to a property that does not melt at a temperature of preferably 200° C., and more preferably 200° C. or higher. There is no upper limit to the temperature at which the silane crosslinked silicone rubber formed body is not melted, and 300° C. or lower is practical.

The fluororubber is not particularly limited, and use can be made of ordinary fluororubber that has been used so far in various rubber formed bodies. Specific examples of the fluororubber include a homopolymer or copolymer rubber containing a fluorine atom in a main chain or a side chain. The fluororubber can be ordinarily obtained by polymerizing (copolymerizing) a monomer containing the fluorine atom.

Such a fluororubber is not particularly limited, and examples thereof may include the same fluororubber as the fluororubber in the base rubber [A]. Among the above-described fluororubbers, tetrafluoroethylene-propylene copolymer rubber and vinylidene fluoride-hexafluoropropylene copolymer rubber are preferable, and tetrafluoroethylene-propylene copolymer rubber is more preferable.

A content of the fluorine atom in the fluororubber that can be contained in the base rubber [B] (mass ratio of the fluorine atom with regard to the total amount of the fluororubber) is not particularly limited, and is preferably 25 mass % or more, more preferably 40 mass % or more, and still more preferably 50 mass % or more. An upper limit of the fluorine content is a mass ratio when all of hydrogen atoms of a polymer before being fluorinated, and capable of being replaced by the fluorine atom are replaced by the fluorine atom, and cannot be unambiguously determined as this varies depending on a molecular weight of the polymer before being fluorinated, the number of hydrogen atoms that can be replaced by the fluorine atom, or the like. For example, the upper limit can be taken as 75 mass %. In a preferred embodiment of the present invention, the fluorine content is determined according to a calculated value in synthesis, or a potassium carbonate pyrohydrolysis method. Specific examples of the potassium carbonate pyrohydrolysis method include the method described by Makoto Noshiro et al., NIPPON KAGAKU KAISHI, 6, 1236 (1973).

In the present invention, the fluororubber may be appropriately synthesized, or a commercially available product may be used.

Examples of the tetrafluoroethylene-propylene copolymer rubber (FEPM) include AFLAS (trade name, manufactured by Asahi Glass Co., Ltd.). Examples of the tetrafluoroethylene-perfluorovinyl ether copolymer rubber (FFKM) include KALREZ (trade name, manufactured by DuPont). Examples of the vinylidene fluoride rubber (FKM) include VITON (trade name, manufactured by DuPont), DAI-EL (trade name, manufactured by Daikin Industries, Ltd.), DYNEON (trade name, manufactured by 3M Company), and TECNOFLON (trade name, manufactured by Solvay Specialty).

In a preferred embodiment of the present invention, the base rubber [B] may contain any rubber or resin other than the millable silicone rubber and other than the fluororubber. Examples of the resin include polyolefin resin, and examples of the rubber include rubbers or elastomers, such as polymers that form polyolefin resins.

### (Polyolefin Resin)

The polyolefin resin that can be contained in the base rubber [B] is not particularly limited, and is basically the same as the polyolefin resin in the base rubber [A]. For example, the polyethylene resin and the polypropylene resin are the same as the polyethylene resin and the polypropylene resin in the base rubber [A]. In a preferred embodiment of the present invention, the polyethylene resin, the polypropylene resin, and the like are preferably used in combination with the following ethylene copolymer resin as the polyolefin resin. That is, when the base rubber [B] contains the polyethylene resin or the polypropylene resin, the base rubber [B] preferably contains the ethylene copolymer resin from the viewpoint of heat resistance and the like.

### —Ethylene Copolymer Resin—

In a preferred embodiment of the present invention, the ethylene copolymer resin refers to a resin of an ethylene copolymer including an acid copolymerized component or an acid ester copolymerized component, among copolymer resins containing ethylene as a copolymerization component. That is, even in the case of a copolymer resin containing ethylene as a copolymerization component, a resin not including an acid copolymerized component or an acid ester copolymerized component is not included in the ethylene copolymer resin.

In a preferred embodiment of the present invention, when the base rubber [B] contains the ethylene copolymer resin, the silane crosslinked silicone rubber formed body [B] can be produced using general-purpose production equipment, particularly can be extrusion-formed using a general-purpose extruder, while maintaining or improving the remarkable heat resistance and strength of the silane crosslinked silicone rubber formed body [B]. Further, in the method of producing a silane crosslinkable silicone rubber composition of a preferred embodiment of the present invention (an aspect of producing a catalyst masterbatch) [B] as described later, the silane masterbatch and the catalyst masterbatch: intermediate products of the silane crosslinkable silicone rubber composition [B] can be pelletized, and fusion (blocking) of pellets can also be suppressed. Although the details of the reason for exhibiting the above-described action and effect are not yet clear, it is considered that when the ethylene copolymer resin is allowed to coexist in the silane crosslinking method, the fluidity of the reaction system can be increased without inhibiting the preferential and selective grafting reaction of the silane coupling agent to the millable silicone rubber during the grafting reaction, and as a result, the melt-mixture during the extrusion forming also maintains high fluidity.

The compound that leads an acid copolymerized component or an acid ester copolymerized component in the ethylene copolymer resin is the same as the compound in a resin of an ethylene copolymer including an acid copolymerized component or an acid ester copolymerized component in the base rubber [A].

Examples of such an ethylene copolymer resin include resins of an ethylene-vinyl acetate copolymer (EVA), an ethylene-(meth)acrylic acid ester copolymer, and an ethylene-(meth)acrylic acid copolymer. The resin composed of the ethylene-(meth)acrylic acid ester copolymer and the ethylene-(meth)acrylic acid copolymer is not particularly limited, and ordinary resins can be used. The (meth)acrylic acid ester that forms the ethylene-(meth)acrylic acid ester copolymer is not particularly limited, and examples thereof include an ester of an alcohol with carbon numbers 1 to 12 and (meth)acrylic acid. Specific examples thereof include methyl (meth)acrylate, ethyl (meth)acrylate, n-butyl (meth)acrylate, t-butyl (meth)acrylate, and 2-ethylhexyl (meth)acrylate. Examples of the resin of the ethylene-(meth)acrylic acid ester copolymer include resins of an ethylene-methyl acrylate copolymer (EMA), an ethylene-ethyl acrylate copolymer (EEA), and an ethylene-butyl acrylate copolymer (EBA).

Among the resins, a resin of an ethylene-vinyl acetate copolymer (EVA) and a resin of an ethylene-(meth)acrylic acid ester copolymer are preferable, and a resin of an ethylene-ethyl acrylate copolymer (EEA) is more preferable from the viewpoint of compatibility with silicone rubber, strength characteristics, heat resistance, and the like.

The content of the copolymerization component in the ethylene copolymer resin is not particularly limited, and can be appropriately set, but the content of the copolymerization component is preferably 15 to 45 mass %.

(Rubber Other than Millable Silicone Rubber)

The rubber other than the millable silicone rubber and other than the fluororubber is not particularly limited, and examples thereof include known rubbers used for various rubber compositions. Specific examples thereof include an ethylene-α-olefin copolymer rubber, a styrene-based elastomer, an acrylic rubber, and the like.

The ethylene-α-olefin copolymer rubber, the styrene-based elastomer, and the acrylic rubber in the base rubber [B] are the same as the respective rubbers in the base rubber [A].

### (Mineral Oil)

The base rubber [B] can also contain a mineral oil. The mineral oil is the same as the mineral oil in the base rubber [A].

### (Composition of Base Rubber [B])

The base rubber [B] contains each component at the following content rate so as to be 100 mass % in total. When the base rubber contains a plurality of components, the content rate of the components is the total content rate of the plurality of components.

The content rate of the millable silicone rubber in 100 mass % of the base rubber [B] is not particularly limited, and is preferably 30 to 80 mass % from the viewpoint of being able to construct a sufficient crosslinked structure while solving the problem of formability, and is more preferably 35 to 70 mass %, still more preferably 40 to 60 mass %, and particularly preferably 40 to 55 mass % from the viewpoint of being able to achieve outer appearance, heat resistance, and strength at a higher level.

The content rate of the fluororubber in 100 mass % of the base rubber [B] is not particularly limited, and is preferably 5 to 40 mass % from the viewpoint of achieving high heat resistance and strength while solving the problem of formability, and is more preferably 10 to 35 mass %, still more preferably 12 to 32 mass %, and particularly preferably 15 to 30 mass % from the viewpoint of being able to achieve a good balance between heat resistance and tensile strength at a higher level.

The total content rate of the polyolefin resin in 100 mass % of the base rubber [B] is not particularly limited, and is appropriately determined. For example, the total content rate is preferably 0 to 70 mass %, more preferably 5 to 50 mass %, and still more preferably 10 to 40 mass %.

The content rate of the polyethylene resin in 100 mass % of the base rubber [B] is not particularly limited, and is appropriately set in consideration of the total content of the polyolefin resin. For example, the content rate is preferably 0 to 25 mass %, and more preferably 5 to 20 mass %. Similarly, the content rate of the polypropylene resin in 100 mass % of the base rubber [B] is not particularly limited, and is appropriately set in consideration of the total content of the polyolefin resin. For example, the content rate is preferably 0 to 25 mass %, and more preferably 2 to 20 mass %. The content rate of the ethylene copolymer resin in 100 mass % of the base rubber [B] is not particularly limited, and is appropriately set in consideration of the total content of the polyolefin resin. For example, the content rate is preferably 5 to 30 mass %, more preferably 10 to 30 mass %, and still more preferably 15 to 25 mass % from the viewpoint of achieving the outer appearance, heat resistance, and tensile strength of the silane crosslinked silicone rubber formed body [B], while solving the problem of formability.

The total content rate of the rubber other than the millable silicone rubber and other than the fluororubber in 100 mass % of the base rubber [B] is not particularly limited, and is appropriately determined. For example, the total content rate is preferably 0 to 50 mass %, more preferably 5 to 45 mass %, and still more preferably 8 to 40 mass %.

The content rate of the ethylene-α-olefin copolymer rubber in 100 mass % of the base rubber [B] is not particularly limited, and is appropriately set in consideration of the total content of the rubber. For example, the content rate is preferably 0 to 25 mass %, more preferably 0 to 20 mass %, and still more preferably 0 to 15 mass %. The content rate of the styrene-based elastomer in 100 mass % of the base rubber [B] is not particularly limited, and is appropriately set in consideration of the total content of the rubber. For example, the content rate is preferably 0 to 25 mass %, and more preferably 0 to 15 mass %. The content rate of the acrylic rubber in 100 mass % of the base rubber [B] is not particularly limited, and is appropriately set in consideration of the total content of the rubber. For example, the content rate may be set to 8 to 40 mass %.

The content rate of the mineral oil in 100 mass % of the base rubber [B] is not particularly limited, and is appropriately determined. For example, the content rate is preferably 0 to 25 mass %, and more preferably 0 to 20 mass %.

### <Base Rubber [C]>

The base rubber [C] used in another preferred embodiment of the present invention contains a millable silicone rubber and an ethylene copolymer resin as essential components, and may appropriately contain other rubbers or various resins as optional components.

### (Millable Silicone Rubber)

The millable silicone rubber is used as a compound obtained by blending a linear organopolysiloxane (uncrosslinked body) as a main raw material (silicone raw rubber) with a reinforcing agent, ordinarily silica.

The millable silicone rubber shows high thermal stability even at a temperature equal to or higher than a decomposition temperature (180° C.) of the organic peroxide, and can cause a grafting reaction with a silane coupling agent with good workability. According to the studies by the present inventors, it has been revealed that even in the presence of a specific amount of an inorganic filler, an organopolysiloxane in which a reinforcing agent is not blended in advance is a clay-like solid, a gum, or a liquid and has a crosslinking point (vinyl group), the organopolysiloxane hardly undergoes a grafting reaction with a silane coupling agent, and a silane crosslinking method cannot be applied. In another preferred embodiment of the present invention, it is further found that an organopolysiloxane (millable silicone rubber) in which a reinforcing agent is blended in advance can preferentially cause a grafting reaction with a silane coupling agent, rather than a crosslinking reaction between organopolysiloxanes, through increased fluidity of a reaction system due to the coexistence of an ethylene copolymer resin in the presence of a specific amount of an inorganic filler to generate an organopolysiloxane to which the silane coupling agent is graft-bonded. In the present invention, based on this finding, a highly precise silane crosslinking method can be applied for the first time only after a silane coupling agent is graft-bonded to a millable silicone rubber as a compound in a state in which a specific amount of an inorganic filler and an ethylene-based copolymer resin separately coexist.

The millable silicone rubber is the same as the millable silicone rubber in the base rubber [A]. {0072}

### (Ethylene Copolymer Resin)

In another preferred embodiment of the present invention, the ethylene copolymer resin as described later is used as an essential component of the base rubber [C].

In another preferred embodiment of the present invention, the ethylene copolymer resin refers to a resin of an ethylene copolymer including an acid copolymerized component or an acid ester copolymerized component, among copolymer resins containing ethylene as a copolymerization component. That is, even in the case of a copolymer resin containing ethylene as a copolymerization component, a resin not including an acid copolymerized component or an acid ester copolymerized component is not included in the ethylene copolymer resin.

In another preferred embodiment of the present invention, when the base rubber contains the ethylene copolymer resin, the silane crosslinked silicone rubber formed body [C] can be produced using general-purpose production equipment, particularly can be extrusion-formed using a general-purpose extruder, and the strength of the silane crosslinked silicone rubber formed body [C] can be further enhanced. Further, in the method [C] of producing a silane crosslinkable silicone rubber composition of another preferred embodiment of the present invention (an aspect of producing a catalyst masterbatch) as described later, the silane masterbatch and the catalyst masterbatch: intermediate products of the silane crosslinkable silicone rubber composition [C] can be pelletized, and fusion (blocking) of pellets can also be suppressed. Although the details of the reason for exhibiting the above-described action and effect are not yet clear, it is considered that when the ethylene copolymer resin is allowed to coexist in the silane crosslinking method, the fluidity of the reaction system can be increased without inhibiting the preferential and selective grafting reaction of the silane coupling agent to the millable silicone rubber during the grafting reaction, and as a result, the melt-mixture during the extrusion forming also maintains high fluidity.

On the other hand, as described above, it has been found that when the millable silicone rubber and the ethylene copolymer resin are used in combination, the heat resistance of the silane crosslinked silicone rubber formed body is lowered although both of them are well compatible with each other and the fluidity is enhanced. As a result of further studies on this problem, the present inventors have found that when an inorganic filler having a content reduced to 100 parts by mass or less and three kinds of antioxidants combined in a specific ratio are allowed to coexist with a base rubber, not only heat resistance and further a decrease in strength due to the coexistence of the ethylene copolymer resin can be suppressed, but also the heat resistance and strength can be increased to a higher level.

The compound that leads an acid copolymerized component or an acid ester copolymerized component in the ethylene copolymer resin is the same as the compound in a resin of an ethylene copolymer including an acid copolymerized component or an acid ester copolymerized component in the base rubber [A].

Such an ethylene copolymer resin is the same as the ethylene copolymer resin in the base rubber [B].

In another preferred embodiment of the present invention, the base rubber [C] may contain any rubber or resin other than the millable silicone rubber and other than the ethylene copolymer resin. Examples of the resin include polyolefin resins other than the above-described ethylene copolymer resin, and examples of the rubber include rubbers or elastomers, such as polymers that form polyolefin resins.

The base rubber [C] preferably contains a millable silicone rubber, an ethylene copolymer resin, and a fluororubber from the viewpoint of solving the problems of manufacturability and formability and exhibiting higher heat resistance and strength. {0075}(Polyolefin resin) The polyolefin resin that can be contained in the base rubber [C] refers to a polyolefin resin other than the ethylene copolymer resin described above. Such a polyolefin resin is not particularly limited, and is basically the same as the polyolefin resin in the base rubber [A], and specific examples thereof include resins such as polyethylene (PE) and polypropylene (PP). The polyolefin resin is preferably a polyethylene resin or a polypropylene resin. Note that the polyolefin resin may be acid-modified with a commonly used unsaturated carboxylic acid, a derivative thereof, or the like. In another preferred embodiment of the present invention, the polyethylene resin, the polypropylene resin, and the like are preferably used in combination with the ethylene copolymer resin. The polyethylene resin and the polypropylene resin are the same as the polyethylene resin and the polypropylene resin in the base rubber [A].

(Rubber Other than Millable Silicone Rubber)

The rubber other than the millable silicone rubber is not particularly limited, and examples thereof include known rubbers used for various rubber compositions. Specific examples thereof include an ethylene-α-olefin copolymer rubber, a styrene-based elastomer, a fluororubber, an acrylic rubber, and the like. Among the rubbers, a fluororubber is preferable from the viewpoint of heat resistance and strength.

The ethylene-α-olefin copolymer rubber, the styrene-based elastomer, and the acrylic rubber in the base rubber [C] are the same as the respective rubbers in the base rubber [A].

### —Fluororubber—

In a preferred embodiment of the present invention, when the silane crosslinked silicone rubber formed body [C] contains the fluororubber, the silane crosslinked silicone rubber formed body [C] can be made to exhibit a high level of heat resistance and strength, and can be a formed body that does not melt even at a high temperature. Here, the heat resistance that does not melt even at a high temperature refers to a property that does not melt at a temperature of preferably 200° C., and more preferably 200° C. or higher. There is no upper limit to the temperature at which the silane crosslinked silicone rubber formed body is not melted, and 300° C. or lower is practical.

Such a fluororubber is not particularly limited, and examples thereof may include the same fluororubber as the fluororubber in the base rubber [B].

### (Mineral Oil)

The base rubber [C] can also contain a mineral oil. The mineral oil is the same as the mineral oil in the base rubber [A].

### (Composition of Base Rubber [C])

The base rubber [C] contains each component at the following content rate so as to be 100 mass % in total. When the base rubber [C] contains a plurality of components, the content rate of the components is the total content rate of the plurality of components.

The content rate of the millable silicone rubber in 100 mass % of the base rubber [C] is not particularly limited, and is preferably 40 to 80 mass % from the viewpoint of being able to construct a sufficient crosslinked structure while solving the problem of formability, and is more preferably 45 to 70 mass %, still more preferably 50 to 65 mass %, and particularly preferably 50 to 60 mass % from the viewpoint of being able to achieve outer appearance, heat resistance, and strength at a higher level.

The content rate of the ethylene copolymer resin in 100 mass % of the base rubber [C] is not particularly limited, and is preferably 5 to 30 mass %, more preferably 10 to 30 mass %, and still more preferably 15 to 25 mass % from the viewpoint of being able to achieve the outer appearance, heat resistance, and strength of the silane crosslinked silicone rubber formed body [C] while solving the problem of formability.

The total content rate of the polyolefin resin in 100 mass % of the base rubber [C] is not particularly limited, and is appropriately determined. For example, the total content rate is preferably 0 to 70 mass %, more preferably 5 to 50 mass %, and still more preferably 10 to 40 mass %.

The content rate of the polyethylene resin in 100 mass % of the base rubber [C] is not particularly limited, and is appropriately set in consideration of the total content of the polyolefin resin. For example, the content rate is preferably 0 to 25 mass %, and more preferably 5 to 20 mass %. Similarly, the content rate of the polypropylene resin in 100 mass % of the base rubber [C] is not particularly limited, and is appropriately set in consideration of the total content of the polyolefin resin. For example, the content rate is preferably 0 to 25 mass %, and more preferably 2 to 20 mass %.

The total content rate of the rubber other than the millable silicone rubber in 100 mass % of the base rubber [C] is not particularly limited, and is appropriately determined. For example, the total content rate is preferably 0 to 50 mass %, more preferably 5 to 45 mass %, and still more preferably 8 to 40 mass %.

The content rate of the ethylene-α-olefin copolymer rubber in 100 mass % of the base rubber [C] is not particularly limited, and is appropriately set in consideration of the total content of the rubber. For example, the content rate is preferably 0 to 25 mass %, more preferably 0 to 20 mass %, and still more preferably 0 to 15 mass %. The content rate of the styrene-based elastomer in 100 mass % of the base rubber [C] is not particularly limited, and is appropriately set in consideration of the total content of the rubber. For example, the content rate is preferably 0 to 25 mass %, and more preferably 0 to 15 mass %. The content rate of the acrylic rubber in 100 mass % of the base rubber [C] is not particularly limited, and is appropriately set in consideration of the total content of the rubber. For example, the content rate may be set to 8 to 40 mass %.

The content rate of the fluororubber in 100 mass % of the base rubber [C] is not particularly limited, and is preferably 5 to 40 mass % from the viewpoint of being able to achieve high heat resistance and strength while solving the problem of formability, and is more preferably 10 to 35 mass %, still more preferably 12 to 32 mass %, and particularly preferably 15 to 30 mass % from the viewpoint of being able to achieve a good balance between heat resistance and tensile strength at a higher level.

The content rate of the mineral oil in 100 mass % of the base rubber [C] is not particularly limited, and is appropriately determined. For example, the content rate is preferably 0 to 25 mass %, and more preferably 0 to 20 mass %.

### <Silane Coupling Agent>

The silane crosslinkable silicone rubber compositions [A] to [C] contain a silane coupling agent graft-bonded to a base rubber, particularly a millable silicone rubber. The base rubber to which the silane coupling agent is graft-bonded is preferably prepared by a grafting reaction between the silane coupling agent and the base rubber in step (a) as described later.

The silane coupling agent used in the present invention (before the grafting reaction) has a grafting reaction site (a functional group such as an atom or an ethylenically unsaturated group) capable of being graft-reacted with a grafting reactive site of the base rubber, in the presence of radical generated by decomposition of organic peroxide. Further, the silanol condensable reaction site preferably has a hydrolysable silyl group and can react with a site to which an inorganic filler can be chemically bonded. The silane coupling agent that can be used in the present invention is not particularly limited, and examples thereof include silane coupling agents which have been used in the conventional silane crosslinking method.

Preferable examples of the silane coupling agent include silane coupling agents having an ethylenically unsaturated group and a hydrolysable silyl group. Specific examples thereof include vinylalkoxysilane such as vinyltrimethoxysilane, vinyltriethoxysilane, vinyltributoxysilane, vinyldimethoxyethoxysilane, vinyldimethoxybutoxysilane, vinyldiethoxybutoxysilane, allyltrimethoxysilane, allyltriethoxysilane, and vinyltriacetoxysilane, and (meth)acryloxysilane such as methacryloxypropyltrimethoxysilane, methacryloxypropyltriethoxysilane, methacryloxypropylmethyldimethoxysilane, and the like. Among these silane coupling agents, vinyltrimethoxysilane or vinyltriethoxysilane is particularly preferable.

### <Inorganic Filler>

In the present invention, each of the silane crosslinkable silicone rubber compositions [A] to [C] contains an inorganic filler. Preferably, the inorganic filler is separately mixed with (added to) the base rubber (a compound or mixture).

The inorganic filler is not particularly limited. However, preferred are those having, on their surfaces, a site that can be chemically bonded by a hydrogen bond or a covalent bond and the like, or an intermolecular bond with a silanol condensable reaction site of the silane coupling agent. The site that can be chemically bonded with the reaction site of the silane coupling agent is not particularly limited, and examples thereof include an OH group (OH group of hydroxy group, of water molecule in hydrous substance or crystallized water, or of carboxyl group), amino group, a SH group, and the like.

As the inorganic filler, use can be made of metal hydrate, such as a compound having a hydroxy group or crystallized water, for example, aluminum hydroxide, magnesium hydroxide, boehmite, calcium carbonate, magnesium carbonate, calcium silicate, magnesium silicate, calcium oxide, magnesium oxide, aluminum oxide, aluminum nitride, aluminum borate whisker, hydrated aluminum silicate, hydrated magnesium silicate, basic magnesium carbonate, hydrotalcite, and talc. Further, use can be made of boron nitride, silica (crystalline silica, amorphous silica, and the like), carbon black, clay (calcined clay), zinc oxide, tin oxide, titanium oxide, molybdenum oxide, a silicone compound, quartz, zinc borate, white carbon, zinc borate, zinc hydroxystannate, or zinc stannate. The inorganic filler preferably contains at least one kind of metal hydrate, talc, clay, silica, calcium carbonate, and carbon black. Silica is more preferable from the viewpoint of heat resistance and tensile strength.

As the inorganic filler, a surface-treated inorganic filler, surface-treated with a silane coupling agent or the like can be used. The amount of surface treatment is not particularly limited, and is preferably, for example, 3 mass % or less.

### <Silanol Condensation Catalyst>

The silanol condensation catalyst is capable of causing a condensation reaction (acceleration), in the presence of water, of a silanol condensable reaction site of the silane coupling agent graft-bonded to the base rubber. Due to the function of this silanol condensation catalyst, base rubbers are crosslinked through the silane coupling agent.

The forgoing silanol condensation catalyst is not particularly limited. Examples thereof include organic tin compounds, metal soaps, and platinum compounds. As the organic tin compounds, examples thereof include organic tin compounds, such as dibutyltin dilaurate, dioctyltin dilaurate, dibutyltin dioctylate, and dibutyltin diacetate.

### <Hindered Phenol-Based Antioxidant>

In another preferred embodiment of the present invention, a hindered phenol-based antioxidant is contained.

The hindered phenol-based antioxidant is not particularly limited as long as it is an antioxidant having a hindered phenol structure in the molecule. For example, those usually used in the field of wiring materials and the like can be used without particular limitation. Examples thereof include octadecyl-3-(3,5-di-tert-butyl-4-hydroxyphenyl)propionate (for example, as a commercially available product, IRGANOX 1076 (trade name) manufactured by BASF), pentaerythritol tetrakis[3-(3,5-di-tert-butyl-4 hydroxyphenyl)propionate (for example, as a commercially available product, IRGANOX 1010 (trade name) manufactured by BASF), and N,N′-bis-3-(3′5′-di-t-butyl-4′-hydroxyphenyl)propionylhexamethylenediamine (for example, as a commercially available product, IRGANOX 1098 (trade name) manufactured by BASF). Among the antioxidants, pentaerythritol tetrakis[3-(3,5-di-tert-butyl-4-hydroxyphenyl)propionate]] is preferable.

### <Hydrazine-Based Metal Inactivator>

In another preferred embodiment of the present invention, a hydrazine-based heavy metal inactivator is contained.

The hydrazine-based heavy metal inactivator is not particularly limited as long as it is a metal inactivator having a hydrazine structure in the molecule. For example, those ordinarily used in the field of wiring materials and the like can be used without particular limitation. Examples thereof include 1,2-bis[3-(3,5-di-tert-butyl-4-hydroxyphenyl)propionyl]hydrazine (e.g. ADK STAB CDA-10 (trade name) manufactured by ADEKA CORPORATION is commercially available) and 1,2-bis[3-(4-hydroxy-3,5-di-tert-butylphenyl)propionyl]hydrazine (e.g. as a commercially available product, IRGANOX MD1024 (trade name) manufactured by BASF).

### <Benzimidazole-Based Antioxidant>

In another preferred embodiment of the present invention, a benzimidazole-based antioxidant is contained.

The benzimidazole-based antioxidant is not particularly limited as long as it has a benzimidazole structure in the molecule. For example, those ordinarily used in the field of wiring materials and the like can be used without particular limitation. Examples thereof include zinc salt of 2-mercaptobenzimidazole (e.g. as a commercially available product, NOCRAC MBZ (trade name)), and 1,3-dihydro-2H-benzimidazole-2-thione 0.5 zinc salt (e.g. commercially available products manufactured by OUCHI SHINKO CHEMICAL INDUSTRIAL CO., LTD.).

In another preferred embodiment of the present invention, when the silane crosslinkable silicone rubber composition [C] contains three kinds of antioxidants, the high heat resistance and strength can be improved to a high level, and the silane crosslinked silicone rubber formed body [C] capable of sustaining such remarkable heat resistance over a long period of time can be obtained.

As the three kinds of antioxidants contained in the silane crosslinkable silicone rubber composition [C] and the like, appropriate antioxidants can be selected from among the respective antioxidants, and allowed to coexist. Examples of a preferred combination of the three antioxidants include a combination including pentaerythritol tetrakis[3-(3,5-di-tert-butyl-4-hydroxyphenyl)propionate as the hindered phenol-based antioxidant and zinc salt of 2-mercaptobenzimidazole as the benzimidazole-based antioxidant.

### <Additive [A]>

In the present invention, various additives [A] ordinarily used in the silicone rubber composition can also be used. Examples of such an additive include an antioxidant, a lubricant, a metal inactivator, a plasticizer, a flame retardant, a flame retardant aid, a plasticization reversion inhibitor, and (co)polymers other than those described for the base rubber.

Examples of the antioxidant include a hindered phenol-based antioxidant, a benzimidazole-based antioxidant, and a hydrazine-based heavy metal inactivator. Examples of the flame retardant (aid) include a bromine-based flame retardant, a chlorine-based flame retardant, and antimony trioxide.

The present invention encompasses both an aspect in which the silane crosslinkable silicone rubber composition [A] and the silane crosslinked silicone rubber formed body [A] contain any one or a combination of three kinds of the above-described antioxidants, particularly the benzimidazole-based antioxidant, and an aspect in which the silane crosslinkable silicone rubber composition [A] and the silane-crosslinkable silicone rubber formed body [A] do not contain any one or a combination of three kinds of the above-described antioxidants, particularly the benzimidazole-based antioxidant. Note that, in the aspect of containing the antioxidants, the total content of the antioxidants is preferably less than 30 parts by mass, more preferably 0.2 to 19 parts by mass, and still more preferably 0.5 to 13 parts by mass, with respect to 100 parts by mass of the base rubber. The phrase “do not contain the antioxidants” is not limited to an aspect in which the content of each of the antioxidants in the silane crosslinkable silicone rubber composition [A] or the like is 0 mass %, and includes an aspect in which the antioxidants are contained within a range not imparting the effect of the present invention. As the range not imparting the effect of the present invention, for example, the amount of the hindered phenol-based antioxidant and the hydrazine-based metal inactivator can be less than 0.2 parts by mass, and the amount of the benzimidazole-based antioxidant can be less than 1.5 parts by mass.

In the present invention, the crosslinkable silicone rubber composition [A] and the silane crosslinked silicone rubber formed body [A] include both an aspect in which a plasticization reversion inhibitor, for example, a silicone rubber not containing a vinyl group is contained, and an aspect in which a silicone rubber not containing a vinyl group is not contained. When the plasticization reversion inhibitor is contained, the content thereof can be 0.5 to 10 mass % in the base rubber. On the other hand, the phrase “do not contain the plasticization reversion inhibitor” is not limited to an aspect in which the content of the plasticization reversion inhibitor in the silane crosslinkable silicone rubber composition [A] or the like is 0 mass %, and includes an aspect in which the plasticization reversion inhibitor is contained, for example, in an amount of less than 0.5 parts by mass, preferably 0.2 parts by mass or less, with respect to 100 parts by mass of the base rubber within a range not imparting the effect of the present invention.

### <Additive [B]>

In a preferred embodiment of the present invention, various additives [B] ordinarily used in the silicone rubber composition can also be used. Examples of such an additive include an antioxidant, a lubricant, a metal inactivator, a plasticizer, a flame retardant, a flame retardant aid, a plasticization reversion inhibitor, and (co)polymers other than those described for the base rubber.

Examples of the antioxidant include a hindered phenol-based antioxidant, a benzimidazole-based antioxidant, and a hydrazine-based heavy metal inactivator. Examples of the flame retardant (aid) include a bromine-based flame retardant, a chlorine-based flame retardant, and antimony trioxide.

A preferred embodiment of the present invention encompasses both an aspect in which the silane crosslinkable silicone rubber composition [B] and the silane crosslinked silicone rubber formed body [B] contain any one or a combination of three kinds of the above-described antioxidants, particularly the benzimidazole-based antioxidant, and an aspect in which the silane crosslinkable silicone rubber composition [B] and the silane-crosslinkable silicone rubber formed body [B] do not contain any one or a combination of three kinds of the above-described antioxidants, particularly the benzimidazole-based antioxidant. Note that, in the aspect of containing the antioxidants, the total content of the antioxidants is preferably less than 30 parts by mass, more preferably 0.2 to 19 parts by mass, and still more preferably 0.5 to 13 parts by mass, with respect to 100 parts by mass of the base rubber. The phrase “do not contain the antioxidants” is not limited to an aspect in which the content of each of the antioxidants in the silane crosslinkable silicone rubber composition [B] or the like is 0 mass %, and includes an aspect in which the antioxidants are contained within a range not imparting the effect of a preferred embodiment of the present invention. As the range not imparting the effect of a preferred embodiment of the present invention, for example, the amount of the hindered phenol-based antioxidant and the hydrazine-based metal inactivator can be less than 0.2 parts by mass, and the amount of the benzimidazole-based antioxidant can be less than 1.5 parts by mass.

In a preferred embodiment of the present invention, the crosslinkable silicone rubber composition [B] and the silane crosslinked silicone rubber formed body [B] include both an aspect in which a plasticization reversion inhibitor, for example, a silicone rubber not containing a vinyl group is contained, and an aspect in which a silicone rubber not containing a vinyl group is not contained. When the plasticization reversion inhibitor is contained, the content thereof can be 0.5 to 10 mass % in the base rubber. On the other hand, the phrase “do not contain the plasticization reversion inhibitor” is not limited to an aspect in which the content of the plasticization reversion inhibitor in the silane crosslinkable silicone rubber composition or the like is 0 mass %, and includes an aspect in which the plasticization reversion inhibitor is contained, for example, in an amount of less than 0.5 parts by mass, preferably 0.2 parts by mass or less, with respect to 100 parts by mass of the base rubber within a range not imparting the effect of a preferred embodiment of the present invention.

### <Additive [C]>

In another preferred embodiment of the present invention, various additives ordinarily used in the silicone rubber composition can also be used. Examples of such an additive include an antioxidant other than the above-described antioxidants, a lubricant, a metal inactivator, a plasticizer, a flame retardant, a flame retardant aid, a plasticization reversion inhibitor, and (co)polymers other than those described for the base rubber. Examples of the flame retardant (aid) include a bromine-based flame retardant, a chlorine-based flame retardant, and antimony trioxide.

In another preferred embodiment of the present invention, the crosslinkable silicone rubber composition [C] and the silane crosslinked silicone rubber formed body [C] include both an aspect in which a plasticization reversion inhibitor, for example, a silicone rubber not containing a vinyl group is contained, and an aspect in which a silicone rubber not containing a vinyl group is not contained. When the plasticization reversion inhibitor is contained, the content thereof can be 0.5 to 10 mass % in the base rubber. On the other hand, the phrase “do not contain the plasticization reversion inhibitor” is not limited to an aspect in which the content of the plasticization reversion inhibitor in the silane crosslinkable silicone rubber composition [C] or the like is 0 mass %, and includes an aspect in which the plasticization reversion inhibitor is contained, for example, in an amount of less than 0.5 parts by mass, preferably 0.2 parts by mass or less, with respect to 100 parts by mass of the base rubber within a range not imparting the effect of another preferred embodiment of the present invention.

### <Organic Peroxide>

In the preparation of the silane crosslinkable silicone rubber compositions [A] to [C], an organic peroxide is used.

The organic peroxide generates radicals by thermal decomposition, and has a function of accelerating a grafting reaction of the base rubber with a silane coupling agent (a covalent bond-forming reaction between a grafting reaction site of the silane coupling agent and a site capable of the grafting reaction of the base rubber, and this is also referred to as a (radical) addition reaction). The organic peroxide is not particularly limited, and for example, compounds represented by formulas: R¹—OO—R², R³—OO—C(═O)R⁴, and R⁵C(═O)—OO(C═O)R⁶ are preferably used. Here, R¹ to R⁶ each independently represent an alkyl group, an aryl group, or an acyl group.

Among R¹ to R⁶ of each of the compounds, a compound in which all of R¹ to R⁶ are alkyl groups or a compound in which any one of R¹ to R⁶ is an alkyl group and the rest is an acyl group is preferable.

As the decomposition temperature measured by the method described in JP-A-2016-121203, the decomposition temperature of the organic peroxide is preferably 80 to 195° C. and particularly preferably 125 to 180° C.

Examples of such an organic peroxide include an organic peroxide described in paragraph [0036] of JP-A-2016-121203, the contents of which are incorporated herein by reference. Among the organic peroxides, dicumyl peroxide, 2,5-dimethyl-2,5-di-(tert-butylperoxy)hexane (PERHEXA 25B), and 2,5-dimethyl-2,5-di-(tert-butylperoxy)hexyne-3 are preferable.

### (Composition of Silane Crosslinkable Silicone Rubber Composition [A])

The content of the silane coupling agent graft-bonded to the base rubber [A] in the silane crosslinkable silicone rubber composition [A] (content in terms of mass before being graft-reacted with the base rubber [A]) is 1 to 15 parts by mass with respect to 100 parts by mass of the base rubber, from the viewpoint of being able to produce the silane crosslinked silicone rubber formed body [A] which exhibits excellent outer appearance, forms a sufficient crosslinked structure, and exhibits excellent heat resistance and mechanical characteristics (tensile strength, breaking elongation), and which suppresses generation of protruding aggregates (gel aggregates) caused by a crosslinked gel or the like, volatilization of the silane coupling agent, and the like. The content of the silane coupling agent is preferably 2 to 15 parts by mass and preferably 3 to 15 parts by mass from the viewpoint of being able to produce the silane crosslinked silicone rubber formed body [A] in which a good balance among outer appearance, tensile strength and heat resistance is achieved at a higher level. The upper limit is preferably 8 parts by mass from the viewpoint of suppressing the volatilization or self-condensation of the silane coupling agent and being able to achieve excellent outer appearance.

The content of the inorganic filler in the silane crosslinkable silicone rubber composition [A] is 0.5 to 300 parts by mass with respect to 100 parts by mass of the base rubber [A] from the viewpoint of being able to construct a crosslinked structure in which an inorganic filler is spirally wound around the silane crosslinked silicone rubber formed body [A], and to achieve both heat resistance and tensile strength. The content of the inorganic filler is preferably set to be small from the viewpoint of being able to achieve both heat resistance and tensile strength at a higher level. Specifically, the content is preferably 1 to 200 parts by mass, more preferably 1 to 100 parts by mass, still more preferably 3 to 50 parts by mass, particularly preferably 3 to 40 parts by mass, and most preferably 3 to 25 parts by mass. In an aspect in which the base rubber [A] contains a fluororubber, the content of the inorganic filler in the silane crosslinkable silicone rubber composition [A] is preferably 1 to 100 parts by mass, more preferably 3 to 50 parts by mass, more preferably 3 to 40 parts by mass, and particularly preferably 3 to 25 parts by mass, among the above contents.

The content of the silanol condensation catalyst in the silane crosslinkable silicone rubber composition [A] is 0.01 to 0.5 parts by mass, preferably 0.03 to 0.3 parts by mass, and more preferably 0.05 to 0.15 parts by mass, with respect to 100 parts by mass of the base rubber, from the viewpoint of being able to achieve a good balance among outer appearance, heat resistance, and tensile strength.

The total content of the additive (antioxidants and plasticization reversion inhibitors are excluded) in the silane crosslinkable silicone rubber composition [A] is not particularly limited, and can be appropriately set within a range that does not impair the action and effect of the present invention.

### [Composition of Silane Crosslinkable Silicone Rubber Composition [B]]

The content of the silane coupling agent graft-bonded to the base rubber in the silane crosslinkable silicone rubber composition [B] (content in terms of mass before being graft-bonded to the base rubber) is the same as the content of the silane coupling agent in the silane crosslinkable silicone rubber composition [A], and the reason is the same.

The content of the inorganic filler in the silane crosslinkable silicone rubber composition [B] is 0.5 to 100 parts by mass with respect to 100 parts by mass of the base rubber [B] from the viewpoint of being able to construct a crosslinked structure in which an inorganic filler is spirally wound around the silane crosslinked silicone rubber formed body [B], and to achieve both heat resistance and tensile strength, particularly high heat resistance and strength. The content of the inorganic filler is preferably set to be small from the viewpoint of being able to achieve a good balance between heat resistance and tensile strength at a higher level. Specifically, the content is preferably 3 to 50 parts by mass, more preferably 3 to 40 parts by mass, and particularly preferably 3 to 25 parts by mass.

The content of the silanol condensation catalyst in the silane crosslinkable silicone rubber composition [B] is the same as the content of the silanol condensation catalyst in the silane crosslinkable silicone rubber composition [A], and the reason is the same.

The total content of the additive (antioxidants and plasticization reversion inhibitors are excluded) in the silane crosslinkable silicone rubber composition [B] is not particularly limited, and can be appropriately set within a range that does not impair the action and effect of the present invention.

### [Composition of Silane Crosslinkable Silicone Rubber Composition [C]]

The content of the silane coupling agent graft-bonded to the base rubber in the silane crosslinkable silicone rubber composition [C] (content in terms of mass before being graft-bonded to the base rubber) is the same as the content of the silane coupling agent in the silane crosslinkable silicone rubber composition [A], and the reason is the same.

The content of the inorganic filler in the silane crosslinkable silicone rubber composition [C] is 0.5 to 100 parts by mass with respect to 100 parts by mass of the base rubber [C] from the viewpoint of being able to construct a crosslinked structure in which an inorganic filler is spirally wound around the silane crosslinked silicone rubber formed body [C], and to achieve both heat resistance and tensile strength, particularly high heat resistance and strength. The content of the inorganic filler is preferably set to be small from the viewpoint of remarkably increasing heat resistance, together with three kinds of antioxidants, and being able to achieve a good balance between heat resistance and tensile strength at a higher level. Specifically, the content is more preferably 3 to 50 parts by mass, particularly preferably 3 to 40 parts by mass, and most preferably 3 to 25 parts by mass.

The total content of the three kinds of antioxidants in the silane crosslinkable silicone rubber composition [C] is not particularly limited, and can be appropriately set in consideration of the use and characteristics and according to the content of each of the antioxidants and the like. For example, the total content of the three kinds of antioxidants is preferably 2 to 30 parts by mass, and more preferably 8 to 20 parts by mass, with respect to 100 parts by mass of the base rubber.

The content of the hindered phenol-based antioxidant in the silane crosslinkable silicone rubber composition [C] is 0.2 to 8 parts by mass with respect to 100 parts by mass of the base rubber [C]. When this content is used, thereby achieving the outer appearance, mechanical characteristics and heat resistance of the formed body. The content of the hindered phenol-based antioxidant is preferably 0.5 to 5 parts by mass, more preferably 0.8 to 4.0 parts by mass, and still more preferably 1 to 3.5 parts by mass with respect to 100 parts by mass of the base rubber [C] from the viewpoint of remarkably increasing heat resistance, together with the inorganic filler and other antioxidants, and being able to achieve a good balance between heat resistance and tensile strength at a higher level.

The content of the hydrazine-based metal inactivator in the silane crosslinkable silicone rubber composition [C] is 0.2 to 5.0 parts by mass with respect to 100 parts by mass of the base rubber [C]. When this content is used, thereby achieving the outer appearance, mechanical characteristics and heat resistance of the formed body [C]. The content of the hydrazine-based metal inactivator is preferably 0.5 to 4.0 parts by mass, more preferably 0.8 to 3.5 parts by mass, and still more preferably 1 to 3.0 parts by mass with respect to 100 parts by mass of the base rubber [C], from the viewpoint remarkably increasing heat resistance, together with the inorganic filler and other antioxidants, and being able to achieve a good balance between heat resistance and tensile strength at a higher level.

The content of the benzimidazole-based antioxidant in the silane crosslinkable silicone rubber composition [C] is 1.5 to 15 parts by mass with respect to 100 parts by mass of the base rubber. When this content is used, thereby achieving the outer appearance, mechanical characteristics and heat resistance of the formed body [C]. The content of the benzimidazole-based antioxidant is preferably 3 to 12 parts by mass, more preferably 5 to 11 parts by mass, and still more preferably 6 to 10 parts by mass with respect to 100 parts by mass of the base rubber [C], from the viewpoint of remarkably increasing heat resistance, together with the inorganic filler and other antioxidants, and being able to achieve a good balance between heat resistance and tensile strength at a higher level, and further being able to sustain high heat resistance over a long period of time.

In the silane crosslinkable silicone rubber composition [C], a ratio of the content of the benzimidazole-based antioxidant to the content of the hindered phenol-based antioxidant [(content of benzimidazole-based antioxidant)/(content of hindered phenol-based antioxidant)] is appropriately set in consideration of the use and characteristics. For example, the ratio of the content can be set to 1.0 to 7.0, preferably 1.5 to 6.0, and more preferably 2.0 to 5.0, from the viewpoint of sustaining high heat resistance over a long period of time.

In the silane crosslinkable silicone rubber composition [C], a combination of the contents of the three kinds of antioxidants is not particularly limited, and contents appropriately selected from the contents of the respective antioxidants described above can be combined. Particularly, a combination is preferable in which the content of the hindered phenol-based antioxidant, the content of the hydrazine-based metal inactivator, and the content of the benzimidazole-based antioxidant are 0.5 to 5 parts by mass, 0.5 to 4 parts by mass, and 3 to 12 parts by mass, respectively, in this order.

The content of the silanol condensation catalyst in the silane crosslinkable silicone rubber composition [C] is 0.01 to 0.5 parts by mass, preferably 0.03 to 0.3 parts by mass, and more preferably 0.05 to 0.15 parts by mass, with respect to 100 parts by mass of the base rubber [C], from the viewpoint of being able to achieve a good balance among outer appearance, heat resistance, and tensile strength.

The total content of the additive (antioxidants and plasticization reversion inhibitors are excluded) in the silane crosslinkable silicone rubber composition [C] is not particularly limited, and can be appropriately set within a range that does not impair the action and effect of the present invention.

### [Composition of Silane Crosslinked Silicone Rubber Formed Body]

Since the silane crosslinked silicone rubber formed bodies [A] to [C] are each formed by forming the silane crosslinkable silicone rubber compositions [A] to [C] and then bringing the compositions into contact with water to cause a silanol condensation reaction, the contents of the components in these formed bodies [A] to [C] are ordinarily the same as the contents in the silane crosslinkable silicone rubber compositions [A] to [C]. However, in the silane crosslinked silicone rubber formed bodies [A] to [C], the content of the silane coupling agent before the silanol condensation reaction, and the content of the base rubber before the crosslinking are set.

### [Method of Producing Silane Crosslinkable Silicone Rubber Composition and Silane Crosslinked Silicone Rubber Formed Body]

Hereinafter, the method of producing a silane crosslinkable silicone rubber composition according to the present invention and each preferred embodiment thereof and the method of producing a silane crosslinked silicone rubber formed body according to the present invention will be described.

The silane crosslinkable silicone rubber composition [A] of the present invention is produced by performing the following step (1A), and the silane crosslinked silicone rubber formed body [A] of the present invention is produced by performing the following steps (1A) to (3A).

The method [A] of producing a silane crosslinked silicone rubber formed body and the method [A] of producing a silane crosslinkable silicone rubber composition of the present invention may be collectively referred to as the production method [A] of the present invention.
Step (1A): A step of obtaining a silane crosslinkable silicone rubber composition by mixing a base rubber containing a millable silicone rubber, and with respect to 100 parts by mass of the base rubber containing a millable silicone rubber, 1 to 15 parts by mass of a silane coupling agent, 0.5 to 300 parts by mass of an inorganic filler, 0.01 to 0.6 parts by mass of an organic peroxide, and 0.01 to 0.5 parts by mass of a silanol condensation catalyst.
Step (2A): A step of obtaining a formed body by forming the silane crosslinkable silicone rubber composition.
Step (3A): A step of obtaining a silane crosslinked silicone rubber formed body by bringing the formed body into contact with water.

In a case of melt-mixing all of the base rubber in the following step (a), the step (1A) includes the following step (a) and step (c), or in a case of melt-mixing a part of the base rubber in the following step (a), the step (1A) includes the following step (a), step (b), and step (c).
Step (a): A step of preparing a silane masterbatch by melt-mixing all or a part of the base rubber, the silane coupling agent, the inorganic filler, and the organic peroxide at a temperature equal to or higher than a decomposition temperature of the organic peroxide.
Step (b): A step of preparing a catalyst masterbatch, by melt-mixing a remainder of the base rubber, and the silanol condensation catalyst.
Step (c): A step of mixing the silane masterbatch with the silanol condensation catalyst or the catalyst masterbatch.

The silane crosslinkable silicone rubber composition [B] according to a preferred embodiment of the present invention is produced by performing the following step (1B), and the silane crosslinked silicone rubber formed body [B] according to a preferred embodiment of the present invention is produced by performing the following steps (1B) to (3B).

The method [B] of producing a silane crosslinked silicone rubber formed body and the method [B] of producing a silane crosslinkable silicone rubber composition according to a preferred embodiment of the present invention may be collectively referred to as the production method [B] of the present invention.
Step (11B): A step of obtaining a silane crosslinkable silicone rubber composition by mixing a base rubber containing a millable silicone rubber and a fluororubber, and with respect to 100 parts by mass of the base rubber containing a millable silicone rubber and a fluororubber, 1 to 15 parts by mass of a silane coupling agent, 0.5 to 100 parts by mass of an inorganic filler, 0.01 to 0.6 parts by mass of an organic peroxide, and 0.01 to 0.5 parts by mass of a silanol condensation catalyst.
Step (2B): A step of obtaining a formed body by forming the silane crosslinkable silicone rubber composition.
Step (3B): A step of obtaining a silane crosslinked silicone rubber formed body by bringing the formed body into contact with water.

In a case of melt-mixing all of the base rubber in the following step (a), the step (1B) includes the following step (a) and step (c), or in a case of melt-mixing a part of the base rubber in the following step (a), the step (1B) includes the following step (a), step (b), and step (c).
Step (a): A step of preparing a silane masterbatch by melt-mixing all or a part of the base rubber, the silane coupling agent, the inorganic filler, and the organic peroxide at a temperature equal to or higher than a decomposition temperature of the organic peroxide.
Step (b): A step of preparing a catalyst masterbatch, by melt-mixing a remainder of the base rubber, and the silanol condensation catalyst.
Step (c): A step of mixing the silane masterbatch with the silanol condensation catalyst or the catalyst masterbatch.

The silane crosslinkable silicone rubber composition [C] according to another preferred embodiment of the present invention is produced by performing the following step (1C), and the silane crosslinked silicone rubber formed body [C] according to another preferred embodiment of the present invention is produced by performing the following steps (1C) to (3C).

The method [C] of producing a silane crosslinked silicone rubber formed body and the method [C] of producing a silane crosslinkable silicone rubber composition according to another preferred embodiment of the present invention may be collectively referred to as the production method [C] of the present invention.
Step (1C): A step of obtaining a silane crosslinkable silicone rubber composition by melt-mixing a base rubber containing a millable silicone rubber and an ethylene copolymer resin, and with respect to 100 parts by mass of the base rubber containing a millable silicone rubber and an ethylene copolymer resin, 1 to 15 parts by mass of a silane coupling agent having a grafting reaction site capable of being graft-reacted with the base rubber, 0.2 to 8 parts by mass of a hindered phenol-based antioxidant, 0.2 to 5 parts by mass of a hydrazine-based metal inactivator, 1.5 to 15 parts by mass of a benzimidazole-based antioxidant, 0.5 to 100 parts by mass of an inorganic filler, 0.01 to 0.6 parts by mass of an organic peroxide, and 0.01 to 0.5 parts by mass of a silanol condensation catalyst.
Step (2C): A step of obtaining a formed body by forming the silane crosslinkable silicone rubber composition.
Step (3C): A step of obtaining a silane crosslinked silicone rubber formed body by bringing the formed body into contact with water.

In a case of melt-mixing all of the base rubber in the following step (a), the step (1C) includes the following step (a) and step (c), or in a case of melt-mixing a part of the base rubber in the following step (a), the step (1C) includes the following step (a), step (b), and step (c).
Step (a): A step of preparing a silane masterbatch by melt-mixing all or a part of the base rubber, the silane coupling agent, the inorganic filler, and the organic peroxide at a temperature equal to or higher than a decomposition temperature of the organic peroxide.
Step (b): A step of preparing a catalyst masterbatch, by melt-mixing a remainder of the base rubber, and the silanol condensation catalyst.
Step (c): A step of melt-mixing the silane masterbatch with the silanol condensation catalyst or the catalyst masterbatch.

Further, in the step (1C), each of the hindered phenol-based antioxidant, the hydrazine-based metal inactivator, and the benzimidazole-based antioxidant is mixed in at least one of the steps (a) and (b).

In the production methods [A] to [C] of the present invention, the steps (1A) to (1C) may be collectively referred to as “step (1)”, the steps (2A) to (2C) may be collectively referred to as “step (2)”, and the steps (3A) to (3C) may be collectively referred to as “step (3)”.

### <Step (1)>

In the production methods [A] to [C] of the present invention, first, steps (1A) to (1C) of preparing silane crosslinkable silicone rubber compositions [A] to [C] by mixing the above components as forming materials are performed.

In the step (1), it is preferable to prepare a silane masterbatch (silane MB) and a catalyst masterbatch (catalyst MB), and to mix both the masterbatches.

Specifically, the step (1) includes steps (a) to (c) as described later.

In the production methods [A] to [C] of the present invention, the mixing amount of each component used as the base rubbers [A] to [C] is the same as the content rate described above as the composition of the base rubbers [A] to [C]. Further, in the production methods [A] and [B] of the present invention, the mixing amounts of the silane coupling agent, the inorganic filler, the silanol condensation catalyst, and the additive are the same as the contents in the silane crosslinkable silicone rubber composition [A] or [B] described above. In the production method [C] of the present invention, the mixing amounts of the silane coupling agent, the inorganic filler, the three kinds of antioxidants, the silanol condensation catalyst, and the additive are the same as the contents in the silane crosslinkable silicone rubber composition [C] described above.

In the production methods [A] to [C] of the present invention, when a part of the base rubber is mixed in the step (a), the polymer component to be mixed may be a specific component or two or more components. The ratio of the base rubber to be mixed in the step (a) is preferably 60 to 95 mass % with respect to 100 mass % of the base rubber to be mixed in the step (a) and the step (b), and is more preferably 70 to 95 mass % from the viewpoint of being able to construct a sufficient crosslinked structure, and to achieve both heat resistance and mechanical characteristics at a higher level. The remainder (carrier resin) of the base rubber to be mixed in the step (b) is appropriately determined according to a part of the base rubber to be mixed in the step (a).

However, in the production method [A] of the present invention, the base rubber [A] used in the step (a) contains at least a millable silicone rubber among the above components. Thus, a sufficient silane crosslinked structure can be constructed in the silane crosslinked silicone rubber formed body.

In the production method [B] of the present invention, the base rubber [B] used in the step (a) contains at least a millable silicone rubber and a fluororubber among the above components. Accordingly, it possible to solve the above-described problem of manufacturability to construct a sufficient silane crosslinked structure in the silane crosslinked silicone rubber formed body [B], and to achieve a good balance between heat resistance and strength at a higher level. Some of the millable silicone rubber and the fluororubber can also be used in the step (b). The base rubber [B] used in the step (a) preferably contains a millable silicone rubber, a fluororubber, and an ethylene copolymer resin from the viewpoint of solving the above-described problem of manufacturability and being able to achieve both heat resistance and mechanical characteristics at a high level. On the other hand, the base rubber [B] (the remainder) used in the step (b) preferably contains an ethylene copolymer resin. Accordingly, the compatibility between the silane masterbatch and the catalyst masterbatch is enhanced, and the heat resistance and the mechanical characteristics can be improved.

In the production method [C] of the present invention, the base rubber [C] used in the step (a) contains at least a millable silicone rubber among the above components, and an ethylene copolymer resin is used in at least one of the steps (a) and (b). Accordingly, it possible to solve the above-described problem of manufacturability to construct a sufficient silane crosslinked structure in the silane crosslinked silicone rubber formed body [C], and to achieve a good balance between heat resistance and mechanical characteristics while also solving the above-described problem of formability. The base rubber [C] used in the step (a) preferably contains a millable silicone rubber and an ethylene copolymer resin from the viewpoint of solving the above-described problem of manufacturability and being able to achieve both heat resistance and mechanical characteristics at a high level. On the other hand, the base rubber [C] (the remainder) used in the step (b) preferably contains an ethylene copolymer resin. Accordingly, the compatibility between the silane masterbatch and the catalyst masterbatch is enhanced, and the heat resistance and the mechanical characteristics can be improved.

In the production methods [A] to [C] of the present invention, a part of the inorganic filler can be used in the step (b), but the inorganic filler is preferably used in the step (a) from the viewpoint of being able to construct a crosslinked structure in which an inorganic filler is spirally wound and to achieve both heat resistance and mechanical characteristics at a higher level. When the inorganic filler is used in the step (b), the amount of the inorganic filler used is not particularly limited, and is appropriately determined.

In the production methods [A] to [C] of the present invention, various additives may be mixed in either the step (a) or the step (b).

In the production methods [A] and [B] of the present invention, the antioxidant may be mixed in either the step (a) or the step (b), but mixing in the step (b) is preferable from the viewpoint of being able to efficiently progress the grafting reaction in the step (a).

In the production method [C] of the present invention, the three kinds of antioxidants may be contained when carrying out the step (c), and can be used in any of the steps. From the viewpoint of being able to efficiently generate and progress the grafting reaction between the silane coupling agent and the base rubber without inhibiting the grafting reaction, all of the three kinds of antioxidants are preferably used (mixed) in the step (b). Note that the antioxidant, particularly the hindered phenol-based antioxidant can also be used in the step (a) within a range not significantly inhibiting the grafting reaction. For example, each of the antioxidants can be used in the step (a) as long as the content is 0.5 parts by mass or less with respect to 100 parts by mass of the base rubber.

In the production methods [A] to [C] of the present invention, the mixing amount of the organic peroxide mixed in the step (a) is 0.01 to 0.6 parts by mass with respect to 100 parts by mass of the base rubber. In the production method [A] of the present invention, when the organic peroxide is mixed in the above content with respect to the millable silicone rubber contained in the above content rate, a crosslinking reaction between the millable silicone rubbers can be suppressed at the time of melt-mixing, and the grafting reaction of the silane coupling agent to the millable silicone rubber can be preferentially and selectively caused to occur (accelerate), and the generation of gel aggregates can also be suppressed. As a result, a good balance among the outer appearance, heat resistance, and mechanical characteristics of the silane crosslinked silicone rubber formed body [A] can be achieved.

In the production methods [B] and [C] of the present invention, when the organic peroxide is mixed in the above content with respect to the millable silicone rubber contained in the above content rate, a competitive reaction (parallel reaction, side reaction) including the crosslinking reaction between the millable silicone rubbers can be suppressed at the time of melt-mixing, and the grafting reaction of the silane coupling agent to the millable silicone rubber can be preferentially and selectively caused to occur (accelerate), and the generation of gel aggregates can also be suppressed. As a result, a good balance among the outer appearance, heat resistance, and mechanical characteristics of the silane crosslinked silicone rubber formed bodies [B] and [C] can be achieved.

In the production methods [A] to [C] of the present invention, the mixing amount of the organic peroxide is preferably 0.05 to 0.2 parts by mass.

### (Step (a))

In the production methods [A] to [C] of the present invention, the step (a) is a step of preparing a silane masterbatch (a silane MB) containing a silane crosslinkable silicone rubber in which a silane coupling agent is graft-bonded to a base rubber, by subjecting the base rubber and the silane coupling agent to a grafting reaction in the coexistence of an inorganic filler.

As the base rubber, the base rubbers [A] to [C] are used according to the production methods [A] to [C] of the present invention. In this step, the base rubber is heated and mixed with the inorganic filler and the silane coupling agent in the presence of the organic peroxide at a temperature equal to or higher than the decomposition temperature of the organic peroxide. As a result, the silane MB is obtained as a melt-mixture.

In the step (a), the mixing temperature at which the above-described components are melt-mixed (also referred to as melt-kneaded) is equal to or higher than the decomposition temperature of the organic peroxide, preferably a temperature of the decomposition temperature of the organic peroxide plus (25 to 110°) C, more preferably 150 to 230° C., and still more preferably 175 to 210° C. Mixing conditions, such as, a mixing time can be appropriately set. For example, the mixing time can be 1 to 25 minutes, and is preferably 3 to 20 minutes. Melt-mixing is performed at a temperature equal to or higher than the decomposition temperature of the organic peroxide, and thus the organic peroxide is thermally decomposed to generate radicals. Consequently, the grafting reaction proceeds.

As a mixing method, a method ordinarily applied for rubber, plastic or the like may be used. As a mixing device, for example, a single screw extruder, a twin screw extruder, a roll, a Banbury mixer, various kneaders, or the like is used, and a sealed mixer such as a Banbury mixer or various kneaders is preferable.

In the present invention, the mixing order is not specified, and the above-described components may be mixed in any order. For example, the components described above can be melt-mixed at a time.

In the production methods [A] to [C] of the present invention, the mixing of the step (a) is preferably performed in the following mixing order through the following steps (a-1) and (a-2).
Step (a-1): A step of mixing the inorganic filler and the silane coupling agent to prepare a mixture.
Step (a-2): A step of melt-mixing the mixture obtained in the step (a-1) and all or part of the base rubber in the presence of an organic peroxide at a temperature equal to or higher than a decomposition temperature of the organic peroxide.

The inorganic filler and the silane coupling agent are premixed in the step (a-1), the silane coupling agent bonded or adsorbed to the inorganic filler by weak bonding and the silane coupling agent bonded or adsorbed to the inorganic filler by strong bonding can be formed in a well-balanced manner. This makes it possible to effectively prevent volatilization of the silane coupling agent and further condensation reaction between unadsorbed silane coupling agents at the time of melt-mixing in the step (a-2). As a result, the silane crosslinked silicone rubber formed bodies [A] to [C] having further improved mechanical characteristics (tensile strength) and heat resistance resulting from the silane crosslinking method can be produced while showing more excellent outer appearance. Here, the weak bonding to the inorganic filler includes mutual action caused by hydrogen bonding, mutual action between ions, partial charges, or dipoles, action caused by adsorption, and the like. Further, the strong bonding to the inorganic filler includes chemical bonding to a site capable of being chemically bonded to the surface of the inorganic filler, and the like.

The mixing method and mixing conditions in the step (a-1) are not particularly limited, and examples thereof include a method and conditions in which mixing is performed by a dry method or a wet method, ordinarily at a temperature lower than the decomposition temperature of the organic peroxide, preferably 10 to 60° C., more preferably near room temperature (20 to 25° C.) for about several minutes to several hours using a known mixer, a kneader, or the like. Particularly, dry mixing (dry blending) is preferably performed at a temperature lower than the decomposition temperature of the organic peroxide. Other conditions for dry mixing are appropriately determined.

In the step (a-1), the base rubber can be mixed as long as the temperature lower than the decomposition temperature is maintained.

The organic peroxide is only required to exist when melt-mixing in the step (a-2) is performed, and may be mixed in the step (a-2), or preferably mixed in the step (a-1).

Then, the mixture obtained in the step (a-1) and all or part of the base rubber are melt-mixed in the presence of the organic peroxide at a temperature equal to or higher than the decomposition temperature of the organic peroxide to prepare a silane MB (step (a-2)). In this way, a silane masterbatch including silane crosslinkable silicone rubber is prepared. In the melt-mixing in this step, it is possible to prevent an excessive crosslinking reaction between the base rubbers (generation of gel aggregates) while suppressing the volatilization and self-condensation of the silane coupling agent described above.

The melt-mixing method and conditions in the step (a-2) are not particularly limited, and the melt-mixing method and conditions in the step (a) can be applied.

In the melt-mixing in the step (a) and the step (a-2), the radicals generated from the organic peroxide preferentially and selectively causes the grafting reaction of the silane coupling agent to the millable silicone rubber as compared with the crosslinking reaction between the millable silicone rubbers (the production method [A] of the present invention) or the competitive reaction including the crosslinking reaction (the production methods [B] and [C] of the present invention). The detailed reason thereof has not been revealed yet, but the following consideration can be given. Since the content of the vinyl group in the millable silicone rubber is ordinarily not high, there are few reaction points, and a crosslinking reaction between the millable silicone rubbers hardly occurs. On the other hand, since the silane coupling agent has a relatively small molecular weight, the number of molecules per part by mass is increased, and since the degree of freedom in the melt-mixture is high and the content is set to the above, the chance of reaction with the millable silicone rubber is increased. Accordingly, it is considered that the grafting reaction of the silane coupling agent preferentially occurs rather than the crosslinking reaction between the millable silicone rubbers.

In the production method [B] of the present invention, it is considered that the addition reactivity of the ethylene copolymer resin and the fluororubber due to radicals is lower than that of the silicone rubber. Thus, it is considered that any competitive reaction, such as a crosslinking reaction between ethylene copolymer resins or between fluororubbers, a crosslinking reaction between different components of an ethylene copolymer resin, a fluororubber, and a millable silicone rubber, and a grafting reaction of a silane coupling agent to an ethylene copolymer resin and a fluororubber, does not occur preferentially. In the production method [C] of the present invention, it is considered that the addition reactivity of the ethylene copolymer resin due to radicals is lower than that of the silicone rubber. Thus, it is considered that any competitive reaction, such as a crosslinking reaction between resins, a crosslinking reaction between a resin and a millable silicone rubber, and a grafting reaction of a silane coupling agent to a resin, does not preferentially occur.

In the step (a) and the step (a-2), at least the following is considered as an aspect in which the silane coupling agent is graft-reacted with the base rubber. That is, there is an aspect in which the silane coupling agent bonded or adsorbed to the inorganic filler by weak bonding is detached from the inorganic filler, and is graft-reacted with the base rubber. From this aspect, the crosslinked structure formed in step (3) as described later does not incorporate the inorganic filler, and ordinarily becomes a crosslinked structure through a silanol condensate between silane coupling agents. Further, there is an aspect in which the silane coupling agent bonded or adsorbed to the inorganic filler by strong bonding is graft-reacted with a resin, in a state of maintaining the bond or adsorption to the inorganic filler.

In the production method [A] of the present invention, from this aspect, the crosslinked structure formed in step (3) as described later incorporates the inorganic filler, and becomes a crosslinked structure through a silane coupling agent bonded to the inorganic filler as a starting point, so that a highly developed crosslinked structure can be constructed, together with the crosslinked structure through a silanol condensate between silane coupling agents.

In the production methods [B] and [C] of the present invention, from the above aspect, the crosslinked structure formed in step (3) as described later incorporates the inorganic filler, and becomes a crosslinked structure through a silane coupling agent bonded to the inorganic filler as a starting point. The crosslinked structures in both the aspects are mixed, so that it is possible to construct a highly developed crosslinked structure including a crosslinked structure in which an inorganic filler is spirally wound around a silane crosslinked silicone rubber formed body.

In the step (a), an antioxidant, an additive, and the like can also be mixed. However, in the step (a), it is preferable that the silanol condensation catalyst is not substantially mixed. This makes it possible to suppress the occurrence of the silanol condensation reaction of the silane coupling agent. In the present invention, the phrase “not substantially mixed” does not meant to exclude the situation in which the silanol condensation catalyst unavoidably exists, and means that the silanol condensation catalyst may exist in a range that can suppress the silanol condensation reaction, for example, in a range of 0.01 parts by mass or less with respect to 100 parts by mass of the base rubber.

The silane MB prepared in the step (a) contains a reaction mixture of the base rubber, the inorganic filler, and the silane coupling agent, and contains a silane crosslinkable silicone rubber (silane graft polymer) in which the silane coupling agent is graft-bonded to the base rubber to such an extent that it can be formed by the step (b) as described later. The silane coupling agent graft-bonded to the base rubber includes a silane coupling agent bonded or adsorbed to the inorganic filler at a silanol condensable reaction site.

The silane MB may be in the form of a clay, a pellet, or a powder.

### (Step (b))

In the production methods [A] to [C] of the present invention, independently of the step (a) or after the step (a), the remainder of the base rubber and the silanol condensation catalyst are melt-mixed to prepare a catalyst masterbatch (catalyst MB).

The melt-mixing method and conditions in the step (b) are not particularly limited, and the melt-mixing method and conditions in the step (a) can be applied. For example, the melt-mixing temperature may be equal to or higher than the melting temperature of the base rubber, and is preferably 120 to 200° C., more preferably 140 to 180° C. For example, the mixing time can be 1 to 25 minutes, and is preferably 3 to 20 minutes.

The catalyst MB may be in the form of a clay, a pellet, or a powder.

### (Step (c))

In the production methods [A] to [C] of the present invention, the silane masterbatch is then mixed with the silanol condensation catalyst or the catalyst masterbatch.

In the production method [A] of the present invention, i.e. in the step (1A), the mixing method and conditions in the step (c) are not particularly limited, and it is preferable to employ a method of mixing (kneading) using a roll or the like under non-high temperature conditions or a method and conditions of dry blending, from the viewpoint of suppressing the occurrence or progress of the silanol condensation reaction. Examples of the mixing method and conditions in kneading or dry blending include the mixing method and conditions in step (a-1).

In the production method [B] of the present invention, i.e. the step (1B), the mixing in the step (c) is not particularly limited, and an appropriate mixing method can be employed in consideration of the characteristics (the form of a clay) of the silane MB and the catalyst MB, and the like. Examples of the mixing method include a mixing method (kneading) in which mixing is performed using a roll or the like under non-high temperature conditions, and a mixing method (melt-mixing) at a temperature at which at least the base rubber melts. In the production method [B] of the present invention, when forming in step (2B) as described later is performed by melt-mixing, the melt mixing in step (c) can be performed simultaneously with the melt-mixing in step (2B) (the melt mixing in step (c) can be omitted).

Examples of the mixing method and conditions in kneading include a method and conditions to which the mixing method and conditions in the step (a-1) are applied using a roll kneader or the like. On the other hand, examples of the mixing method and conditions in melt-mixing include methods and conditions basically similar to those in the melt mixing in the step (a). In this melt-mixing, for example, the mixing temperature is appropriately selected according to the base rubber. For example, the temperature is preferably 80 to 250° C., more preferably 100 to 240° C., and still more preferably 120 to 200° C. In the melt-mixing in the step (c), a melt mixing method and conditions capable of maintaining the fluidity (formability) of the silane crosslinkable silicone rubber composition [B] are set. The silane crosslinkable silicone rubber in the silane crosslinkable silicone rubber composition [B] is an uncrosslinked body in which the silane coupling agent is not silanol condensed. Practically, when the melt-mixing is performed in the step (c), crosslinking of part (partial crosslinking) may be unavoidable, but formability is kept on the silane crosslinkable silicone rubber composition [B] to be obtained. For example, in order to avoid the occurrence or progress of the silanol condensation reaction, it is preferable that the silane MB and the silanol condensation catalyst are not kept in a high temperature state for a long period of time in the state of being mixed.

In the step (c) of the step (1B), the silane MB is preferably dry-blended with the silanol condensation catalyst or the catalyst masterbatch before both are mixed. A method and conditions of dry blending are not particularly limited, and specific examples thereof include dry mixing and conditions in the step (a-1).

In the production method [C] of the present invention, i.e. the step (1C), the melt-mixing method is not particularly limited, but is basically similar to the melt-mixing in the step (a), and mixing is performed at a temperature at which at least the base rubber melts. The mixing conditions in the step (c) are not particularly limited, and the mixing conditions in the step (a) can be applied. For example, the mixing temperature is appropriately selected according to the base rubber. For example, the temperature is preferably 80 to 250° C., more preferably 100 to 240° C., and still more preferably 120 to 200° C. In the melt-mixing in the step (c), a melt mixing method and conditions capable of maintaining the fluidity (formability) of the silane crosslinkable silicone rubber composition [C] are set. The silane crosslinkable silicone rubber in the silane crosslinkable silicone rubber composition [C] is an uncrosslinked body in which the silane coupling agent is not silanol condensed. Practically, when the melt-mixing is performed in the step (c), crosslinking of part (partial crosslinking) may be unavoidable, but formability is kept on the silane crosslinkable silicone rubber composition [C] to be obtained. For example, in order to avoid the occurrence or progress of the silanol condensation reaction, it is preferable that the silane MB and the silanol condensation catalyst are not kept in a high temperature state for a long period of time in the state of being mixed.

In the step (c) of the step (1C), the silane MB is preferably dry-blended with the silanol condensation catalyst or the catalyst masterbatch before both are melt-mixed. A method and conditions of dry blending are not particularly limited, and specific examples thereof include dry mixing and conditions in the step (a-1).

Note that, in the production method [C] of the present invention, when forming in step (2C) as described later is performed by melt-mixing, the melt mixing in step (c) can be performed simultaneously with the melt-mixing in step (2C) (the melt mixing in step (c) can be omitted).

In this way, the silane crosslinkable silicone rubber compositions [A] to [C] of the present invention are produced as mixtures (kneaded products or melt-mixtures).

The silane crosslinkable silicone rubber composition [A] thus obtained contains a silane crosslinkable silicone rubber, an inorganic filler, a silanol condensation catalyst, and further a crosslinked body of organopolysiloxanes according to the selectivity of the grafting reaction of the silane coupling agent. In this silane crosslinkable silicone rubber, the silanol condensable reaction site of the silane coupling agent may be bonded or adsorbed to the inorganic filler, but is not silanol condensed. Therefore, the silane crosslinkable silicone rubber contains the silane crosslinkable silicone rubber in which the silane coupling agent bonded or adsorbed to the inorganic filler is graft-bonded to the base rubber, and the silane crosslinkable silicone rubber in which the silane coupling agent not bonded or adsorbed to the inorganic filler is graft-bonded to the base rubber.

The silane crosslinkable silicone rubber composition [B] contains the above-described silane crosslinkable silicone rubber, inorganic filler, silanol condensation catalyst, and the like. In this silane crosslinkable silicone rubber, the silanol condensable reaction site of the silane coupling agent may be bonded or adsorbed to the inorganic filler, but is not silanol condensed. Therefore, the silane crosslinkable silicone rubber contains the silane crosslinkable silicone rubber in which the silane coupling agent bonded or adsorbed to the inorganic filler is graft-bonded to the base rubber, and the silane crosslinkable silicone rubber in which the silane coupling agent not bonded or adsorbed to the inorganic filler is graft-bonded to the base rubber.

In addition to the above-described components, the silane crosslinkable silicone rubber composition [B] may contain components based on various competitive reactions according to the selectivity of the grafting reaction of the silane coupling agent and the like. Examples of such a component include a crosslinked body between organopolysiloxanes, a crosslinked body between fluororubbers, a crosslinked body between different components of a millable silicone rubber and a fluororubber, a fluororubber in which a silane coupling agent is graft-bonded, and the like. When the base rubber contains an ethylene copolymer resin, the silane crosslinkable silicone rubber composition [B] may contain, in addition to the above-described components, a crosslinked body between ethylene copolymer resins, a crosslinked body between different components including an ethylene copolymer resin, an ethylene copolymer resin to which a silane coupling agent is graft-bonded, and the like.

On the other hand, the silane crosslinkable silicone rubber composition [C] contains the above-described silane crosslinkable silicone rubber, inorganic filler, three kinds of antioxidants, silanol condensation catalyst, and the like. In this silane crosslinkable silicone rubber, the silanol condensable reaction site of the silane coupling agent may be bonded or adsorbed to the inorganic filler, but is not silanol condensed. Therefore, the silane crosslinkable silicone rubber contains the silane crosslinkable silicone rubber in which the silane coupling agent bonded or adsorbed to the inorganic filler is graft-bonded to the base rubber, and the silane crosslinkable silicone rubber in which the silane coupling agent not bonded or adsorbed to the inorganic filler is graft-bonded to the base rubber.

In addition to the above-described components, the silane crosslinkable silicone rubber composition [C] may contain components based on competitive reactions according to the selectivity of the grafting reaction of the silane coupling agent and the like. Examples of such a component include a crosslinked body between organopolysiloxanes, a crosslinked body between ethylene copolymer resins, a crosslinked body between a millable silicone rubber and an ethylene copolymer resin, an ethylene copolymer resin in which a silane coupling agent is graft-bonded, and the like.

When the base rubber contains a fluororubber, the silane crosslinkable silicone rubber composition [C] may contain, in addition to the above-described components, a crosslinked body between fluororubbers, a crosslinked body between different components including a fluororubber, a fluororubber to which a silane coupling agent is graft-bonded, and the like.

### <Step (2)>

In the methods [A] to [C] of producing a silane crosslinked silicone rubber formed body of the present invention, the silane crosslinkable silicone rubber compositions [A] to [C] are then formed to obtain formed bodies.

In the method [A] of producing a silane crosslinked silicone rubber formed body of the present invention, in the step (2A), depending on the forming method, the silane crosslinkable silicone rubber composition [A] as a mixture can be formed as it is, or can be formed after being once melt-mixed. For example, when press-forming or the like is employed, the silane crosslinkable silicone rubber composition can be formed by pressing the silane crosslinkable silicone rubber composition as it is, and when extrusion forming or the like is employed, the silane crosslinkable silicone rubber composition [A] can be formed by melt-mixing.

The forming method is not particularly limited, and is appropriately selected according to the form of the target product. Examples of the forming method include press-forming, forming using other general-purpose forming machines, and extrusion forming using an extruder or an injection forming machine dedicated to silicone rubber, and the like. In the case of producing a wiring material, the extrusion forming method is preferable from the viewpoint of productivity, and further from the viewpoint of being able to perform coextrusion with a conductor, and the like.

The forming conditions are not particularly limited as long as the silane crosslinkable silicone rubber composition [A] of the present invention can be formed and the silanol condensation reaction does not occur. The melt-mixing conditions are not particularly limited as long as the silane crosslinkable silicone rubber composition [A] of the present invention can be uniformly mixed and formed, and the silanol condensation reaction does not occur. As both the conditions, for example, the melt-mixing method and conditions of the step (a) can be applied. More specifically, the forming (melt-mixing) temperature in this step is set to a temperature equal to or higher than the temperature at which the base rubber melts, and is preferably 80 to 250° C., more preferably 100 to 240° C., and still more preferably 120 to 200° C. In this melt-mixing, formability of the melt-mixture of the silane crosslinkable silicone rubber composition [A] is kept, and the melt-mixing method and conditions are set. In the case of performing coextrusion forming with a conductor using an extruder, it is preferable to set the temperature of the cylinder portion to about 120 to 180° C. and the temperature of the crosshead portion to about 160 to 200° C., although depending on various conditions such as take-up speed of the conductor or the like. A forming speed (linear velocity) in the extrusion forming is not particularly limited, and can be appropriately set according to the characteristics or performance of the extruder, the extrusion amount (coating amount), and the like. The linear velocity can ordinarily be set to less than 1 to 20 m/min, preferably 1 to 10 mm/min. This linear velocity can also be preferably applied to an extrusion amount (coating thickness) to the outer periphery of an extruder or a conductor used in Examples as described later.

The silane crosslinkable silicone rubber in the formed body obtained in the step (2A) is an uncrosslinked body in which the silane coupling agent is not silanol condensed. Practically, when the melt-mixing is performed in the step (2A), crosslinking of part (partial crosslinking) cannot be avoided, but formability is kept on the formed body to be obtained. For example, in order to avoid the occurrence or progress of the silanol condensation reaction, it is preferable that the silane crosslinkable silicone rubber composition [A] is not kept in a high temperature state for a long period of time.

In the method [B] of producing a silane crosslinked silicone rubber formed body according to a preferred embodiment of the present invention, the forming method is not particularly limited, and can be appropriately selected according to the characteristics of the silane crosslinkable silicone rubber composition [B] and the form of the target product. Examples of the forming method include press-forming, forming using other general-purpose forming machines, and extrusion forming using an extruder or an injection forming machine either general purpose or dedicated to silicone rubber, and the like. In the case of producing a wiring material, the extrusion forming method is preferable from the viewpoint of productivity, and further from the viewpoint of being able to perform coextrusion with a conductor, and the like. When the masterbatch is a clay-like solid and the silane crosslinkable silicone rubber composition [B] is a kneaded product, press-forming, extrusion forming using an extruder or an injection forming machine dedicated to silicone rubber, or the like is preferable. When the silane crosslinkable silicone rubber composition [B] is a melt-mixture, forming using a general-purpose forming machine, extrusion forming using an extruder or an injection molding machine for general purpose, or the like is preferable.

In the step (2B), depending on the forming method, the silane crosslinkable silicone rubber composition [B] can be formed as it is, or can be formed after being once melt-mixed. For example, when press-forming or the like is employed, the silane crosslinkable silicone rubber composition can be formed by pressing the silane crosslinkable silicone rubber composition [B] as it is, and when extrusion forming or the like is employed, the silane crosslinkable silicone rubber composition [B] can be formed by melt-mixing.

The forming conditions are not particularly limited as long as the silane crosslinkable silicone rubber composition [B] of the present invention can be formed and the silanol condensation reaction does not occur. The melt-mixing conditions is not particularly limited as long as the silane crosslinkable silicone rubber composition [B] of the present invention can be uniformly mixed and formed, and the silanol condensation reaction does not occur. As both the conditions, for example, the melt-mixing method and conditions of the step (a) can be applied. More specifically, the forming (melt-mixing) temperature in this step is set to a temperature equal to or higher than the temperature at which the base rubber melts, and is preferably 80 to 250° C., more preferably 100 to 240° C., and still more preferably 120 to 200° C. In this melt-mixing, formability of the melt-mixture of the silane crosslinkable silicone rubber composition [B] is kept, and the melt-mixing method and conditions are set. In the case of performing coextrusion forming with a conductor using an extruder, it is preferable to set the temperature of the cylinder portion to about 120 to 180° C. and the temperature of the crosshead portion to about 160 to 200° C., although depending on various conditions such as take-up speed of the conductor or the like. A forming speed (linear velocity) in the extrusion forming is not particularly limited, and can be appropriately set according to the characteristics or performance of the extruder, the extrusion amount (coating amount), and the like. The linear velocity can ordinarily be set to less than 1 to 20 m/min, preferably 1 to 10 mm/min. This linear velocity can also be preferably applied to an extrusion amount (coating thickness) to the outer periphery of an extruder or a conductor used in Examples as described later.

The silane crosslinkable silicone rubber in the formed body obtained in the step (2B) is an uncrosslinked body in which the silane coupling agent is not silanol condensed. Practically, when the melt-mixing is performed in the step (2B), crosslinking of part (partial crosslinking) cannot be avoided, but formability is kept on the formed body to be obtained. For example, in order to avoid the occurrence or progress of the silanol condensation reaction, it is preferable that the silane crosslinkable silicone rubber composition [B] is not kept in a high temperature state for a long period of time.

In the method [C] of producing a silane crosslinked silicone rubber formed body according to another preferred embodiment of the present invention, the above-described problem of formability is solved in the silane crosslinkable silicone rubber composition [C]. Thus, the forming method is not particularly limited, and can be appropriately selected according to the form of the target product. Examples of the forming method include press-forming, forming using other general-purpose forming machines, and extrusion forming using an extruder or an injection forming machine for general purpose, and the like. In the case of producing a wiring material, the extrusion forming method is preferable from the viewpoint of productivity, and further from the viewpoint of being able to perform coextrusion with a conductor, and the like.

The forming conditions (melt-mixing conditions) are not particularly limited as long as they are conditions under which the silane crosslinkable silicone rubber composition [C] can be formed and the silanol condensation reaction does not occur. For example, the melt-mixing method and conditions of the step (a) can be applied. More specifically, the forming (melt-mixing) temperature in this step is set to a temperature equal to or higher than the temperature at which the base rubber melts, and is preferably 80 to 250° C., more preferably 100 to 240° C., and still more preferably 120 to 200° C. In this melt-mixing, formability of the melt-mixture of the silane crosslinkable silicone rubber composition [C] is kept, and the melt-mixing method and conditions are set. In the case of performing coextrusion forming with a conductor using a general-purpose extruder, it is preferable to set the temperature of the cylinder portion to about 120 to 180° C. and the temperature of the crosshead portion to about 160 to 200° C., although depending on various conditions such as take-up speed of the conductor or the like. A forming speed (linear velocity) in the extrusion forming is not particularly limited, and can be appropriately set according to the characteristics or performance of the extruder, the extrusion amount (coating amount), and the like. The linear velocity can ordinarily be set to less than 1 to 20 m/min, preferably 1 to 10 mm/min. This linear velocity can also be preferably applied to an extrusion amount (coating thickness) to the outer periphery of an extruder or a conductor used in Examples as described later.

The silane crosslinkable silicone rubber in the formed body obtained in the step (2C) is an uncrosslinked body in which the silane coupling agent is not silanol condensed. Practically, when the melt-mixing is performed in the step (2C), crosslinking of part (partial crosslinking) cannot be avoided, but formability is kept on the formed body to be obtained. For example, in order to avoid the occurrence or progress of the silanol condensation reaction, it is preferable that the silane crosslinkable silicone rubber composition [C] is not kept in a high temperature state for a long period of time.

In the methods [A] to [C] of producing a silane crosslinked silicone rubber formed body of the present invention, the step (2) can be performed simultaneously or continuously with the step (c). For example, a series of steps can be employed in which the silane MB is mixed with the silanol condensation catalyst or the catalyst MB by dry blending or the like immediately before a coating device (extruder), and then melt-mixed in a coating device (step (c)), or the silane MB and the silanol condensation catalyst or the catalyst MB are separately placed in the coating device, and subsequently, melt-mixed (step (c)) and formed (coextrusion-formed) on an outer peripheral of a conductor or the like.

Further, in the methods [A] and [B] of producing a silane crosslinked silicone rubber formed body of the present invention, a series of steps can be employed in which the silane MB and the catalyst MB are kneaded (step (c)), and then formed with a forming machine such as a press machine (step (2)).

### <Step (3)>

In the methods [A] to [C] of producing a silane crosslinked silicone rubber formed body of the present invention, the formed body obtained in the step (2) is then brought into contact with water to produce silane crosslinked silicone rubber formed bodies [A] to [C]. Since the formed body obtained in the step (2) is an uncrosslinked body, in this step, a silanol condensation reaction of a silanol condensable reaction site of the silane coupling agent graft-bonded to the base rubber is caused to occur and progress (accelerate), and finally silane crosslinking is performed.

The contact between the uncrosslinked formed body and water can be performed by an ordinary method. Since the silanol condensation reaction proceeds only by being left standing at normal temperature, for example, in a temperature environment of about 20 to 25° C., it is not necessary to actively bring the uncrosslinked formed body into contact with water. From the viewpoint of accelerating the silanol condensation reaction (crosslinking reaction), it is preferable to actively bring the uncrosslinked formed body into contact with water. Examples of the contact method include a method (condition) ordinarily applied to the silane crosslinking method, and examples thereof include a method of performing contact under an ordinary pressure environment, and specific examples thereof include exposure to a saturated water vapor atmosphere, exposure to a high humidity environment, immersion in water at room temperature or warm water (e.g. 50 to 90° C.), placement in a wet heat bath, exposure to high temperature water vapor, and the like. In addition, pressure may be applied to in order to penetrate moisture thereinto on the contact.

In this way, the silane crosslinked silicone rubber formed bodies [A] to [C] are produced.

The silane crosslinked silicone rubber formed body [A] of the present invention contains a crosslinked silicone rubber in which a base rubber (particularly, an organopolysiloxane contained in a millable silicone rubber) is condensed through a siloxane bond, and optionally a crosslinked body of organopolysiloxanes. The silane crosslinked silicone rubber formed body contains an inorganic filler, and the inorganic filler may be bonded to a silane coupling agent of the crosslinked silicone rubber. Therefore, it is considered that the crosslinked silicone rubber contains a crosslinked silicone rubber in which a plurality of base rubbers is bonded or adsorbed to an inorganic filler by a silane coupling agent and bonded (crosslinked) through the inorganic filler and the silane coupling agent, and a crosslinked silicone rubber in which the hydrolysable groups of the silane coupling agent graft-bonded to the base rubber are hydrolyzed and silanol condensation reacted with each other to be crosslinked through the silane coupling agent (siloxane bond) (without through the inorganic filler).

The silane crosslinked silicone rubber formed bodies [B] and [C] according to a preferred embodiment of the present invention each contain a crosslinked silicone rubber in which a base rubber (particularly, an organopolysiloxane contained in a millable silicone rubber) is condensed through a siloxane bond. The silane crosslinked silicone rubber formed body contains an inorganic filler, and the inorganic filler may be bonded to a silane coupling agent of the crosslinked silicone rubber. Therefore, it is considered that the crosslinked silicone rubber contains a crosslinked silicone rubber in which a plurality of base rubbers is bonded or adsorbed to an inorganic filler by a silane coupling agent and bonded (crosslinked) through the inorganic filler and the silane coupling agent, and a crosslinked silicone rubber in which the hydrolysable groups of the silane coupling agent graft-bonded to the base rubber are hydrolyzed and silanol condensation reacted with each other to be crosslinked through the silane coupling agent (siloxane bond) (without through the inorganic filler). The silane crosslinked silicone rubber formed bodies [B] and [C] may contain this silanol condensate as a component based on the competitive reaction.

As described above, in the production method [A] of the present invention, in the step (a), the grafting reaction between the silane coupling agent and the base rubber can be caused to occur (accelerate) in the presence of the inorganic filler while suppressing the volatilization and self-condensation reaction of the silane coupling agent and the crosslinking reaction between the organopolysiloxanes. Accordingly, the silane crosslinkable silicone rubber composition [A] of the present invention is brought into contact with water under relatively mild conditions, and thus a highly developed crosslinked structure including a crosslinked structure in which an inorganic filler is spirally wound can be constructed, and the silane crosslinked silicone rubber formed body [A] exhibiting excellent outer appearance, heat resistance, and tensile strength can be produced.

As described above, in the production method [B] of the present invention, in the step (a), the grafting reaction between the silane coupling agent and the base rubber can be caused to occur (accelerate) in the presence of the inorganic filler while suppressing the competitive reaction including the volatilization and self-condensation reaction of the silane coupling agent, the crosslinking reaction between the organopolysiloxanes, and the like. When the base rubber contains an ethylene copolymer resin, the fluidity is increased during forming, and the forming can be performed with a general-purpose extruder without impairing excellent manufacturability. Accordingly, the silane crosslinkable silicone rubber composition [B] according to a preferred embodiment of the present invention is brought into contact with water under relatively mild conditions, and thus a highly developed crosslinked structure including a crosslinked structure in which an inorganic filler is spirally wound can be constructed, and the silane crosslinked silicone rubber formed body [B] having excellent outer appearance and exhibiting remarkable heat resistance and tensile strength can be produced.

As described above, in the production method [C] of the present invention, in the step (a), the grafting reaction between the silane coupling agent and the base rubber can be caused to occur (accelerate) even in the presence of the inorganic filler while increasing the fluidity of the reaction system, and further suppressing the competitive reaction including the volatilization and self-condensation reaction of the silane coupling agent and the crosslinking reaction between the organopolysiloxanes. In addition, the fluidity of the melt-mixture increases during forming (during melt-mixing), and the forming can be performed with a general-purpose extruder without impairing excellent manufacturability. Accordingly, the silane crosslinkable silicone rubber composition [C] according to another preferred embodiment of the present invention is brought into contact with water under relatively mild conditions, and thus a highly developed crosslinked structure including a crosslinked structure in which an inorganic filler is spirally wound can be constructed can be constructed, and the silane crosslinked silicone rubber formed body [C] having excellent outer appearance and exhibiting remarkable heat resistance and tensile strength can be produced.

### [Silane Crosslinked Silicone Rubber Formed Article]

The silane crosslinked silicone rubber formed articles [A] to [C] of the present invention are products including the silane crosslinked silicone rubber formed bodies [A] to [C] of the present invention, and can be used as various rubber formed articles, and can be preferably used as substitutes for conventional silicone rubber formed articles. Examples thereof include coating materials for wiring materials such as insulated wires, cables, or optical fiber cables, materials for rubber substitute wires/cable materials, heat-resistant parts for microwave or gas range, heat-resistant wire parts, heat-resistant sheets, heat-resistant films, and the like. Further, examples thereof include: power plugs; connectors; sleeves; boxes; tape base materials, tubes; sheets; packings; cushion materials; vibration-proof materials; and wiring materials to be used for internal wiring or external wiring of electric or electronic pieces of equipment, in particular, electric wires or optical fiber cables, and further the above-described wiring materials, and tubular formed bodies.

The silane crosslinked silicone rubber formed articles [A] to [C] of the present invention may be formed articles including the silane crosslinked silicone rubber formed bodies [A] to [C] of the present invention in a part thereof (rubber formed part), or may be formed articles including only of the silane crosslinked silicone rubber formed bodies [A] to [C] of the present invention.

The silane crosslinked silicone rubber formed article [A] of the present invention shows excellent outer appearance, heat resistance and tensile strength, similarly to the silane crosslinked silicone rubber formed body [A] of the present invention. The silane crosslinked silicone rubber formed article [A] of the present invention is preferably applied to a covering material, a sheet, and a packing of a wiring material by utilizing the above characteristics.

Each of the silane crosslinked silicone rubber formed articles [B] and [C] of the present invention can realize high heat resistance and strength while maintaining excellent outer appearance, similarly to the silane crosslinked silicone rubber formed body [B] or [C] of the present invention. Accordingly, each of the silane crosslinked silicone rubber formed articles [B] and [C] of the present invention is preferably applied to a coating material, a sheet, and a packing of a wiring material, and further, an application requiring high heat resistance, for example, a packing around an engine room for an automobile, a packing around a high-output motor, or the like, by utilizing the above characteristics, and is further applied to an application in which a general silicone rubber is difficult to apply and is easily scratched by repeated vibration or the like, or an application in which bending and stretching are repeated, for example, an insulated wire for an automobile, a wiring material for an industrial robot, an industrial wire being dragged outdoors, or the like, by utilizing wear resistance exhibiting high strength.

A sheet or packing preferable for the silane crosslinked silicone rubber formed articles [A] to [C] of the present invention will be described.

Examples of the sheet or packing include those obtained by forming the silane crosslinkable silicone rubber compositions [A] to [C] of the present invention into a predetermined shape and then bringing the resulting products into contact with water and crosslinking the contacted products. The shape and size of the sheet or packing are appropriately determined according to the use and the like.

A wiring material (an insulated wire for an automobile) preferable for the silane crosslinked silicone rubber formed articles [A] to [C] of the present invention will be described.

Examples of the wiring material include a wiring material formed of the silane crosslinked silicone rubber formed bodies [A] to [C] of the present invention, in which the wiring material has a coating layer on the outer periphery of a conductor, the coating layer being formed by forming the silane crosslinkable silicone rubber compositions [A] to [C] of the present invention into a tubular layer and crosslinking the coating layer. Here, when the coating layer of the wiring material is composed of a plurality of layers, at least one of the layers may be formed of the silane crosslinked silicone rubber formed bodies [A] to [C] of the present invention.

The wiring material is the same as an ordinary wiring material used in various electrical- or electronic-equipment fields and industrial fields, except that the coating layer is formed of the silane crosslinked silicone rubber formed bodies [A] to [C] of the present invention. The coating layer formed of the silane crosslinked silicone rubber formed body of the present invention is provided directly or through another layer on the outer periphery of the conductor, and the presence or absence, material, and the like of the other layer are appropriately determined according to the type, use, required characteristics, and the like of the wiring material. As the conductor, an ordinary conductor can be used, and examples thereof include a single wire or a twisted wire (one obtained by vertically attaching or twisting tensile strength fibers) of copper or aluminum. Moreover, in addition to a bare wire, a tin-plated conductor or a conductor having an enamel-coating insulation layer can be used. The thickness of the coating layer formed by the silane crosslinked silicone rubber formed bodies [A] to [C] of the present invention is not particularly limited, but is ordinarily about 0.15 to 5 mm.

A wiring material [A] of the present invention can be produced by performing forming by various forming methods in the step (2A), using, for example, an extruder or an injection forming machine dedicated to silicone rubber, and then performing contacting with water. Preferably, the wiring material [A] can be produced by disposing the silane crosslinkable silicone rubber composition [A] of the present invention in a tubular shape on the outer periphery of a conductor and then subjecting the silane crosslinkable silicone rubber composition [A] to a crosslinking reaction (silanol condensation reaction). For example, in the method [A] of producing a silane crosslinked silicone rubber formed body of the present invention described above, the wiring material [A] can be produced by setting the forming step (2A) to the step of coextrusion forming of the silane crosslinkable silicone rubber composition [A] onto the outer periphery of the conductor using a coating device (extruder) dedicated to silicone rubber. Specific coextrusion forming is as described above.

A wiring material [B] of the present invention can be produced by performing forming by various forming methods in the step (2B), using, for example, an extruder or an injection forming machine, and then performing contacting with water.

Preferably, the wiring material [B] can be produced by disposing the silane crosslinkable silicone rubber composition [B] of the present invention in a tubular shape on the outer periphery of a conductor and then subjecting the silane crosslinkable silicone rubber composition [B] to a crosslinking reaction (silanol condensation reaction). For example, in the method [B] of producing a silane crosslinked silicone rubber formed body of the present invention described above, the wiring material [B] can be produced by setting the forming step (2B) to the step of coextrusion forming of the silane crosslinkable silicone rubber composition [B] onto the outer periphery of the conductor using a coating device (extruder) either general purpose or dedicated to silicone rubber. Specific coextrusion forming is as described above.

A wiring material [C] of the present invention can be produced by performing forming by various forming methods in the step (2C), using, for example, an extruder or an injection forming machine, and then performing contacting with water.

Preferably, the wiring material [C] can be produced by disposing the silane crosslinkable silicone rubber composition [C] of the present invention in a tubular shape on the outer periphery of a conductor and then subjecting the silane crosslinkable silicone rubber composition [C] to a crosslinking reaction (silanol condensation reaction). For example, in the method [C] of producing a silane crosslinked silicone rubber formed body of the present invention described above, the wiring material [C] can be produced by setting the forming step (2C) to the step of coextrusion forming of the silane crosslinkable silicone rubber composition [C] onto the outer periphery of the conductor using a coating device (extruder) either general purpose or dedicated to silicone rubber. Specific coextrusion forming is as described above.

### EXAMPLES

Hereinafter, the present invention will be described in more detail based on Examples, but the present invention is not limited to the following Examples.

### Examples [A]

Examples [A] are examples and comparative examples relating to the present invention using the silane crosslinkable silicone rubber composition [A] of the present invention.

The compounds used in Examples [A] are shown below.

### <Base Rubber>

(1) Millable silicone rubber: ELASTSIL R401/70S (trade name, compound (agent A) containing methylvinyl silicone rubber and fumed silica, specific gravity 1.18 g/cm³, manufactured by Wacker Asahikasei Silicone Co., Ltd.)
(2) Millable silicone rubber: ELASTSIL R401/80S (trade name, compound (agent A) containing methylvinyl silicone rubber and fumed silica, specific gravity 1.20 g/cm³, manufactured by Wacker Asahikasei Silicone Co., Ltd.)
(3) Millable silicone rubber: XIAMETER RBB6660-60 (trade name, compound (agent A) containing methylvinyl silicone rubber and fumed silica, specific gravity 1.24 g/cm³, manufactured by Dow Corning Corp.)
(4) Millable silicone rubber: FE-351U (trade name, compound (agent A) containing methyl fluoroalkyl silicone rubber and fumed silica, specific gravity: 1.44 g/cm³, manufactured by Shin-Etsu Silicone Co., Ltd.)
(5) Ethylene-ethyl acrylate copolymer resin (EEA): NUC6510 (trade name: manufactured by ENEOS NUC Corporation)
(6) Ethylene-vinyl acetate copolymer resin (EVA): VF120T (trade name: manufactured by Ube-Maruzen Polyethylene Co., Ltd.)
(7) Linear low-density polyethylene (LLDPE): EVOLUE SP0510 (trade name: manufactured by Prime Polymer Co., Ltd.)
(8) Polypropylene resin (PP): PB222A (trade name, RANDOM PP, manufactured by SunAllomer Ltd.)

The specific gravity of the millable silicone rubber is a value measured in accordance with JIS K 7112 (1999), Method A (collecting gas over water).

Specifically, a sample of 20 mm square (cube) was prepared from each millable silicone rubber, and the mass of the sample was measured in the air and in a liquid (distilled water). From the obtained value and the density (specific gravity) of the liquid, a value p calculated from the following formula was taken as the specific gravity of the millable silicone rubber.

P={Ma/Ma−Mw}×ρw

In the above formula, Ma designates a sample mass in the air (g), Mw designates a sample mass in the liquid (g), and pw designates a density of the liquid (g/cm³).

### <Inorganic Filler>

(1) Inorganic filler: SOFTON 1200 (trade name, calcium carbonate, manufactured by BIHOKU FUNKA KOGYO Co., Ltd.)
(2) Inorganic filler: AEROSIL 200 (trade name, dry silica, manufactured by NIPPON AEROSIL Co., Ltd.)
(3) Inorganic filler: CRYSTALITE 5X (trade name, crystalline silica, manufactured by Takimori Ltd.)
(4) Inorganic filler: SATINTONE SP-33 (trade name, calcined clay, manufactured by BASF)
(5) Inorganic filler: MICRO ACE K-1 (trade name, talc, manufactured by Nippon Talc Co., Ltd.)
(6) Inorganic filler: MAGSEEDS FK621 (trade name, magnesium hydroxide, manufactured by Konoshima Chemical Co., Ltd.)

### <Silane Coupling Agent>

KBM-1003: trade name, vinyltrimethoxysilane, manufactured by Shin-Etsu Chemical Co., Ltd.

### <Silanol Condensation Catalyst>

ADK STAB OT-1: trade name, dioctyltin dilaurate, manufactured by ADEKA CORPORATION

### <ORGANIC PEROXIDE>

PERHEXA 25B: trade name, 2,5-dimethyl-2,5-di(tert-butylperoxy)hexane, decomposition temperature 154° C., manufactured by NOF Corporation

### <Antioxidant>

IRGANOX 1010 (trade name, hindered phenol-based antioxidant, manufactured by BASF)

### Examples A1 to A22 and Comparative Examples A2 to A7

Each of Examples A1 to A22 and Comparative Examples A2 to A7 were carried out using the components shown in Tables A1 to A3.

In Tables A1 to A3, the numerical values for the composition amount (content) of the respective examples and comparative examples are in terms of part by mass, unless otherwise specified. In addition, in each component column, the blank means that a composition amount of a corresponding component is 0 part by mass.

In each of the examples and comparative examples, a part of the base rubber (specifically, the millable silicone rubber or EEA shown in the “Catalyst MB” column in Tables A1 to A3) was used in the mass ratio shown in the same column as the carrier resin of the catalyst MB.

First, an inorganic filler, a silane coupling agent, and an organic peroxide, in mass ratios shown in the “Silane MB” column in Tables A1 to A3, were placed in a rotary blade mixer (Mazelar PM: trade name, manufactured by Mazelar CO., LTD.), and the resultant mixture was stirred (premixed) at a rotation speed of 10 rpm for 1 minute at room temperature (25° C.) (step (a-1)). Thus, a powder mixture was obtained.

Next, the powder mixture, and a base rubber and an antioxidant shown in the “Silane MB” column in Tables A1 to A3, in mass ratios shown in the same column, were placed in a Banbury mixer (volume: 2 L) heated to 80° C. in advance, the resultant mixture was mixed at a rotation speed of 40 rpm for 5 minutes, and further subjected to finish kneading (melt-mixing) at a rotation speed of 30 rpm for 3 minutes. After confirming that the temperature of the mixture reached 180 to 200° C., i.e. temperatures equal to or higher than a decomposition temperature of the organic peroxide, the mixture was discharged to obtain a silane MB (step (a) in conjunction with steps (a-2) and (a-1)).

On the other hand, a base rubber, a silanol condensation catalyst, and an antioxidant shown in the “Catalyst MB” column in Tables A1 to A3, in mass ratios shown in the same column, were sequentially placed in a Banbury mixer (volume: 2 L) heated to 80° C. in advance, the resultant mixture was mixed at a rotation speed of 40 rpm for 5 minutes, and then subjected to finish kneading (melt-mixing) at a rotation speed of 30 rpm for 3 minutes. After confirming that the temperature of the mixture reached about 160° C. and the carrier rubber was sufficiently melted, the mixture was discharged to obtain a catalyst MB (step (b)).

Then, the silane MB and the catalyst MB were kneaded at room temperature (25° C.) for 5 minutes using an 8-inch open roll to obtain a silane crosslinkable silicone rubber composition (step (c)). At this time, the mixing ratios of the silane MB and the catalyst MB was set to the mass ratios shown in the “Silane MB” column and the “Catalyst MB” column in Tables A1 to A3.

Each of the prepared silane crosslinkable silicone rubber compositions was used, and A4 size (210 mm×297 mm) 2 mm thick sheet-shaped formed bodies were produced as follows.

Each of the silane crosslinkable silicone rubber compositions was placed in a non-preheated press machine, and then heating was started. When the temperature of each of the silane crosslinkable silicone rubber compositions reached 120° C., pressing was performed under a pressure of 10 MPa, and this state was maintained for 3 minutes to perform press-forming (step (2A)).

The resulting sheet-shaped formed bodies (thickness: 2 mm) were left to stand still in atmosphere with the temperature of 60° C. and the humidity of 95% RH for 24 hours to bring the silane crosslinkable silicone rubber compositions into contact with water (step (3A)).

In this way, 2 mm thick sheet-shaped formed bodies (corresponding to crosslinked bodies and silane crosslinked silicone rubber formed bodies) were produced.

### Comparative Example A1

The components shown in the “Silane MB” column in Table A3 were placed in a Banbury mixer, the resultant mixture was melt-mixed at 60 to 100° C. for 10 minutes, and then discharged at a material discharge temperature of 100° C. to obtain a crosslinkable silicone rubber composition.

Then, the silane crosslinkable silicone rubber composition was placed in a non-preheated press machine, and then heating was started. When the temperature of the crosslinkable silicone rubber composition reached 120° C., pressing was performed under a pressure of 10 MPa, and this state was maintained for 3 minutes to perform press-forming.

In this way, an A4 size 2 mm thick sheet-shaped formed body was produced.

The sheet-shaped formed bodies thus produced were evaluated as follows, and the results were shown in Tables A1 to A3.

### <Sheet Outer Appearance Test>

The outer appearance of each of the produced sheet-shaped formed bodies was visually confirmed and evaluated according to the following evaluation criteria.

### —Evaluation Criteria—

“A” (good appearance, pass): When a sample body was confirmed to have smooth outer appearance (surface) and have no gel aggregate.
“B” (acceptable outer appearance, pass): When a sample body was confirmed to have 1 to 10 gel aggregates with a thickness of 1 mm or less on its sheet surface, but was acceptable as a product.
“D” (poor outer appearance, fail): When a sample body was confirmed to have significant flow mark, gel aggregates, roughness, and the like on its surface.

### <Measurement of Tensile Strength>

A No. 3 dumbbell-shaped test piece specified in Japanese Industrial Standard (JIS) K 6251 (2017) was punched out from each of the produced sheet-shaped formed bodies. Using the dumbbell test piece, a tensile test was performed under the conditions of a gauge length of 20 mm and a tensile speed of 200 mm/min in accordance with JIS C 3005, and the strength at break (MPa) was measured.

The measured tensile strength was evaluated by applying the following evaluation criteria.

### —Evaluation Criteria—

“A” (excellent): A sample body has a tensile strength of 3 MPa or more.
“B” (good): A sample body has a tensile strength of 2 MPa or more and less than 3 MPa.
“C” (acceptable): A sample body has a tensile strength of 1 MPa or more and less than 2 MPa.
“D” (fail): A sample body has a tensile strength of less than 1 MPa.

### <Hot Set Test>

A No. 3 dumbbell-shaped test piece specified in JIS K 6251 (2017) was punched out from each of the produced sheet-shaped formed bodies. A weight of 205 gf (20 N/cm²) was attached to the lower end of the dumbbell test piece, and the resultant test piece was hung vertically and left in a temperature environment of any one of 150° C., 200° C., and 250° C. for 15 minutes.

After a lapse of 15 minutes, the gauge distance of the dumbbell test piece with the weight attached was measured. At this time, when the portion between the gauge marks of the dumbbell test piece was not cut, and the gauge distance of the dumbbell test piece was within 175% of the gauge distance before the test (before the application of the load: initial gage length) (the gauge distance was extended 2.75 times or less), it was defined as pass. The results of the hot set test were applied to the following evaluation criteria and evaluated.

This test is a test for evaluating the heat resistance of the sheet-shaped formed bodies, and is also a test for evaluating the crosslinked state of the sheet-shaped formed bodies. The higher the evaluation criteria in this test are, the more sufficient the crosslinked structure is constructed in the sheet-shaped formed bodies.

This means that the sheet-shaped formed bodies show characteristics of exhibiting high heat resistance and not melting even at high temperature.

### —Evaluation Criteria—

“A” (excellent): A sample body passed at a temperature of 250° C.
“B” (good): Although a sample body failed at a temperature of 250° C., the sample body passed at a temperature of 200° C.
“C” (acceptable): Although a sample body failed at a temperature of 200° C., the sample body passed at a temperature of 150° C.
“D” (fail): A sample body did not pass at any temperature.

TABLE A1

| | | | | Example A | | | | | | | | | |
|---|---|---|---|---|---|---|---|---|---|---|---|---|---|
| | | | | 1 | 2 | 3 | 4 | 5 | 6 | 7 | 8 | 9 | 10 |
| Silane | Base | Millable silicone | ELASTSIL | 95 | | | | 90 | 80 | 95 | 95 | 95 | 95 |
| MB | Rubber | rubber | R401/70S | | | | | | | | | | |
| | | Millable silicone | ELASTSIL | | 95 | | | | | | | | |
| | | rubber | R401/80S | | | | | | | | | | |
| | | Millable silicone | XIAMETER | | | 95 | | | | | | | |
| | | rubber | RBB6660-60 | | | | | | | | | | |
| | | Millable silicone | FE-351-U | | | | 95 | | | | | | |
| | | rubber | | | | | | | | | | | |
| | | EEA | NUC6510 | | | | | | | | | | |
| | | EVA | VF120T | | | | | | | | | | |
| | | LLDPE | EVOLUE SP0510 | | | | | | | | | | |
| | | PP | PB222A | | | | | | | | | | |
| | Inorganic | Calcium carbonate | SOFTON 1200 | | | | | | | 30 | | | |
| | filler | Dry silica | AEROSIL 200 | 5 | 5 | 5 | 5 | 5 | 5 | | | | |
| | | Crystalline silica | CRYSTALITE 5X | | | | | | | | 30 | | |
| | | Calcined clay | SATINTONE SP-33 | | | | | | | | | 30 | |
| | | Talc | MICRO ACE K-1 | | | | | | | | | | 30 |
| | | Magnesium hydroxide | MAGSEEDS FK621 | | | | | | | | | | |
| | Antioxidant | | IRGANOX 1010 | 0.1 | 0.1 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 6 | 6 | 6 | 6 | 6 |
| | Organic peroxide | | PERHEXA 25B | 0.1 | 0.1 | 0.1 | 0.1 | 0.1 | 0.1 | 0.1 | 0.1 | 0.1 | 0.1 |
| | Total | | | 106.2 | 106.2 | 106.2 | 106.2 | 101.2 | 91.2 | 131.2 | 131.2 | 131.2 | 1312 |
| Catalyst | Base | Millable silicone | ELASTSIL | 5 | 5 | 5 | 5 | 10 | 20 | 5 | 5 | 5 | 5 |
| MB | Rubber | rubber | R401/70S | | | | | | | | | | |
| | | EEA | NUC6510 | | | | | | | | | | |

| | | | | | | | | | | | |
|---|---|---|---|---|---|---|---|---|---|---|---|
| Antioxidant | IRGANOX 1010 | 0.1 | 0.1 | 0.1 | 0.1 | 0.1 | 0.1 | 0.1 | 0.1 | 0.1 | 0.1 |
| Silanol condensation catalyst | ADK STAB OT-1 | 0.1 | 0.1 | 0.1 | 0.1 | 0.1 | 0.1 | 0.1 | 0.1 | 0.1 | 0.1 |

| | | | | | | | | | | | |
|---|---|---|---|---|---|---|---|---|---|---|---|
| | Total | 5.2 | 5.2 | 5.2 | 5.2 | 10.2 | 20.2 | 5.2 | 5.2 | 5.2 | 5.2 |
| Evaluation | Sheet outer appearance fest | A | A | A | A | A | A | A | A | A | A |
| | Tensile strength (MPa) | A | B | A | A | A | B | B | A | B | B |
| | Hot set test | A | A | A | A | A | B | B | A | B | B |

TABLE A2

| | | | | Example A | | | | | | | | | |
|---|---|---|---|---|---|---|---|---|---|---|---|---|---|
| | | | | 11 | 12 | 13 | 14 | 15 | 16 | 17 | 18 | 19 | 20 |
| Silane | Base | Millable silicone | ELASTSIL | 95 | 95 | 95 | 75 | 75 | 75 | 75 | 95 | 95 | 95 |
| MB | Rubber | rubber | R401/70S | | | | | | | | | | |
| | | Millable silicone | ELASTSIL | | | | | | | | | | |
| | | rubber | R401/80S | | | | | | | | | | |
| | | Millable silicone | XIAMETER | | | | | | | | | | |
| | | rubber | RBB6660-60 | | | | | | | | | | |
| | | Millable silicone | FE-351-U | | | | | | | | | | |
| | | rubber | | | | | | | | | | | |
| | | EEA | NUC6510 | | | | 20 | | | | | | |
| | | EVA | VF120T | | | | | 20 | | | | | |
| | | LLDPE | EVOLUE SP0510 | | | | | | 20 | | | | |
| | | PP | PB222A | | | | | | | 20 | | | |
| | Inorganic | Calcium carbonate | SOFTON 1200 | | | | | | | | | | |
| | filler | Dry silica | AEROSIL 200 | | 0.5 | | 5 | 5 | 5 | 5 | 5 | 5 | 5 |
| | | Crystalline silica | CRYSTALITE 5X | | | 300 | | | | | | | |
| | | Calcined clay | SATINTONE SP-33 | | | | | | | | | | |
| | | Talc | MICRO ACE K-1 | | | | | | | | | | |
| | | Magnesium hydroxide | MAGSEEDS FK621 | 30 | | | | | | | | | |
| | Antioxidant | | IRGANOX 1010 | 0.1 | 0.1 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 6 | 6 | 6 | 1.5 | 15 |
| | Organic peroxide | | PERHEXA 25B | 0.1 | 0.1 | 0.1 | 0.1 | 0.1 | 0.1 | 0.1 | 0.1 | 0.1 | 0.1 |
| | Total | | | 131.2 | 101.7 | 401.2 | 106.2 | 106.2 | 106.2 | 106.2 | 106.2 | 101.7 | 115.2 |
| Catalyst | Base | Millable silicone | ELASTSIL | 5 | 5 | 5 | 5 | 5 | 5 | 5 | | 5 | 5 |
| MB | Rubber | rubber | R401/70S | | | | | | | | | | |
| | | EEA | NUC6510 | | | | | | | | 5 | | |

| | | | | | | | | | | | |
|---|---|---|---|---|---|---|---|---|---|---|---|
| Antioxidant | IRGANOX 1010 | 0.1 | 0.1 | 0.1 | 0.1 | 0.1 | 0.1 | 0.1 | 0.1 | 0.1 | 0.1 |
| Silanol condensation catalyst | ADK STAB OT-1 | 0.1 | 0.1 | 0.1 | 0.1 | 0.1 | 0.1 | 0.1 | 0.1 | 0.1 | 0.1 |

| | | | | | | | | | | | |
|---|---|---|---|---|---|---|---|---|---|---|---|
| | Total | 5.2 | 5.2 | 5.2 | 5.2 | 5.2 | 5.2 | 5.2 | 5.2 | 5.2 | 5.2 |
| Evaluation | Sheet outer appearance test | A | B | A | A | A | A | A | A | A | B |
| | Tensile strength (MPa) | A | C | C | A | A | A | A | A | C | A |
| | Hot set test | A | B | C | B | B | B | C | A | C | A |

TABLE A3

| | | | | Example A | | Comparative Example A | | | | | | |
|---|---|---|---|---|---|---|---|---|---|---|---|---|
| | | | | 21 | 22 | 1 | 2 | 3 | 4 | 5 | 6 | 7 |
| Silane | Base | Millable silicone | ELASTSIL | 95 | 95 | 100 | 95 | 95 | 95 | 95 | 95 | 95 |
| MIB | Rubber | rubber | R401/70S | | | | | | | | | |
| | | Millable silicone | ELASTSIL | | | | | | | | | |
| | | rubber | R401/80S | | | | | | | | | |
| | | Millable silicone | XIAMETER | | | | | | | | | |
| | | rubber | RBB6660-60 | | | | | | | | | |
| | | Millable silicone | FE-351-U | | | | | | | | | |
| | | rubber | | | | | | | | | | |
| | | EEA | NUC6510 | | | | | | | | | |
| | | EVA | VF120T | | | | | | | | | |
| | | LLDPE | EVOLUE SP0510 | | | | | | | | | |
| | | PP | PB222A | | | | | | | | | |
| | Inorganic | Calcium carbonate | SOFTON 1200 | | | | | | | | | |
| | filler | Dry silica | AEROSIL 200 | 5 | 5 | 5 | 0.3 | | 5 | 5 | 5 | 5 |
| | | Crystalline silica | CRYSTALITE 5X | | | | | 320 | | | | |
| | | Calcined clay | SATINTONE SP-33 | | | | | | | | | |
| | | Talc | MICRO ACE K-1 | | | | | | | | | |
| | | Magnesium hydroxide | MAGSEEDS FK621 | | | | | | | | | |
| | Antioxidant | | IRGANOX 1010 | 0.1 | 0.1 | 0.1 | 0.1 | 0.1 | 0.1 | 0.1 | 0.1 | 0.1 |
| | Silane coupling agent | | KBM-1003 | 6 | 6 | | 6 | 6 | 0.8 | 16 | 6 | 6 |
| | Organic peroxide | | PERHEXA 25B | 0.1 | 0.1 | 0.5 | 0.1 | 0.1 | 0.1 | 0.1 | 0.1 | 0.1 |
| | Total | | | 106.2 | 106.2 | 105.6 | 101.5 | 421.2 | 101 | 116.2 | 106.2 | 106.2 |
| Catalyst | Base | Millable silicone | ELASTSIL | 5 | 5 | | 5 | 5 | 5 | 5 | 5 | 5 |
| MB | Rubber | rubber | R401/70S | | | | | | | | | |
| | | EEA | NUC6510 | | | | | | | | | |

| | | | | | | | | | |
|---|---|---|---|---|---|---|---|---|---|
| Antioxidant | IRGANOX 1010 | 0.1 | 0.1 | 0.1 | 0.1 | 0.1 | 0.1 | 0.1 | 0.1 |
| Silanol condensation catalyst | ADK STAB OT-1 | 0.01 | 0.5 | 0.1 | 0.1 | 0.1 | 0.1 | 0.005 | 0.6 |

| | | | | | | | | | | |
|---|---|---|---|---|---|---|---|---|---|---|
| | Total | 5.11 | 5.6 | | 5.2 | 5.2 | 5.2 | 5.2 | 5.105 | 5.7 |
| Evaluation | Sheet outer appearance test | A | B | A | A | A | D | D | A | D |
| | Tensile strength (MPa) | C | A | D | D | D | D | B | D | A |
| | Hot set test | C | A | D | C | C | D | B | D | A |

The results of Tables A1 to A3 show the following matters.

In Comparative Example A1 employing the chemical crosslinking method, no crosslinking reaction occurs under the press-forming conditions described above, and the hot set test (heat resistance) and the tensile strength are poor. When the chemical crosslinking method is employed, heating at a high temperature for a long time is required to cause a crosslinking reaction. It is found that the manufacturability is poor from the viewpoint of productivity and production cost.

Even when the silane crosslinking method is applied, Comparative Example A2 in which the composition amount (content) of the inorganic filler is too small is inferior in tensile strength. This is considered to be because a crosslinked structure in which an inorganic filler is spirally wound is not formed, and the constructed crosslinked structure becomes sparse. Comparative Example A3 in which the composition amount of the inorganic filler is too large is inferior in tensile strength. This is considered to be because the silane coupling agent was excessively adsorbed to the inorganic filler, and the grafting reaction with respect to the base silicone rubber hardly proceeded. In Comparative Example A4 in which the composition amount of the silane coupling agent is too small, since the silane crosslinked structure itself is not sufficiently constructed, sufficient heat resistance and tensile strength are not exhibited, and the outer appearance is also poor. The reason for the poor outer appearance is considered to be that a crosslinking reaction between the organopolysiloxanes preferentially occurs in the step (a). On the other hand, in Comparative Example A5 in which the composition amount of the silane coupling agent is too large, the volatilization or self-condensation of the silane coupling agent cannot be suppressed, and the formation of foam or gel aggregates occurs during forming, resulting in poor outer appearance. Furthermore, in Comparative Example A6 in which the composition amount of the silanol condensation catalyst is too small, the silanol condensation reaction cannot be accelerated, and the crosslinked structure itself is not sufficiently constructed, and thus the heat resistance and the tensile strength are poor. On the other hand, Comparative Example A6 in which the composition amount of the silanol condensation catalyst is too large is inferior in outer appearance.

On the other hand, it is apparent that in each of Examples A1 to A22 in which a specific amount of a silane coupling agent is used in the coexistence of a specific amount of a silanol condensation catalyst and an inorganic filler with respect to millable silicone rubber, a silane crosslinking reaction can be caused (accelerated) under mild conditions without requiring special crosslinking equipment such as a chemical crosslinking tube or an electron beam crosslinking machine, and a silane crosslinked silicone rubber formed body having outer appearance, heat resistance, and tensile strength can be produced with good manufacturability.

### Examples [B]

Examples [B] are examples and comparative examples relating to a preferred embodiment of the present invention using the silane crosslinkable silicone rubber composition [B] in a preferred embodiment of the present invention.

The compounds used in Examples [B] are shown below.

### <Base Rubber>

(1) Millable silicone rubber: ELASTSIL R401/40S (trade name, compound (agent A) containing methylvinyl silicone rubber and fumed silica, specific gravity 1.12 g/cm³, manufactured by Wacker Asahikasei Silicone Co., Ltd.)
(2) Fluororubber: AFLAS 400E (trade name: tetrafluoroethylene-propylene rubber, manufactured by AGC Inc.)
(3) Ethylene-ethyl acrylate copolymer resin (EEA): NUC6510 (trade name: manufactured by ENEOS NUC Corporation)
(4) Ethylene-vinyl acetate copolymer resin (EVA): VF120T (trade name: manufactured by Ube-Maruzen Polyethylene Co., Ltd.)
(5) Linear low-density polyethylene (LLDPE): EVOLUE SP0510 (trade name: manufactured by Prime Polymer Co., Ltd.)
(6) Polypropylene resin (PP): PB222A (trade name, RANDOM PP, manufactured by SunAllomer Ltd.)

The specific gravity of the millable silicone rubber is a value measured in the same manner as in Examples [A].
SOFTON 1200, AEROSIL 200 and CRYSTALITE 5X used as inorganic fillers in Examples [B] are the same as those in Examples [A].
KBM-1003 used as a silane coupling agent, ADK STAB OT-1 used as a silanol condensation catalyst, and PERHEXA 25B used as an organic peroxide in Examples [B] are the same as those in Examples [A].

In Examples [B], the following antioxidants were used.

### <Antioxidant>

IRGANOX 1010: trade name, hindered phenol-based antioxidant, manufactured by BASF
ADK STAB CDA-10: trade name, hydrazine-based heavy metal inactivator, manufactured by ADEKA Corporation

### Examples B1 to B17 and Comparative Examples B2 to B6

Each of Examples B1 to B17 and Comparative Examples B2 to B6 was carried out using the components shown in Tables B1 to B3.

Note that Example 1 also corresponds to a comparative example of another preferred embodiment ([Examples C]) of the present invention, but is described as an example of Examples B. Further, Comparative Examples B2 and B4 also correspond to the present invention ([Example A]), but are described as comparative examples of Examples B.

In Tables B1 to B3, the numerical values for the composition amount (content) of the respective examples and comparative examples are in terms of part by mass, unless otherwise specified. In addition, in each component column, the blank means that a composition amount of a corresponding component is 0 part by mass.

In each of the examples and comparative examples, a part of the base rubber (specifically, the millable silicone rubber or EEA shown in the “Catalyst MB” column of Tables B1 to B3) was used in the mass ratio shown in the same column as the carrier resin of the catalyst MB.

First, an inorganic filler, a silane coupling agent, and an organic peroxide, in mass ratios shown in the “Silane MB” column in Tables B1 to B3, were placed in a rotary blade mixer (Mazelar PM: trade name, manufactured by Mazelar CO., LTD.), and the resultant mixture was stirred (premixed) at a rotation speed of 10 rpm for 1 minute at room temperature (25° C.) (step (a-1)). Thus, a powder mixture was obtained.

Next, the powder mixture, and a base rubber and an antioxidant shown in the “Silane MB” column in Tables B1 to B3, in mass ratios shown in the same column, were placed in a Banbury mixer (volume: 2 L) heated to 80° C. in advance, the resultant mixture was mixed at a rotation speed of 40 rpm for 5 minutes, and further subjected to finish kneading (melt-mixing) at a rotation speed of 30 rpm for 3 minutes. After confirming that the temperature of the mixture reached 180 to 200° C., i.e. temperatures equal to or higher than a decomposition temperature of the organic peroxide, the melt-mixture was thinly extended to about 3 mm with an 8-inch open roll, and the resultant mixture was pelletized using a square pelletizer to obtain a silane MB (step (a) in conjunction with steps (a-2) and (a-1)).

Since the silanes MB of Example B1, Comparative Example B2, Comparative Example B5, and Comparative Example B6 could not be pelletized, the silanes discharged from the Banbury mixer were used as silanes MB.

On the other hand, a base rubber, a silanol condensation catalyst, and an antioxidant shown in the “Catalyst MB” column in Tables B1 to B3, in mass ratios shown in the same column, were sequentially placed in a Banbury mixer (volume: 2 L) heated to 80° C. in advance, the resultant mixture was mixed at a rotation speed of 40 rpm for 5 minutes, and then subjected to finish kneading (melt-mixing) at a rotation speed of 30 rpm for 3 minutes. After confirming that the temperature of the mixture reached about 160° C. and the carrier rubber was sufficiently melted, the melt-mixture was thinly extended to about 3 mm with an 8-inch open roll and the resultant mixture was pelletized using a square pelletizer to obtain a catalyst MB (step (b)).

Since the catalyst MB of Example B1 could not be pelletized, the catalyst discharged from the Banbury mixer was used as the catalyst MB.

### —Production of Sheet-Shaped Formed Body—

The prepared silane MB and catalyst MB were kneaded at room temperature (25° C.) for 5 minutes using an 8-inch open roll to obtain a silane crosslinkable silicone rubber composition (step (c)). At this time, the mixing ratios of the silane MB and the catalyst MB was set to the mass ratios shown in the “Silane MB” column and the “Catalyst MB” column in Tables B1 to B3.

Then, each of the prepared silane crosslinkable silicone rubber compositions was used, and A4 size (210 mm×297 mm) 2 mm thick sheet-shaped formed bodies were produced as follows. Hence, each of the prepared silane crosslinkable silicone rubber compositions was placed in a non-preheated press machine, and then heating was started. When the temperature of each of the silane crosslinkable silicone rubber compositions reached 120° C., pressing was performed under a pressure of 10 MPa, and this state was maintained for 3 minutes to perform press-forming (step (2B)).

The resulting sheet-shaped formed bodies (thickness: 2 mm) were left to stand still in atmosphere with the temperature of 60° C. and the humidity of 95% RH for 24 hours to bring the silane crosslinkable silicone rubber compositions into contact with water (step (3B)).

In this way, 2 mm thick sheet-shaped formed bodies (corresponding to crosslinked bodies and silane crosslinked silicone rubber formed bodies) were produced.

### —Production of Insulated Wire—

The prepared silane MB and catalyst MB, in the mass ratios shown in the “Silane MB” column and the “Catalyst MB” column in Tables B1 to B3, were placed in a poly bag and dry-blended at room temperature (25° C.) for 3 minutes to obtain a dry-blended product.

The resulting dry-blended product was then introduced into an extruder equipped with a screw of L/D=25, with a screw diameter of 25 mm (temperature at the cylinder portion: 130° C., temperature at the crosshead portion: 180° C.). This extruder is a general-purpose plastic extruder (Model No.: D2-1429, manufactured by OMIYA SEIKI Co., Ltd.). While the dry-blended product was melt-mixed in the extruder (step (c)), the silane crosslinkable silicone rubber composition was extruded and applied to a thickness of 0.8 mm on the outer periphery of a copper conductor having a diameter of 0.8 mm at a linear velocity of 10 m/min to obtain a coated conductor having an outer diameter of 2.4 mm (step (2B)). This coated conductor was left in atmosphere with the temperature of 60° C. and the humidity of 95% for 24 hours, and brought into contact with water (step (3B)).

In this way, each insulated wire having a coating layer composed of the silane crosslinked silicone rubber formed body on the outer periphery of the conductor was produced.

In Example B1, Comparative Example B2, Comparative Example B5, and Comparative Example B6, since the crosslinkable silicone rubber composition could not be extrusion-formed, the insulated wire was not produced.

### Comparative Example B1

Respective components shown in the “Silane MB” column in Table B3 were placed in a Banbury mixer, the resultant mixture was melt-mixed at 60 to 100° C. for 10 minutes, then discharged at a material discharge temperature of 100° C., thinly extended to about 3 mm with an 8-inch open roll, and then attempted to obtain a pellet-shaped crosslinkable silicone rubber composition using a square pelletizer, but the mixture could not be pelletized.

Using the prepared crosslinkable silicone rubber composition, press-forming was performed in the same manner as in Example B1 to produce a sheet-shaped formed body having a thickness of 2 mm.

Since the crosslinkable silicone rubber composition of Comparative Example B1 could not be extrusion-formed, the insulated wire was not produced.

The insulated wires and sheet-shaped formed bodies thus produced were evaluated as follows, and the results were shown in Tables B1 to B3.

The blank in the “Tensile test” column in each table indicates that the tensile test was not performed using the corresponding test piece.

### <Sheet Outer Appearance Test>

The outer appearance of each of the produced sheet-shaped formed bodies was visually confirmed and evaluated according to the following evaluation criteria.

### —Evaluation Criteria—

“A” (good appearance, pass): When a sample body was confirmed to have smooth outer appearance (surface) and have no gel aggregate.
“B” (acceptable outer appearance, pass): When a sample body was confirmed to have 1 to 10 gel aggregates with a thickness of 1 mm or less on its sheet surface, but was acceptable as a product.
“D” (poor outer appearance, fail): When a sample body was confirmed to have significant flow mark, gel aggregates, roughness, and the like on its surface.

### <Hot Set Test>

A No. 3 dumbbell-shaped test piece specified in JIS K 6251 (2017) was punched out from each of the produced sheet-shaped formed bodies. A weight of 205 gf (20 N/cm²) was attached to the lower end of the dumbbell test piece, and the resultant test piece was hung vertically and left in a temperature environment of any one of 150° C., 200° C., and 250° C. for 15 minutes.

After a lapse of 15 minutes, the gauge distance of each test piece with the weight attached was measured. At this time, when the portion between the gauge marks of the test piece was not cut, and the gauge distance of the test piece was within 175% of the gauge distance before the test (before the application of the load: initial gage length) (the gauge distance was extended 2.75 times or less), it was defined as pass. The results of the hot set test were applied to the following evaluation criteria and evaluated.

This test is a test for evaluating the heat resistance of test pieces, and is also a test for evaluating the crosslinked state of test pieces. The higher the evaluation criteria in this test are, the more sufficient the crosslinked structure is constructed in the test pieces. This means that the test pieces show characteristics of exhibiting high heat resistance and not melting even at high temperature.

### —Evaluation Criteria—

“A” (excellent, pass): A sample body passed at a temperature of 250° C.
“B” (good, pass): Although a sample body failed at a temperature of 250° C., the sample body passed at a temperature of 200° C.
“C” (acceptable, pass): Although a sample body failed at a temperature of 200° C., the sample body passed at a temperature of 150° C.
“D” (fail): A sample body did not pass at any temperature.

### <Tensile Test>

The conductor was pulled out from each of the produced insulated wires to produce a tubular test piece made of the silane crosslinked silicone rubber formed body.

On the other hand, in Example B1, Comparative Example B1, Comparative Example B2, Comparative Example B5, Comparative Example B6, and Example B2 in which the insulated wire could not be produced, a No. 3 dumbbell-shaped test piece defined in JIS K 6251 (2017) was punched out from each of the produced sheet-shaped formed bodies to prepare dumbbell test pieces.

Using each of the prepared test pieces, a tensile test was conducted under the conditions of a gauge length of 20 mm and a speed of 200 mm/min in accordance with JIS C 3005, and the strength (MPa) at break and the elongation (%) at break were measured.

The measured strength at break (tensile strength) and elongation at break (breaking elongation) were evaluated according to the following evaluation criteria.

In this test, the breaking elongation is a reference test.

### —Evaluation Criteria for Tensile Strength—

“A” (excellent, pass): A test piece has a tensile strength of 12 MPa or more.
“B” (good, pass): A test piece has a tensile strength of 8 MPa or more and less than 12 MPa.
“C” (acceptable, pass): A test piece has a tensile strength of 4.5 MPa or more and less than 8 MPa.
“D” (fail): A test piece has a tensile strength of less than 4.5 MPa.

### —Evaluation Criteria for Breaking Elongation—

“A” (excellent, pass): A test piece has a breaking elongation of 400% or more.
“B” (good, pass): A test piece has a breaking elongation of 250% or more and less than 400%.
“C” (acceptable, pass): A test piece has a breaking elongation of 150% or more and less than 250%.
“D” (fail): A test piece has a breaking elongation of less than 150%.

### <Heat Aging Test>

An aging process was performed by holding the tubular test piece or each of the dumbbell test pieces prepared in <Tensile Test> described above at a temperature of 200° C. for 168 hours.

For each of the test pieces after the aging process, the breaking elongation was measured under the same conditions as in <Tensile Test>.

The breaking elongation after the aging process was divided by the breaking elongation before the aging process (breaking elongation obtained in <Tensile Test> above), and the residual ratio (%) of the breaking elongation was calculated.

The residual ratio of the resulting breaking elongation was evaluated according to the following evaluation criteria.

This test is a test for evaluating the heat resistance of test pieces.

### —Evaluation Criteria—

“A” (excellent, pass): A test piece has a residual ratio of 80% or more.
“B” (good, pass): A test piece has a residual ratio of 65% or more and less than 80%.
“C” (pass): A test piece has a residual ratio of 50% or more and less than 65%.
“D” (fail): A test piece has a residual ratio of less than 50%.

### <Formability Test: Reference Test>

In this test, in each of the examples and the comparative examples, whether or not the silane MB and the catalyst MB could be prepared as pellets that would be difficult to fuse (pellet preparation suitability), and whether or not the insulated wire could be produced by extrusion forming using these pellets, were evaluated.

Specifically, each of the pellets of the silane MB and the pellets of the catalyst MB prepared in each of the examples and comparative examples was held at a temperature of 40° C. for 24 hours. The state of each of the pellets after holding for 24 hours was visually confirmed, and whether or not extrusion forming using the pellets was possible was evaluated according to the following evaluation criteria. When the evaluation of the pellet preparation suitability was different between the silane MB and the catalyst MB, the inferior evaluation was employed.

### —Evaluation Criteria—

“A” (excellent, pass): When pellets were not fused (blocked) with each other, and there was no problem in extrusion forming (extrusion forming was possible).
“D” (fail): When pellets could not be pelletized and could not be extrusion-formed.

### <Extrusion Outer Appearance Test: Reference Test>

The outer appearance of each of the produced insulated wires was visually confirmed and evaluated according to the following evaluation criteria.

Note that one that failed in the formability test (Example B1, Comparative Example B1, Comparative Example B2, Comparative Example B5, and Comparative Example B6) could not be extrusion-formed, and thus the result of the extrusion outer appearance test was evaluated as “D”.

### —Evaluation Criteria—

“A” (high outer appearance, pass): When an insulated wire sample was confirmed to have a clean surface and have no gel aggregate.
“B” (acceptable outer appearance, pass): When an insulated wire sample was confirmed to have 1 to 5 gel aggregates on average per 1 m on its surface, but had no problem in terms of outer appearance as an insulated wire.
“D” (poor outer appearance, fail): When an insulated wire sample was confirmed to have a large amount of gel aggregates or roughness on its surface, and the outer appearance as an insulated wire was poor.

TABLE B1

| | | | | Example B | | | | | | | |
|---|---|---|---|---|---|---|---|---|---|---|---|
| | | | | 1 | 2 | 3 | 4 | 5 | 6 | 7 | 8 |
| Silane | Base | Millable silicone | ELASTSIL R401/40S | 75 | 55 | 55 | 45 | 35 | 55 | 45 | 45 |
| MB | Rubber | rubber | | | | | | | | | |
| | | Fluororubber | AFLAS 400E | 20 | 20 | 20 | 20 | 30 | 10 | 20 | 20 |
| | | EEA | NUC6510 | | 20 | | 20 | 20 | 20 | 20 | 10 |
| | | EVA | VF120T | | | 20 | | | | | |
| | | LLDPE | EVOLUE SP0510 | | | | 10 | 10 | 10 | | 10 |
| | | PP | PB222A | | | | | | | 10 | 10 |
| | Inorganic | Calcium carbonate | SOFTON 1200 | | | | | | | | |
| | filler | Dry silica | AEROSIL 200 | 5 | 5 | 5 | 5 | 5 | 5 | 5 | 5 |
| | | Crystalline silica | CRYSTALITE 5X | | | | | | | | |
| | Antioxidant | | IRGANOX 1010 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 6 | 6 | 6 |
| | Organic peroxide | | PERHEXA 25B | 0.1 | 0.1 | 0.1 | 0.1 | 0.1 | 0.1 | 0.1 | 0.1 |
| | Total | | | 106.2 | 106.2 | 106.2 | 106.2 | 106.2 | 106.2 | 106.2 | 106.2 |
| Catalyst | Base | Millable silicone | ELASTSIL R401/70S | 5 | | | | | | | |
| MB | Rubber | rubber | | | | | | | | | |
| | | EEA | NUC6510 | | 5 | 5 | 5 | 5 | 5 | 5 | 5 |

| | Antioxidant | IRGANOX 1010 | 1 | 1 | 1 | 1 | 1 | 1 | 1 | 1 |
|---|---|---|---|---|---|---|---|---|---|---|
| | | ADK STAB CDA-10 | 1 | 1 | 1 | 1 | 1 | 1 | 1 | 1 |
| | Silanol condensation catalyst | ADK STAB OT-1 | 0.1 | 0.1 | 0.1 | 0.1 | 0.1 | 0.1 | 0.1 | 0.1 |
| | Total | | 7.1 | 7.1 | 7.1 | 7.1 | 7.1 | 7.1 | 7.1 | 7.1 |
| Evaluation | Sheet outer appearance test | | A | A | A | A | A | A | A | A |
| | Hot set test | | A | B | B | B | B | B | B | B |
| | Tensile test (tubular piece) | Tensile strength | | A | B | A | A | B | A | A |
| | | (MPa) | | | | | | | | |
| | | Breaking elongation | | A | A | A | A | A | A | A |
| | | (%) | | | | | | | | |
| | Tensile test (dumbbell piece) | Tensile strength | C | B | | | | | | |

| | | |
|---|---|---|
| (MPa) | | |
| Breaking elongation | A | A |
| (%) | | |

| | | | | | | | | |
|---|---|---|---|---|---|---|---|---|
| Heat aging test | A | A | B | B | A | C | C | B |
| Formability test (Reference test) | D | A | A | A | A | A | A | A |
| Extrusion outer appearance test (Reference test) | D | A | A | A | A | A | A | A |

TABLE B2

| | | | | Example B | | | | | | | | |
|---|---|---|---|---|---|---|---|---|---|---|---|---|
| | | | | 9 | 10 | 11 | 12 | 13 | 14 | 15 | 16 | 17 |
| Silane | Base | Millable silicone | ELASTSIL R401/40S | 45 | 45 | 45 | 45 | 45 | 45 | 45 | 45 | 45 |
| MB | Rubber | rubber | | | | | | | | | | |
| | | Fluororubber | AFLAS 400E | 20 | 20 | 20 | 20 | 20 | 20 | 20 | 20 | 20 |
| | | EEA | NUC6510 | 20 | 20 | 10 | 10 | 10 | 20 | 20 | 10 | 10 |
| | | EVA | VF120T | | | | | | | | | |
| | | LLDPE | EVOLUE SP0510 | 10 | 10 | 10 | 10 | 10 | 10 | 10 | 10 | 10 |
| | | PP | PB222A | | | 10 | 10 | 10 | | | 10 | 10 |
| | Inorganic | Calcium carbonate | SOFTON 1200 | 30 | | | | | | | | |
| | filler | Dry silica | AEROSIL 200 | | | 0.5 | | | 5 | 5 | 5 | 5 |
| | | Crystalline silica | CRYSTALITE 5X | | 30 | | 50 | 100 | | | | |
| | Antioxidant | | IRGANOX 1010 | 0.1 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 1.5 | 15 | 6 | 6 |
| | Organic peroxide | | PERHEXA 25B | 0.1 | 0.1 | 0.1 | 0.1 | 0.1 | 0.1 | 0.1 | 0.1 | 0.1 |
| | Total | | | 131.2 | 131.2 | 101.7 | 151.2 | 201.2 | 101.7 | 115.2 | 106.2 | 106.2 |
| Catalyst | Base | Millable silicone | ELASTSIL R401/70S | | | | | | | | | |
| MB | Rubber | rubber | | | | | | | | | | |
| | | EEA | NUC6510 | 5 | 5 | 5 | 5 | 5 | 5 | 5 | 5 | 5 |

| | Antioxidant | IRGANOX 1010 | 1 | 1 | 1 | 1 | 1 | 1 | 1 | 1 | 1 |
|---|---|---|---|---|---|---|---|---|---|---|---|
| | | ADK STAB CDA-10 | 1 | 1 | 1 | 1 | 1 | 1 | 1 | 1 | 1 |
| | Silanol condensation catalyst | ADK STAB OT-1 | 0.1 | 0.1 | 0.1 | 0.1 | 0.1 | 0.1 | 0.1 | 0.01 | 0.5 |
| | Total | | 7.1 | 7.1 | 7.1 | 7.1 | 7.1 | 7.1 | 7.1 | 7.01 | 7.5 |
| Evaluation | Sheet outer appearance test | | A | A | A | A | A | A | B | A | A |
| | Hot set test | | B | B | C | B | C | C | B | C | A |
| | Tensile test (tubular piece) | Tensile strength | B | A | C | B | C | B | B | C | B |
| | | (MPa) | | | | | | | | | |
| | | Breaking elongation | A | A | A | B | C | A | B | A | C |
| | | (%) | | | | | | | | | |
| | Tensile test (dumbbell piece) | Tensile strength | | | | | | | | | |

(MPa)
Breaking elongation
(%)

| | | | | | | | | | |
|---|---|---|---|---|---|---|---|---|---|
| Heat aging test | B | B | B | C | C | C | B | C | A |
| Formability test (Reference test) | A | A | A | A | A | A | A | A | A |
| Extrusion outer appearance test (Reference test) | A | A | B | A | A | A | B | A | B |

TABLE B3

| | | | | Comparative Example B | | | | | |
|---|---|---|---|---|---|---|---|---|---|
| | | | | 1 | 2 | 3 | 4 | 5 | 6 |
| Silane | Base | Millable silicone | ELASTSIL R401/40S | 80 | 95 | 55 | 55 | 75 | 75 |
| MB | Rubber | rubber | | | | | | | |
| | | Fluororubber | AFLAS 400E | 20 | | 20 | 20 | 20 | 20 |
| | | EEA | NUC6510 | | | | | | |
| | | EVA | VF120T | | | | | | |
| | | LLDPE | EVOLUE SP0510 | | | 20 | 20 | | |
| | | PP | PB222A | | | | | | |
| | Inorganic | Calcium carbonate | SOFTON 1200 | | | | | | |
| | filler | Dry silica | AEROSIL 200 | 5 | 5 | 0.1 | | 5 | 5 |
| | | Crystalline silica | CRYSTALITE 5X | | | | 120 | | |
| | Antioxidant | | IRGANOX 1010 | 0.1 | 0.1 | 0.1 | 0.1 | 0.1 | 0.1 |
| | Silane coupling agent | | KBM-1003 | | 6 | 6 | 6 | 6 | 6 |
| | Organic peroxide | | PERHEXA 25B | 0.5 | 0.1 | 0.1 | 0.1 | 0.1 | 0.1 |
| | Total | | | 105.6 | 106.2 | 101.3 | 221.2 | 106.2 | 106.2 |
| Catalyst | Base | Millable silicone | ELASTSIL R401/70S | | | | | | |
| MB | Rubber | rubber | | | | | | | |
| | | EEA | NUC6510 | | 5 | 5 | 5 | 5 | 5 |

| | Antioxidant | IRGANOX 1010 | | 1 | 1 | 1 | 1 | 1 |
|---|---|---|---|---|---|---|---|---|
| | | ADK STAB CDA-10 | | 1 | 1 | 1 | 1 | 1 |
| | Silanol condensation catalyst | ADK STAB OT-1 | | 0.1 | 0.1 | 0.1 | 0.005 | 0.6 |
| | Total | | | 7.1 | 7.1 | 7.1 | 7.005 | 7.6 |
| Evaluation | Sheet outer appearance test | | A | A | A | A | A | D |
| | Hot set test | | D | A | D | | D | A |
| | Tensile test (tubular piece) | Tensile strength | | | D | C | | |
| | | (MPa) | | | | | | |
| | | Breaking elongation | | | A | C | | |
| | | (%) | | | | | | |
| | Tensile test (dumbbell piece) | Tensile strength | D | D | | | D | C |

| | | | | |
|---|---|---|---|---|
| (MPa) | | | | |
| Breaking elongation | D | A | C | D |

| | | | | | | |
|---|---|---|---|---|---|---|
| Heat aging test | D | B | C | D | D | A |
| Formability test (Reference test) | D | D | A | A | D | D |
| Extrusion outer appearance test (Reference test) | D | D | D | B | D | D |

The results of Tables B1 to B3 show the following matters.

In Comparative Example B1 employing the chemical crosslinking method, no crosslinking reaction occurs under the press-forming conditions, and heat resistance (hot set test and heat aging test) and mechanical characteristics (tensile test) are poor. When the chemical crosslinking method is employed, heating at a high temperature for a long time is required to cause a crosslinking reaction. It is found that the manufacturability is poor from the viewpoint of productivity and production cost.

Even when the silane crosslinking method is applied, Comparative Example B2 containing the millable silicone rubber and the ethylene copolymer resin as the base rubber but not containing the fluororubber is inferior in strength.

In Comparative Examples B3 and B4 in which the content of the inorganic filler is not within the range specified in the present invention, both heat resistance and tensile strength cannot be achieved at a high level. That is, Comparative Example B3 in which the content is too small is inferior in heat resistance (hot set test) and tensile strength, and Comparative Example 4 in which the content is too large is inferior in heat resistance (heat aging test).

Furthermore, in Comparative Example B5 in which the composition amount of the silanol condensation catalyst is too small, the silanol condensation reaction cannot be accelerated, and the crosslinked structure itself is not sufficiently constructed, and thus the heat resistance and the tensile strength are poor. On the other hand, Comparative Example B6 in which the composition amount of the silanol condensation catalyst is too large is inferior in outer appearance and breaking elongation.

Note that since Comparative Examples B2 and B4 also correspond to the present invention ([Example A]), the action and effect of Example A are satisfied.

On the other hand, in each of Examples B1 to B17 in which a fluororubber is used in combination with a millable silicone rubber, and a specific amount of a silane coupling agent is used in the coexistence of a specific amount of a silanol condensation catalyst and an inorganic filler, a silane crosslinking reaction can be caused (accelerated) under mild conditions without requiring special crosslinking equipment such as a chemical crosslinking tube or an electron beam crosslinking machine, and a formed body excellent in outer appearance can be produced. In addition, the formed body exhibits remarkably high heat resistance and excellent tensile strength such that the residual ratio of breaking elongation is 50% or more even when the formed body is held at 200° C. for 168 hours. That is, it is apparent that the silane crosslinkable silicone rubber composition [B] according to a preferred embodiment of the present invention can produce the silane crosslinked silicone rubber formed body [B] having excellent outer appearance and showing high heat resistance and strength with excellent manufacturability.

When the ethylene copolymer resin is used in combination with the millable silicone rubber and the fluororubber, the silane crosslinked silicone rubber formed body [B] having excellent outer appearance, high heat resistance and strength can be extrusion-formed even with a general-purpose extruder.

### Examples [C]

Examples [C] are examples and comparative examples relating to another preferred embodiment of the present invention using the silane crosslinkable silicone rubber composition [C] in another preferred embodiment of the present invention.

The compounds used in Examples [C] are shown below.

Each rubber used as the base rubber in Examples [C] is the same as that in Examples [B], and the specific gravity of the millable silicone rubber is a value measured in the same manner as in Examples [A].

SOFTON 1200, AEROSIL 200 and CRYSTALITE 5X used as inorganic fillers in Examples [C] are the same as those in Examples [A].

KBM-1003 used as a silane coupling agent, ADK STAB OT-1 used as a silanol condensation catalyst, and PERHEXA 25B used as an organic peroxide in Examples [C] are the same as those in Examples [A].

In Examples [C], the following antioxidants were used.

### <Antioxidant>

(1) Hindered phenol-based antioxidant: IRGANOX 1010 (trade name: manufactured by BASF)
(2) Hydrazine-based metal inactivator: ADK STAB CDA-10 (trade name, manufactured by ADEKA Corporation)
(3) Benzimidazole-based antioxidant: NOCRAC MBZ (trade name: manufactured by OUCHI SHINKO CHEMICAL INDUSTRIAL CO., LTD.)
(4) Hindered amine-based antioxidant: ADK STAB LA-52 (trade name, manufactured by ADEKA Corporation)

### Examples C1 to C21 and Comparative Examples C2 to C7

Each of Examples C1 to C21 and Comparative Examples C2 to C7 were carried out using the components shown in Tables C1 to C3.

Note that Example 1 also corresponds to a comparative example of a preferred embodiment ([Examples B]) of the present invention, but is described as an example of Examples C. Further, Comparative Examples C2 to C5 correspond to the present invention ([Examples A]) and a preferred embodiment of the present invention ([Examples B]), but are described as comparative examples of Examples C.

In Tables C1 to C3, the numerical values for the composition amount (content) of the respective examples and comparative examples are in terms of part by mass, unless otherwise specified. In addition, in each component column, the blank means that a composition amount of a corresponding component is 0 part by mass.

In each of the examples and comparative examples, a part of the base rubber (specifically, the EEA shown in the “Catalyst MB” column in Tables C1 to C3) was used in the mass ratio shown in the same column as the carrier resin of the catalyst MB.

First, an inorganic filler, a silane coupling agent, and an organic peroxide, in mass ratios shown in the “Silane MB” column in Tables C1 to C3, were placed in a rotary blade mixer (Mazelar PM: trade name, manufactured by Mazelar CO., LTD.), and the resultant mixture was stirred (premixed) at a rotation speed of 10 rpm for 1 minute at room temperature (25° C.) (step (a-1)). Thus, a powder mixture was obtained.

Next, the powder mixture, and a base rubber and an antioxidant shown in the “Silane MB” column in Tables C1 to C3, in mass ratios shown in the same column, were placed in a Banbury mixer (volume: 2 L) heated to 80° C. in advance, the resultant mixture was mixed at a rotation speed of 40 rpm for 5 minutes, and further subjected to finish kneading (melt-mixing) at a rotation speed of 30 rpm for 3 minutes. After confirming that the temperature of the mixture reached 180 to 200° C., i.e. temperatures equal to or higher than a decomposition temperature of the organic peroxide, the melt-mixture was thinly extended to about 3 mm with an 8-inch open roll, and the resultant mixture was pelletized using a square pelletizer to obtain a silane MB (step (a) in conjunction with steps (a-2) and (a-1)).

On the other hand, a base rubber, a silanol condensation catalyst, and an antioxidant shown in the “Catalyst MB” column in Tables C1 to C3, in mass ratios shown in the same column, were sequentially placed in a Banbury mixer (volume: 2 L) heated to 80° C. in advance, the resultant mixture was mixed at a rotation speed of 40 rpm for 5 minutes, and then subjected to finish kneading (melt-mixing) at a rotation speed of 30 rpm for 3 minutes. After confirming that the temperature of the mixture reached about 160° C. and the carrier rubber was sufficiently melted, the melt-mixture was thinly extended to about 3 mm with an 8-inch open roll and the resultant mixture was pelletized using a square pelletizer to obtain a catalyst MB (step (b)).

Then, the silane MB and the catalyst MB, in the mass ratios shown in the “Silane MB” column and the “Catalyst MB” column in Tables C1 to C3, were placed in a poly bag and dry-blended at room temperature (25° C.) for 3 minutes to obtain a dry-blended product.

The resulting dry-blended product was then introduced into an extruder equipped with a screw of L/D=25, with a screw diameter of 25 mm (temperature at the cylinder portion: 130° C., temperature at the crosshead portion: 180° C.). This extruder is a general-purpose plastic extruder (Model No.: D2-1429, manufactured by OMIYA SEIKI Co., Ltd.). While the dry-blended product was melt-mixed in the extruder (step (c)), the silane crosslinkable silicone rubber composition was extruded and applied to a thickness of 0.8 mm on the outer periphery of a copper conductor having a diameter of 0.8 mm at a linear velocity of 10 m/min to obtain a coated conductor having an outer diameter of 2.4 mm (step (2C)). This coated conductor was left in atmosphere with the temperature of 60° C. and the humidity of 95% for 24 hours, and brought into contact with water (step (3C)).

In this way, each insulated wire having a coating layer composed of the silane crosslinked silicone rubber formed body on the outer periphery of the conductor was produced.

### Comparative Example C1

The components shown in the “Silane MB” column in Table C3 were placed in a Banbury mixer, the resultant mixture was melt-mixed at 60 to 100° C. for 10 minutes, then discharged at a material discharge temperature of 100° C., thinly extended to about 3 mm with an 8-inch open roll, and then attempted to obtain a masterbatch A in the form of a pellet using a square pelletizer, but the mixture could not be pelletized.

Similarly, the components shown in the “Catalyst MB” column in Table C3 was melt-mixed to obtain a masterbatch B in the form of a pellet.

The crosslinkable silicone rubber composition prepared by mixing these masterbatches A and B with the 8-inch open roll could not be extrusion-formed.

The produced insulated wire and the like were evaluated as follows, and the results were shown in Tables C1 to C3.

### <Formability Test>

In this test, in each of the examples and the comparative examples, whether or not the silane MB and the catalyst MB could be prepared as pellets that would be difficult to fuse (pellet preparation suitability), and whether or not the insulated wire could be produced by extrusion forming using these pellets, were evaluated.

Specifically, each of the pellets of the silane MB and the pellets of the catalyst MB was held at a temperature of 40° C. or 25° C. (room temperature) for 24 hours. The state of each of the pellets after holding for 24 hours was visually confirmed, and whether or not extrusion forming using the pellets was possible was evaluated according to the following evaluation criteria. When the evaluation of the pellet preparation suitability was different between the silane MB and the catalyst MB, the inferior evaluation was employed.

### —Evaluation Criteria—

“A” (excellent, pass): When pellets were not fused (blocked) with each other in both holding at 40° C. and holding at 25° C., and there was no problem in extrusion forming (extrusion forming was possible).
“B” (good, pass): When pellets were fused with each other and the extrusion forming was hindered in the holding at 40° C., but the pellets were not fused with each other and the extrusion forming was not hindered in the holding at 25° C.
“D” (fail): When pellets could not be pelletized, or the pellets of the masterbatch B were fused with each other and could not be extrusion-formed.

### <Extrusion Outer Appearance Test>

The outer appearance of each of the produced insulated wires was visually confirmed and evaluated according to the following evaluation criteria.

Note that one that failed in the formability test could not be extrusion-formed, and thus the result of the extrusion outer appearance test was evaluated as “D”.

### —Evaluation Criteria—

“A” (high outer appearance, pass): When an insulated wire sample was confirmed to have a clean surface and have no gel aggregate.
“B” (acceptable outer appearance, pass): When an insulated wire sample was confirmed to have 1 to 5 gel aggregates on average per 1 m on its surface, but had no problem in terms of outer appearance as an insulated wire.
“D” (poor outer appearance, fail): When an insulated wire sample was confirmed to have a large amount of gel aggregates or roughness on its surface, and the outer appearance as an insulated wire was poor.

### <Hot Set Test>

### (Preparation of Test Piece)

The conductor was pulled out from each of the produced insulated wires to produce a tubular test piece made of the silane crosslinked silicone rubber formed body.

On the other hand, in Comparative Example C1 in which the insulated wire was unable to be produced, a sheet-shaped formed body was formed as follows to obtain a dumbbell test piece. Specifically, the crosslinkable silicone rubber composition (a mixture of masterbatches A and B by an open roll) was placed in a non-preheated press machine, and then heating was started. When the temperature of the composition reached 120° C., a pressure of 10 MPa was applied to press the composition, and this state was maintained for 3 minutes to perform press-forming. A No. 3 dumbbell-shaped test piece specified in JIS K 6251 (2017) was punched out from the prepared sheet-shaped formed body (thickness: 2 mm) to prepare a dumbbell test piece.

### [Test]

A weight of 83 gf (20 N/cm²) was attached to the lower end of the tubular test piece, and a weight of 205 gf (20 N/cm²) was attached to the lower end of the dumbbell test piece, and the test pieces were hung vertically, and left in a temperature environment of any one of 150° C., 200° C., and 250° C. for 15 minutes.

After a lapse of 15 minutes, the gauge distance of each test piece with the weight attached was measured. At this time, when the portion between the gauge marks of the test piece was not cut, and the gauge distance of the test piece was within 175% of the gauge distance before the test (before the application of the load: initial gage length) (the gauge distance was extended 2.75 times or less), it was defined as pass. The results of the hot set test were applied to the following evaluation criteria and evaluated.

This test is a test for evaluating the heat resistance of test pieces, and is also a test for evaluating the crosslinked state of test pieces. The higher the evaluation criteria in this test are, the more sufficient the crosslinked structure is constructed in the test pieces. This means that the test pieces show characteristics of exhibiting high heat resistance and not melting even at high temperature.

### —Evaluation Criteria—

“A” (excellent, pass): A sample body passed at a temperature of 250° C.
“B” (good, pass): Although a sample body failed at a temperature of 250° C., the sample body passed at a temperature of 200° C.
“C” (acceptable, pass): Although a sample body failed at a temperature of 200° C., the sample body passed at a temperature of 150° C.
“D” (fail): A sample body did not pass at any temperature.

### <Tensile Test>

A tubular test piece was prepared in the same manner as in the <Hot set test> (Preparation of test piece), and the dumbbell test piece was prepared for Comparative Example C1.

Using each of the prepared test pieces, a tensile test was conducted under the conditions of a gauge length of 20 mm and a speed of 200 mm/min in accordance with JIS C 3005, and the strength (MPa) at break and the elongation (%) at break were measured.

The measured strength at break (tensile strength) and elongation at break (breaking elongation) were evaluated according to the following evaluation criteria.

In this test, the breaking elongation is a reference test.

### —Evaluation Criteria for Tensile Strength—

“A” (excellent, pass): A test piece has a tensile strength of 12 MPa or more.
“B” (good, pass): A test piece has a tensile strength of 10 MPa or more and less than 12 MPa.
“C” (acceptable, pass): A test piece has a tensile strength of 7 MPa or more and less than 10 MPa.
“D” (fail): A test piece has a tensile strength of less than 7 MPa.

### —Evaluation Criteria for Breaking Elongation—

“A” (excellent, pass): A test piece has a breaking elongation of 400% or more.
“B” (good, pass): A test piece has a breaking elongation of 250% or more and less than 400%.
“C” (acceptable, pass): A test piece has a breaking elongation of 150% or more and less than 250%.
“D” (fail): A test piece has a breaking elongation of less than 150%.

### <Heat Aging Test 1>

A tubular test piece was prepared in the same manner as in the <Hot set test> (Preparation of test piece), and the dumbbell test piece was prepared for Comparative Example C1.

An aging process was performed by holding each of the prepared test pieces at a temperature of 200° C. for 240 hours.

For each of the test pieces after the aging process, the breaking elongation was measured under the same conditions as in <Tensile test>.

The breaking elongation after the aging process was divided by the breaking elongation before the aging process (breaking elongation obtained in <Tensile test> above), and the residual ratio (%) of the breaking elongation was calculated.

The residual ratio of the resulting breaking elongation was evaluated according to the following evaluation criteria.

This test is a test for evaluating the heat resistance of test pieces.

### —Evaluation Criteria—

“A” (excellent, pass): A test piece has a residual ratio of 80% or more.
“B” (good, pass): A test piece has a residual ratio of 65% or more and less than 80%.
“C” (pass): A test piece has a residual ratio of 50% or more and less than 65%.
“D” (fail): A test piece has a residual ratio of less than 50%.

### <Heat Aging Test 2: Reference Test>

The heat resistance of each of the test pieces was evaluated in the same manner as in the <Heat aging test 1> except that the holding time in the <Heat aging test 1> was changed to 336 hours.

TABLE C1

| | | | | Example C | | | | | | | | | |
|---|---|---|---|---|---|---|---|---|---|---|---|---|---|
| | | | | 1 | 2 | 3 | 4 | 5 | 6 | 7 | 8 | 9 | 10 |
| Silane | Base | ELASTSIL R401/40S | Specific gravity 1.12 | 70 | 55 | 55 | 55 | 55 | 55 | 55 | 55 | 55 | 45 |
| MB | Rubber | AFLAS 400E | Fluororubber | | 20 | 20 | 20 | 20 | 20 | 20 | 20 | 20 | 30 |
| | | NUC6510 | EEA | 20 | 15 | 15 | 5 | 5 | | | | 7.5 | 7.5 |
| | | VF120T | EVA | | | | | | 15 | | | | |
| | | EVOLUE SP0510 | LLDPE | | | | | | | 15 | | 7.5 | 7.5 |
| | | PB222A | PP | | | | | | | | 15 | | |
| | Inorganic | SOFTON 1200 | Calcium carbonate | | | | | | | | | | |
| | filler | AEROSIL 200 | Dry silica | 5 | 5 | 5 | 5 | 5 | 5 | 5 | 5 | 5 | 5 |
| | | CRYSTALITE 5X | Crystalline silica | | | | | | | | | | |
| | Antioxidant | | IRGANOX 1010 | 0.1 | 0.1 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 6 | 6 | 6 | 6 | 6 |
| | Organic peroxide | | PERHEXA 25B | 0.1 | 0.1 | 0.1 | 0.1 | 0.1 | 0.1 | 0.1 | 0.1 | 0.1 | 0.1 |
| | Total | | | 101.2 | 101.2 | 101.2 | 91.2 | 91.2 | 101.2 | 101.2 | 101.2 | 101.2 | 101.2 |
| Catalyst | Base rubber | NUC6510 | EEA | 10 | 10 | 10 | 20 | 20 | 10 | 10 | 10 | 10 | 10 |
| MB | Antioxidant | Hindered phenol-based | IRGANOX 1010 | 2 | 2 | 2 | 8 | 0.2 | 2 | 2 | 2 | 2 | 2 |
| | | Hydrazine-based | ADK STAB CDA-10 | 2 | 2 | 2 | 5 | 0.5 | 2 | 2 | 2 | 2 | 2 |
| | | Benzimidazole-based | NOCRAC MBZ | 4 | 4 | 8 | 15 | 1.5 | 8 | 8 | 8 | 8 | 8 |
| | | Hindered amine-based | ADK STAB LA-52 | | | | | | | | | | |

| | Silanol condensation catalyst | ADK STAB OT-1 | 0.1 | 0.1 | 0.1 | 0.1 | 0.1 | 0.1 | 0.1 | 0.1 | 0.1 | 0.1 |
|---|---|---|---|---|---|---|---|---|---|---|---|---|
| | Total | | 18.1 | 18.1 | 22.1 | 48.1 | 22.3 | 22.1 | 22.1 | 22.1 | 22.1 | 22.1 |
| Evaluation | Formability test | | A | A | A | B | B | A | A | A | A | A |
| | Extrusion outer appearance test | | A | A | A | B | A | A | A | A | A | A |
| | Hot set test | | B | B | B | C | B | A | B | C | B | B |
| | Tensile test | Tensile strength | B | A | A | C | A | B | A | A | A | A |

| | | | | | | | | | | |
|---|---|---|---|---|---|---|---|---|---|---|
| (MPa) | | | | | | | | | | |
| Breaking elongation | A | A | A | C | A | A | A | A | A | A |
| (%) | | | | | | | | | | |

| | | | | | | | | | | |
|---|---|---|---|---|---|---|---|---|---|---|
| Heat aging test 1 | B | A | A | B | C | B | B | C | B | A |
| Heat aging test 2 | C | B | A | C | D | C | C | C | B | B |

TABLE C2

| | | | | Example C | | | | | | | | | |
|---|---|---|---|---|---|---|---|---|---|---|---|---|---|
| | | | | 11 | 12 | 13 | 14 | 15 | 16 | 17 | 18 | 19 | 20 |
| Silane | Base | ELASTSIL R401/40S | Specific gravity 1.12 | 65 | 50 | 55 | 55 | 55 | 55 | 55 | 55 | 55 | 55 |
| MB | Rubber | AFLAS 400E | Fluororubber | 10 | 20 | 20 | 20 | 20 | 20 | 20 | 20 | 20 | 20 |
| | | NUC6510 | EEA | 7.5 | 7.5 | 7.5 | 7.5 | 7.5 | 7.5 | 7.5 | 7.5 | 7.5 | 7.5 |
| | | VF120T | EVA | | | | | | | | | | |
| | | EVOLUE SP0510 | LLDPE | 7.5 | 7.5 | 7.5 | 7.5 | 7.5 | 7.5 | 7.5 | 7.5 | 7.5 | 7.5 |
| | | PB222A | PP | | 5 | | | | | | | | |
| | Inorganic | SOFTON 1200 | Calcium carbonate | | | 30 | | | | | | | |
| | filler | AEROSIL 200 | Dry silica | 5 | 5 | | | 0.5 | | | 5 | 5 | 5 |
| | | CRYSTALITE 5X | Crystalline silica | | | | 30 | | 50 | 100 | | | |
| | Antioxidant | | IRGANOX 1010 | 0.1 | 0.1 | 0.1 | 0.1 | 0.1 | 0.1 | 0.1 | 0.1 | 0.1 | 0.1 |
| | Silane coupling agent | | KBM-1003 | 6 | 6 | 6 | 6 | 6 | 6 | 6 | 1.5 | 15 | 6 |
| | Organic peroxide | | PERHEXA 25B | 0.1 | 0.1 | 0.1 | 0.1 | 0.1 | 0.1 | 0.1 | 0.1 | 0.1 | 0.1 |
| | Total | | | 101.2 | 101.2 | 126.2 | 126.2 | 96.7 | 146.2 | 196.2 | 146.2 | 196.2 | 101.2 |
| Catalyst | Base rubber | NUC6510 | EEA | 10 | 10 | 10 | 10 | 10 | 10 | 10 | 10 | 10 | 10 |
| MB | Antioxidant | Hindered phenol-based | IRGANOX 1010 | 2 | 2 | 2 | 2 | 2 | 2 | 2 | 2 | 2 | 2 |
| | | Hydrazine-based | ADK STAB CDA-10 | 2 | 2 | 2 | 2 | 2 | 2 | 2 | 2 | 2 | 2 |
| | | Benzimidazole-based | NOCRAC MBZ | 8 | 8 | 8 | 8 | 8 | 8 | 8 | 8 | 8 | 8 |
| | | Hindered amine-based | ADK STAB LA-52 | | | | | | | | | | |

| | Silanol condensation catalyst | ADK STAB OT-1 | 0.1 | 0.1 | 0.1 | 0.1 | 0.1 | 0.1 | 0.1 | 0.1 | 0.1 | 0.01 |
|---|---|---|---|---|---|---|---|---|---|---|---|---|
| | Total | | 22.1 | 22.1 | 22.1 | 22.1 | 22.1 | 22.1 | 22.1 | 22.1 | 22.1 | 22.01 |
| Evaluation | Formability test | | A | A | A | A | A | A | A | A | A | A |
| | Extrusion outer appearance test | | A | A | A | A | B | A | A | B | B | A |
| | Hot set test | | B | B | B | B | C | B | C | C | A | C |
| | Tensile test | Tensile strength | B | A | B | A | B | B | C | B | A | C |

| | | | | | | | | | | |
|---|---|---|---|---|---|---|---|---|---|---|
| (MPa) | | | | | | | | | | |
| Breaking elongation | A | A | B | B | A | B | B | A | B | A |
| (%) | | | | | | | | | | |

| | | | | | | | | | | |
|---|---|---|---|---|---|---|---|---|---|---|
| Heat aging test 1 | B | B | B | B | B | B | C | C | B | C |
| Heat aging test 2 | C | | C | C | C | C | D | D | C | C |

TABLE C3

| | | | | Example C | Comparative Example C | | | | | | |
|---|---|---|---|---|---|---|---|---|---|---|---|
| | | | | 21 | 1 | 2 | 3 | 4 | 5 | 6 | 7 |
| Silane | Base | ELASTSIL R401/40S | Specific gravity 1.12 | 55 | 70 | 55 | 55 | 55 | 55 | 55 | 55 |
| MB | Rubber | AFLAS 400E | Fluororubber | 20 | 20 | 20 | 20 | 20 | 20 | 20 | 20 |
| | | NUC6510 | EEA | 7.5 | | 15 | 15 | 15 | 15 | 15 | 15 |
| | | VF120T | EVA | | | | | | | | |
| | | EVOLUE SP0510 | LLDPE | 7.5 | | | | | | | |
| | | PB222A | PP | | | | | | | | |
| | Inorganic | SOFTON 1200 | Calcium carbonate | | | | | | | | |
| | filler | AEROSIL 200 | Dry silica | 5 | 5 | 5 | 5 | 5 | 5 | 5 | 5 |
| | | CRYSTALITE 5X | Crystalline silica | | | | | | | | |
| | Antioxidant | | IRGANOX 1010 | 0.1 | 0.1 | 0.1 | 0.1 | 0.1 | 0.1 | 0.1 | 0.1 |
| | Silane coupling agent | | KBM-1003 | 6 | | 6 | 6 | 6 | 6 | 6 | 6 |
| | Organic peroxide | | PERHEXA 25B | 0.1 | 0.5 | 0.1 | 0.1 | 0.1 | 0.1 | 0.1 | 0.1 |
| | Total | | | 101.2 | 95.6 | 101.2 | 101.2 | 101.2 | 101.2 | 101.2 | 101.2 |
| Catalyst | Base rubber | NUC6510 | EEA | 10 | 10 | 10 | 10 | 10 | 10 | 10 | 10 |
| MB | Antioxidant | Hindered phenol-based | IRGANOX 1010 | 2 | 2 | 2 | | 0.1 | 9 | 2 | 2 |
| | | Hydrazine-based | ADK STAB CDA-10 | 2 | 2 | 2 | 2 | 0.3 | 6 | 2 | 2 |
| | | Benzimidazole-based | NOCRAC MBZ | 8 | 8 | | 8 | 1 | 16 | 8 | 8 |
| | | Hindered amine-based | ADK STAB LA-52 | | | | 2 | | | | |

| | Silanol condensation catalyst | ADK STAB OT-1 | 0.5 | | 0.1 | 0.1 | 0.1 | 0.1 | 0.005 | 0.6 |
|---|---|---|---|---|---|---|---|---|---|---|
| | Total | | 22.5 | 22 | 14.1 | 22.1 | 11.5 | 41.1 | 22.005 | 22.6 |
| Evaluation | Formability test | | A | D | A | A | A | A | A | A |
| | Extrusion outer appearance test | | B | D | A | A | A | D | A | D |
| | Hot set test | | A | D | A | B | A | C | D | A |
| | Tensile test | Tensile strength | B | D | A | B | A | D | D | C |

| | | | | | | | | |
|---|---|---|---|---|---|---|---|---|
| (MPa) | | | | | | | | |
| Breaking elongation | C | D | A | A | A | D | C | D |
| (%) | | | | | | | | |

| | | | | | | | | |
|---|---|---|---|---|---|---|---|---|
| Heat aging test 1 | A | D | D | D | D | B | D | A |
| Heat aging test 2 | A | D | D | D | D | C | D | B |

The results of Tables C1 to C3 show the following matters.

In Comparative Example C1 containing no ethylene copolymer resin, pelletization was impossible and extrusion forming was impossible (extrusion outer appearance was unable to be evaluated). In addition, the chemical crosslinking method is employed, no crosslinking reaction occurs under the press-forming conditions, and heat resistance (hot set test and heat aging test) and mechanical characteristics (tensile test) are poor. When the chemical crosslinking method is employed, heating at a high temperature for a long time is required to cause a crosslinking reaction. It is found that the manufacturability is poor from the viewpoint of productivity and production cost.

Further, even when the silane crosslinking method is applied, all of Comparative Examples C2 to C5 containing no three kinds of antioxidants at specific contents are unable to achieve both high heat resistance and excellent mechanical characteristics. Specifically, in Comparative Example C2 containing no benzimidazole-based antioxidant, Comparative Example C3 using the hindered amine-based antioxidant in place of the hindered phenol-based antioxidant in the catalyst MB, and Comparative Example C4 in which the contents of the hindered phenol-based antioxidant and the benzimidazole-based antioxidant are too small even when the three kinds of antioxidants are contained, all of the comparative examples do not exhibit high heat resistance. On the other hand, Comparative Example C5 in which the content of each of the antioxidants is too large even when the three kinds of antioxidants are contained is inferior in mechanical characteristics and outer appearance.

Furthermore, in Comparative Example C6 in which the composition amount of the silanol condensation catalyst is too small, the silanol condensation reaction cannot be accelerated, and the crosslinked structure itself is not sufficiently constructed, and thus the heat resistance and the tensile strength are poor. On the other hand, Comparative Example C7 in which the composition amount of the silanol condensation catalyst is too large is inferior in outer appearance.

Note that Comparative Examples C2 to C4 also correspond to the present invention ([Examples A]) and a preferred embodiment of the present invention ([Examples B]), and thus the actions and effects of [Examples A] and [Examples B] are satisfied.

On the other hand, in all of Examples C1 to C21 in which an ethylene copolymer resin is used in combination with a millable silicone rubber, and a specific amount of three kinds of antioxidants is used in the coexistence of a specific amount of a silanol condensation catalyst and an inorganic filler, a silane crosslinking reaction can be caused (accelerated) under mild conditions without requiring special crosslinking equipment such as a chemical crosslinking tube and an electron beam crosslinking machine, and further a formed body excellent in outer appearance can be extrusion-formed even with a general-purpose extruder. In addition, the formed body exhibits remarkably high heat resistance and excellent tensile strength such that the residual ratio of breaking elongation is 50% or more even when the formed body is held at 200° C. for 240 hours. That is, it is apparent that the silane crosslinkable silicone rubber composition [C] according to another preferred embodiment of the present invention can produce the silane crosslinked silicone rubber formed body [C] having excellent outer appearance and showing high heat resistance and strength with excellent manufacturability, even with a general-purpose extruder.

Having described our invention as related to the present embodiments, it is our intention that the present invention not be limited by any of the details of the description, unless otherwise specified, but rather be construed broadly within its spirit and scope as set out in the accompanying claims.

1. A silane crosslinkable silicone rubber composition, comprising:
a base rubber containing a millable silicone rubber; and
with respect to 100 parts by mass of the base rubber containing a millable silicone rubber, 1 to 15 parts by mass of a silane coupling agent graft-bonded to the base rubber, 0.5 to 300 parts by mass of an inorganic filler, and 0.01 to 0.5 parts by mass of a silanol condensation catalyst.

2. The silane crosslinkable silicone rubber composition according to claim 1, wherein the base rubber includes a fluororubber and contains 0.5 to 100 parts by mass of the inorganic filler.

3. The silane crosslinkable silicone rubber composition according to claim 2, wherein the fluororubber includes a tetrafluoroethylene-propylene rubber.

4. The silane crosslinkable silicone rubber composition according to claim 2, wherein the base rubber includes an ethylene copolymer resin.

5. The silane crosslinkable silicone rubber composition according to claim 1,
wherein the base rubber includes an ethylene copolymer resin, and
wherein 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant are contained.

6. The silane crosslinkable silicone rubber composition according to claim 5, wherein the ethylene copolymer resin includes an ethylene-(meth)acrylic acid ester copolymer resin.

7. The silane crosslinkable silicone rubber composition according to claim 5, wherein the base rubber includes a fluororubber.

8. The silane crosslinkable silicone rubber composition according to claim 7, wherein the fluororubber includes a tetrafluoroethylene-propylene rubber.

9. The silane crosslinkable silicone rubber composition according to claim 5, wherein the content of the hindered phenol-based antioxidant is 0.5 to 5 parts by mass, the content of the hydrazine-based metal inactivator is 0.5 to 4 parts by mass, and the content of the benzimidazole-based antioxidant is 3 to 12 parts by mass.

10. The silane crosslinkable silicone rubber composition according to claim 1, wherein the inorganic filler is at least one kind selected from the group consisting of metal hydrate, talc, clay, silica, calcium carbonate, and carbon black.

11. The silane crosslinkable silicone rubber composition according to claim 1, wherein the content of the silane coupling agent is 3 to 15 parts by mass with respect to 100 parts by mass of the base rubber.

12. A silane crosslinked silicone rubber formed body obtained by, after forming the silane crosslinkable silicone rubber composition according to claim 1, bringing the silane crosslinkable silicone rubber composition into contact with water.

13. A silane crosslinked silicone rubber formed article comprising the silane crosslinked silicone rubber formed body according to claim 12.

14. A method of producing a silane crosslinkable silicone rubber composition, including a step (1) of obtaining a silane crosslinkable silicone rubber composition by mixing a millable silicone rubber, and with respect to 100 parts by mass of the base rubber containing a millable silicone rubber, 1 to 15 parts by mass of a silane coupling agent having a grafting reaction site capable of being graft-reacted with the base rubber, 0.5 to 300 parts by mass of an inorganic filler, 0.01 to 0.6 parts by mass of an organic peroxide, and 0.01 to 0.5 parts by mass of a silanol condensation catalyst,
wherein, when the step (1) is performed, in a case of melt-mixing all of the base rubber in the following step (a), the step (1) includes the following step (a) and step (c), or in a case of melt-mixing a part of the base rubber in the following step (a), the step (1) includes the following step (a), step (b), and step (c):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of mixing the silane masterbatch with the silanol condensation catalyst or the catalyst masterbatch.

15. The method of producing a silane crosslinkable silicone rubber composition according to claim 14, wherein in the step (1), the base rubber includes a fluororubber, and 0.5 to 100 parts by mass of the inorganic filler is mixed.

16. The method of producing a silane crosslinkable silicone rubber composition according to claim 14,
wherein in the step (1), the base rubber includes an ethylene copolymer resin, and 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant are mixed, and
wherein each of the hindered phenol-based antioxidant, the hydrazine-based metal inactivator, and the benzimidazole-based antioxidant is mixed in at least one of the step (a) and the step (b).

17. A method of producing a silane crosslinked silicone rubber formed body, including the following step (1), step (2), and step (3):
Step (1): a step of obtaining the silane crosslinkable silicone rubber composition by mixing a base rubber containing a millable silicone rubber, and with respect to 100 parts by mass of the base rubber containing a millable silicone rubber, 1 to 15 parts by mass of a silane coupling agent having a grafting reaction site capable of being graft-reacted with the base rubber, 0.5 to 300 parts by mass of an inorganic filler, 0.01 to 0.6 parts by mass of an organic peroxide, and 0.01 to 0.5 parts by mass of a silanol condensation catalyst,
Step (2): a step of obtaining a formed body by forming the silane crosslinkable silicone rubber composition, and
Step (3): a step of obtaining the silane crosslinked silicone rubber formed body by bringing the formed body into contact with water,
wherein, when the step (1) is performed, in a case of melt-mixing all of the base rubber in the following step (a), the step (1) includes the following step (a) and step (c), or in a case of melt-mixing a part of the base rubber in the following step (a), the step (1) includes the following step (a), step (b), and step (c):
Step (a): a step of preparing a silane masterbatch by melt-mixing all or a part of the base rubber, the silane coupling agent, the inorganic filler, and the organic peroxide at a temperature equal to or higher than a decomposition temperature of the organic peroxide,
Step (b): a step of preparing a catalyst masterbatch, by melt-mixing a remainder of the base rubber, and the silanol condensation catalyst, and
Step (c): a step of mixing the silane masterbatch with the silanol condensation catalyst or the catalyst masterbatch.

18. The method of producing a silane crosslinkable silicone rubber composition according to claim 17, wherein in the step (1), the base rubber includes a fluororubber, and 0.5 to 100 parts by mass of the inorganic filler is mixed.

19. The method of producing a silane crosslinkable silicone rubber composition according to claim 17,
wherein in the step (1), the base rubber includes an ethylene copolymer resin, and 0.5 to 100 parts by mass of the inorganic filler, 0.2 to 8 parts by mass of a hindered phenol-based antioxidant, 0.2 to 5 parts by mass of a hydrazine-based metal inactivator, and 1.5 to 15 parts by mass of a benzimidazole-based antioxidant are mixed, and
wherein each of the hindered phenol-based antioxidant, the hydrazine-based metal inactivator, and the benzimidazole-based antioxidant is mixed in at least one of the step (a) and the step (b).
